(19) United States
(12) Patent Application Publication
(10) Pub. No.: US 2009/0033859 A1
(43) Pub. Date: Feb. 5, 2009

(54) Liquid Crystal Spacer, Spacer Diffusion Liquid, Liquid Crystal Display Device Manufacturing Method, and Liquid Crystal Display Device

(76) Inventors: Michihisa Ueda, Osaka (JP); Takeshi Wakiya, Osaka (JP); Tsutomu Ando, Osaka (JP); Hiroshi Yoshitani, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/922,501

(22) PCT Filed: Jun. 21, 2006
(86) PCT No.: PCT/JP2006/312431

§ 371 Date: Feb. 22, 2008

(30) Foreign Application Priority Data
Jun. 21, 2005 (JP) 2005-180312
Jul. 12, 2005 (JP) 2005-203205
Jul. 26, 2005 (JP) 2005-216065

(51) Int. Cl. G02F 1/1339; C09K 3/00

(52) U.S. Cl. 349/155; 252/363.5; 349/189

(57) ABSTRACT

It is the object of the present invention to provide: a liquid crystal spacer that can precisely control the interval of two substrates in producing a liquid crystal display apparatus, and can be firmly fixed to the surface of the substrate; a spacer dispersion that can precisely control the interval of two substrates in manufacturing a liquid crystal display apparatus, and can make spacer particles firmly fixed to the surface of a substrate and a spacer dispersion that can precisely dispose spacer particles at a predetermined position on a substrate, a method for producing a liquid crystal display apparatus; and a liquid crystal display apparatus.

The invention is a liquid crystal spacer, which comprises a base particle and an adhesive layer provided on the surface of the base particle, the apparent center of the adhesive layer being not identical to the apparent center of the base particle.

### TECHNICAL FIELD

The present invention relates to: a liquid crystal spacer that can precisely control the interval of two substrates in producing a liquid crystal display apparatus, and can be firmly fixed to the surface of the substrate; a spacer dispersion that can precisely control the interval of two substrates in producing a liquid crystal display apparatus, and can make spacer particles firmly fixed to the surface of the substrate; a spacer dispersion that can precisely arrange spacer particles at a predetermined position on a substrate; a method for producing a liquid crystal display apparatus; and a liquid crystal display apparatus.

### BACKGROUND ART

A liquid crystal display apparatus is widely used for personal computers, portable electronic devices, and the like now. FIG. 20 is a cross-sectional view schematically illustrating an example of a liquid crystal display apparatus. As illustrated in FIG. 20, a liquid crystal display apparatus 200 is arranged so that two transparent substrates 201 and 202 face each other.

Color filters 203 and black matrixes 204 that separate the color filters 203 are formed on the inner surface of the transparent substrate 201, and an overcoat layer 205 is formed on the color filters 203 and the black matrixes 204.

Furthermore, a transparent electrode 206 is formed on the overcoat layer 205, and an alignment layer 207 is formed thereon so as to cover the transparent electrode 206.

Meanwhile, a transparent electrode 208 is formed on a position facing the color filter 203 on the inner surface of the transparent substrate 202, and an alignment layer 209 is further formed so as to cover the inner surface of the transparent substrate 202 and the transparent electrode 208. The transparent electrodes 206 and 208 have a pixel electrode arranged on a pixel area and an electrode arranged on an area other than a pixel area.

In addition, polarizing plates 210 and 211 are arranged on the outer surface of the transparent substrates 201 and 202, respectively, and bonded in the vicinity of the outer circumference thereof through a sealing material 212.

Furthermore, a liquid crystal 214 is enclosed in a space surrounded by the alignment layers 207, 209, and the sealing material 212, and spacer particles 213 are arranged between the alignment layer 207 and the alignment layer 209. The function of the spacer particles 213 is to regulate the interval between the two transparent substrates 201 and 202 and maintain a proper thickness of a liquid crystal layer, namely a cell gap.

In a conventional method for producing a liquid crystal display, in order to disperse spacers randomly and evenly on the substrate in which pixel electrodes are formed, the spacers are arranged even in pixel electrodes, that is, display parts (pixel areas) of the liquid crystal display. The spacers are typically made of a synthetic resin or glass, and when the spacers are arranged on the pixel electrodes, there sometimes occurred a problem that a so-called depolarization phenomenon, in which polarized light is disturbed and loses a polarization property, arose and therefore the spacer portion caused light leakage.

In addition, owing to disorder of alignment of the liquid crystal on the surface of the spacers, there sometimes occurred a problem that light blank was caused to deteriorate the contrast and color tone and to worsen the display picture quality.

Further, in the case of a TFT liquid crystal display, TFT elements are arranged on a substrate, and when the spacers were arranged on the TFT element, a serious problem that the element was broken when pressure was applied to the substrate possibly occurred.

To suppress such problems attributed to a random and uniform dispersion of spacer particles, it is examined to arrange the spacers under a light shielding layer (portions separating the pixel areas). As a method for arranging the spacers only in specified positions in such a manner, there is disclosed a color liquid crystal panel (see, for example, Patent Document No. 1) in which openings of a mask having openings and positions where the spacers should be placed were adjusted and then the spacers are arranged only in portions corresponding to the openings. In addition, a liquid crystal display apparatus that electrostatically attracts the spacers to a photoconductor and then transferring the spacers to a transparent substrate and a method for producing the liquid crystal display apparatus are disclosed (see, for example, Patent Document No. 2).

However, these methods have a problem that a mask or a photoconductor directly contacts a substrate, and an alignment layer on the substrate becomes susceptible to damage, leading to deterioration of display picture quality.

In addition, a method for producing a liquid crystal display involving arranging an electrostatically charged spacers on specified positions owing to electrostatic resilient force by applying voltage to the image electrodes on a substrate and dispersing the electrically charged spacer is disclosed (see, for example, Patent Document No. 3).

However, since this method needs an electrode formed in accordance with the arrangement patterns and it is impossible to arrange the spacers in completely optional positions, there is a problem that the types of applicable liquid crystal display apparatuses are limited.

Meanwhile, in the liquid crystal display element with spacers and a liquid crystal placed between the interval parts between the transparent electrode substrates where transparent electrodes were adhered and formed on opposing faces, a method for producing a liquid crystal display apparatus for dispersing spacers on an electrode substrate using an ink-jet apparatus, namely, arranging spacers by an ink-jet printing method is disclosed (see, for example, Patent Document No. 4).

This method is effective in that, unlike the above-mentioned methods, no direct contact with the substrate is involved and the spacers can be arranged on any position in any pattern.

However, since spacers with a size of approximately 1 to 10 μm are contained in a spacer dispersion to be dispersed with an ink-jet printing method, there sometimes occurred a case where some spacer dispersions cannot be ejected straight forward from a nozzle.

In addition, a nozzle diameter of an ink-jet head has to be enlarged so as to eject the spacer dispersion straight forward, and consequently, there still remains a problem that the droplets of the spacer dispersion ejected on a substrate become large and come out to the pixel areas from the light shielding regions even if the spacer dispersion is dispersed aiming to the light shielding regions.

Thus, unless some improvements are made, such as drying and reducing droplets of the spacer dispersion with deposition points on the light shielding regions being the center, gathering the spacers toward the deposition points with the drying and reducing, the spacers will be arranged even in the pixel areas, and a desired effect to improve the picture quality such as color tone and the contrast, namely, improve the display picture quality will be unable to be achieved.

In addition, in a method for drying and reducing the droplets of the spacer dispersion with deposition points on the shielding regions being the center, and gathering the spacers toward the deposition points, since the spacers are more likely to move in the droplets or move with the drying droplets, there sometimes occurred a case where the spacers had an inferior adherence after the droplets were dried and the spacers were firmly fixed to the substrate by a heat treatment. There was a problem that when the adherence of the spacers was inferior, the spacers moved in injecting liquid crystal and the like.

As a method for improving an adherence of spacers to a substrate, a core-shell type spacer, with a silica particle being a core, made by uniformly coating the surface of the silica particle with an adhesive layer having adhesiveness, is disclosed (see, for example, Patent Document 5). When producing a liquid crystal display apparatus, this core-shell type spacer can firmly fix the spacer to the substrate by being held between the substrates and subjected to heat and pressure.

However, since a conventional core-shell type spacer is configured so that an adhesive layer having a uniform thickness was formed on the surface of a core particle to serve as a substrate, when the spacer is firmly fixed to a substrate, it exists between the core particle and the substrate, there was only a small amount of the adhesive layer for fixing the core particle to the substrate, and thereby the adherence of the spacers to the substrate was not necessarily satisfactory.

### Patent Document No. 1: Japanese Kokai Publication Hei-4-198919;

### Patent Document No. 2: Japanese Kokai Publication Hei-6-258647;

### Patent Document No. 3: Japanese Kokai Publication Hei-10-339878;

### Patent Document No. 4: Japanese Kokai Publication Sho-57-58124; and

### Patent Document No. 5: Japanese Kokai Publication 2002-327030

### DISCLOSURE OF THE INVENTION

### Problems to be Solved by the Invention

In view of the above-mentioned state of the art, it is the object of the invention to provide: a liquid crystal spacer that can precisely control the interval of two substrates in producing a liquid crystal display apparatus, and can be firmly fixed to the surface of the substrate; a spacer dispersion that can precisely control the interval of two substrates in producing a liquid crystal display apparatus, and can make spacer particles firmly fixed to the surface of a substrate; and a spacer dispersion that can precisely arrange spacer particles at a predetermined position on a substrate; a method for producing a liquid crystal display apparatus; and a liquid crystal display apparatus.

### Means for Solving the Problems

The present invention is a liquid crystal spacer of the present invention, which comprises a base particle and an adhesive layer provided on the surface of the base particle, the apparent center of the adhesive layer being not identical to the apparent center of the base particle.

In addition, the present invention is a spacer dispersion, which comprises a liquid crystal spacer of the present invention and a solvent dispersing the liquid crystal spacer (hereinafter, also referred to as a spacer dispersion of the first invention).

In addition, the present invention is a spacer dispersion, which comprises a spacer particle, an adhesive particle and a solvent containing water and/or a hydrophilic organic solvent (hereinafter, also referred to as a spacer dispersion of the second invention).

In addition, the present invention is a spacer dispersion, which comprises a spacer particle and a solvent component, the spacer dispersion being ejected on a substrate of a liquid crystal display element using an ink-jet apparatus and being used when the spacer particle is arranged on the substrate, and the solvent component containing 1% by weight or more of an solvent with a boiling point of 200° C. or more and a surface tension of 42 mN/m or more (hereinafter, also referred to as a spacer dispersion of the third invention).

In addition, the present invention is a method for producing a liquid crystal display apparatus having a pixel area and a non-pixel area, and a first and a second substrates facing each other, which comprises the steps of: arranging spacer particles on an area corresponding to a non-pixel area on the first substrate, by ejecting a spacer dispersion, where spacer particles are dispersed, on the first substrate from a nozzle of an ink-jet apparatus, superimposing the first substrate on which spacer particles are arranged on the second substrate so as to face each other via spacer particles and injecting a liquid crystal between the first and the second substrates superimposed on one another, or arranging a liquid crystal on the first substrate or the second substrate before superimposing the first substrate on the second substrate, the spacer dispersion containing at least a solvent with a boiling point of 200° C. or more and a surface tension of 42 mN/m or more, and an amount of a solvent with a boiling point of 200° C. or more and a surface tension of 42 mN/m or more contained in a spacer dispersion ejected at a time from one nozzle being 0.5 to 15 ng in the step of arranging spacer particles.

In addition, the present invention is a liquid crystal display apparatus, which is obtained by using the spacer dispersion of the present invention and the liquid crystal spacer of the present invention.

Hereinafter, the present invention will be described more in detail.

### (Liquid Crystal Spacer)

Inventors of the invention have made investigations and have found that a very firm adhesion and fixation to the surface of the substrate can be achieved by forming a specific shape of the adhesive layer in a liquid crystal spacer having a base particle and an adhesive layer provided on the surface of the base particle, and thus have completed the liquid crystal spacer of the present invention.

The liquid crystal spacer of the present invention comprises a base particle and an adhesive layer provided on the surface of the base particle.

In producing a liquid crystal display apparatus using the liquid crystal spacer of the present invention, the base particle is held between two substrates, controls the interval of these two substrates, and serves to maintain a proper cell gap; while in producing the liquid crystal display apparatus using the liquid crystal spacer of the present invention, the adhesive layer serves to firmly adhere and fix the base particle to one or both of the surfaces of the two substrates by melting the base particle after the base particle is held between the two substrates.

The liquid crystal spacer of the present invention may have a structure in which the adhesive layer is provided on a portion of the surface of the base particle or on all surface areas of the base particle.

In the case where the liquid crystal spacer of the present invention may have a structure in which the adhesive layer is provided on a portion of the surface of the base particle, examples of the structure includes a structure in which a portion of a base particle 11 in spherical form is embedded in an adhesive layer 15 smaller than the base particle 11, as in a liquid crystal spacer 10 illustrated in FIG. 1, and a structure in which a portion of a base particle 21 in spherical form is embedded in an adhesive layer 25 larger than the base particle 21, as in a liquid crystal spacer 20 illustrated in FIG. 2. In the case where the liquid crystal spacer of the present invention may have a structure in which the adhesive layer is provided on all surface areas of the liquid crystal spacer, examples of the structure includes a structure in which a base particle 31 in spherical form is completely embedded leaning toward one side of a surface of an adhesive layer 35, as in a liquid crystal spacer 30 illustrated in FIG. 3. Here, FIGS. 1 to 3 are cross-sectional views schematically illustrating one example of a liquid crystal spacer of the present invention.

In the liquid crystal spacer of the present invention, the apparent center of the adhesive layer is not identical to the apparent center of the base particle. In the case where the apparent center of the adhesive layer is identical to the apparent center of the base particle, the adhesive layer is formed so as to have a uniform thickness on the surface of the base particle. Therefore, when the spacer particles are firmly fixed to the substrate, the adhesive layer exists between the spacer particles and the substrate, the amount of the adhesive layer that firmly fixes the spacer particles to the substrate becomes very small, and an adherence of the spacer particles to the substrate becomes insufficient.

Moreover, in the present description, the apparent center of the adhesive layer means a center of the sphere when the surface of the adhesive layer is regarded as a portion of the surface of a sphere as illustrated in FIGS. 1 and 2 or a center of the sphere when the adhesive layer is regarded as a sphere as illustrated in FIG. 3. The apparent center of the base particle means a center of the sphere when the base particle is regarded as a sphere as illustrated in FIGS. 1 to 3. However, in the case where the liquid crystal spacer has a structure illustrated in FIGS. 1 and 2 in which a portion of the adhesive layer is thinly coated on the entirety of the base particle, the thinly coated portion is excluded from the surface of the sphere when calculating the apparent center of the adhesive layer.

It can be identified, by observing the cross section of the liquid crystal spacer of the present invention with a transmission electron microscope (TEM), whether or not the apparent center of the adhesive layer of the liquid crystal spacer of the present invention is identical to the apparent center of the base particle.

That is, in the case where the liquid crystal spacer has a structure illustrated in FIG. 1 or 2, it will be identified in the observation with a TEM that the apparent center of an adhesive layer is not identical to the apparent center of a base particle when the outer periphery does not form a concentric circle with the outer periphery of cross section of the base particle in the case of regarding the outer periphery of the cross section of the adhesive layer as a portion of the circle. In the case where the liquid crystal spacer of the present invention has a structure illustrated in FIG. 3, it will be identified, in the observation of the cross-sectional shape of the liquid crystal spacer with a TEM from at least two directions going straight, that the apparent center of the adhesive layer is not identical to the apparent center of the base particle when the outer periphery of the adhesive layer observed from at least one direction does not draw a concentric circle with the outer periphery of the cross section of the base particle. Moreover, in the case where the liquid crystal spacer of the present invention has a structure illustrated in FIG. 3, the reason why the cross-sectional shape of the liquid crystal spacer is observed from at least two directions going straight is that based on how the cross section is obtained, the outer periphery of cross section of the base particle may draw a concentric circle with the outer periphery of cross section of an adhesive layer when the observation with the TEM is carried out from only one direction.

With respect to a ratio (b/a) of the apparent diameter (a) of the base particle to the apparent diameter (b) of the adhesive layer in the liquid crystal spacer of the present invention, the preferable lower limit thereof is 0.3 and the preferable upper limit thereof is 1.5. When it is less than 0.3, the base particle sometimes cannot be firmly adhered and fixed to the surface of the substrate in the liquid crystal display apparatus produced using the liquid crystal spacer of the present invention. When it exceeds 1.5, a cell gap sometimes cannot be controlled because the adhesive layer unevenly remains between the base particle and the substrate in the liquid crystal display apparatus produced using the liquid crystal spacer of the present invention.

Moreover, in the present description, the apparent diameter (a) of the base particle means a diameter of the sphere when the base particle is regarded as a sphere as illustrated in FIGS. 1 to 3. In addition, the apparent diameter (b) of the adhesive layer means a diameter of the sphere when the surface of the adhesive layer is regarded as a portion of surface of a sphere as illustrated in FIGS. 1 and 2 or a diameter of the sphere when the adhesive layer is regarded as a sphere as illustrated in FIG. 3. However, in the case where the liquid crystal spacer has a structure illustrated in FIGS. 1 and 2 in which a portion of the adhesive layer is thinly coated on the entirety of the base particle, the thinly coated portion is excluded from the surface of the sphere in calculation of the apparent diameter (b) of the adhesive layer.

In the liquid crystal spacer of the present invention, as long as a ratio of the apparent diameter (a) of the base particle to the apparent diameter (b) of the adhesive layer satisfies the above-described range, the base particle may be larger than or equal to or smaller than the adhesive layer.

With respect to a liquid crystal spacer having a structure in which the apparent diameter (a) of the base particle is larger than the apparent diameter of the adhesive layer, examples thereof include a structure of the liquid crystal spacer 10 illustrated in FIG. 1, and in such a liquid crystal spacer of the present invention, a ratio (b/a) of the apparent diameter (a) of the base particle to the apparent diameter (b) of the adhesive layer is 0.3 or more and less than 1.0.

In addition, in the case where the apparent diameter (b) of the adhesive layer is equal to or larger than the apparent diameter (a) of the base particle, examples of the structure of the liquid crystal spacer of the present invention include a liquid crystal spacer illustrated in FIG. 2, and in such a liquid crystal spacer of the present invention, with respect to a ratio (b/a) of the apparent diameter of the base particle (a) to the apparent diameter (b) of the adhesive layer, the lower limit thereof is 1.0 and the upper limit thereof is 1.5.

In addition, in the case where the apparent diameter (b) of the adhesive layer is larger than the apparent diameter (a) of the base particle, namely in the case where the above-described (b/a) exceeds 1.0, the liquid crystal spacer of the present invention may have a structure in which an adhesive layer is provided on all surface areas of the base particle as illustrated in FIG. 3.

Moreover, in the liquid crystal spacer of the present invention, the apparent diameter (b) of the adhesive layer is preferably equal to or larger than the apparent diameter of the base particle (a). In producing the liquid crystal display apparatus using the liquid crystal spacer of the present invention having such a structure, a portion protruding from the adhesive layer to form a bump shape is so large that the portion protruding to form a bump shape will be held while contacting both of the two substrates. When the portion protruding to form a bump shape is melted by heating and pressurizing it in this state, the portion protruding to form a bump shape will adhere both the base particle and the two substrates, and the base particle will be very firmly fixed.

In addition, in the liquid crystal spacer of the present invention, a length (c) in a long axis direction is smaller than the sum of the apparent diameter (a) of the base particle and the apparent diameter (b) of the adhesive layer. In the case where the length (c) in the long axis direction is equal to or larger than the sum of the apparent diameter (a) of the base particle and the apparent diameter (b) of the adhesive layer, the base particle will be only in contact with the adhesive layer or both will be separate, whereby a liquid crystal device excellent in display picture quality cannot be produced.

Moreover, the length (c) in the long axis direction means the longest line of the lines drawn between two points on the surface of the liquid crystal spacer of the present invention.

In such a liquid crystal spacer of the present invention, the adhesive layer preferably has a portion protruding from the surface of the base particle to form a bump shape. Moreover, in the present description, “the portion protruding to form a bump shape” means a portion that protrudes, by not lower than a certain thickness in comparison with other portions, in the adhesive layer provided on the surface of the base particle. This excludes the case where the adhesive layer is provided so as to coat all surface areas of the base particle with a uniform thickness and the case where the adhesive layer is provided in thin film form on a portion of the surface of the base particle.

For example, in the case where the liquid crystal spacer of the present invention has a structure in which the adhesive layer is provided on a portion of surface of the base particle as in the liquid crystal spacers 10 and 20 illustrated in FIGS. 1 and 2, the adhesive layers 15 and 25 themselves will serve as the portion protruding to form a bump shape. In the case where the liquid crystal spacer of the present invention has a structure in which the adhesive layer is provided on all surface areas of the base particle as in the liquid crystal spacer 30 illustrated in FIG. 3, a portion of the adhesive layer 35 that covers the base particle 31, which is thickest when viewed from the surface of the base particle 31, will serve as the portion protruding to form a bump shape.

When the liquid crystal spacer of the present invention having such a structure is dispersed on the substrate, the liquid crystal spacer of the present invention is placed with gravitational effect with a portion of the adhesive layer protruding to form a bump shape being in contact with the substrate. When the portion protruding to form a bump shape is melted in this state, most of the portion protruding to form a bump shape will be used to adhere both the base particle and the substrate, and the base particle will be firmly fixed to the substrate.

In the liquid crystal spacer of the present invention, materials forming the base particle are not particularly limited, and conventionally well-known organic and/or inorganic materials, for example, can be used.

In the case where an organic material is used as a material forming the base particle, a polymerizable monomer, which is a raw material of the organic material, is not particularly limited, and examples thereof include a crosslinking monomer and a non-crosslinking monomer.

These monomers may be used alone, or two or more kinds thereof may be used in combination.

The non-crosslinking monomer is not particularly limited, and examples thereof include: styrene-based monomers, such as styrene, α-methylstyrene, p-methylstyrene, p-chlorostyrene and chloromethylstyrene; carboxylic-group containing monomers such as (meth)acrylic acid, maleic acid and maleic anhydride; alkyl(meth)acrylates such as methyl(meth)acrylate, ethyl(meth)acrylate, propyl(meth)acrylate, butyl(meth)acrylate, 2-ethylhexyl(meth)acrylate, lauryl(meth)acrylate, cetyl(meth)acrylate, stearyl(meth)acrylate, cyclohexyl(meth)acrylate, isobornyl(meth)acrylate, ethylene glycol(meth)acrylate, trifluoroethyl(meth)acrylate and pentafluoropropyl (meth)acrylate; oxygen-atom-containing (meth)acrylates such as 2-hydroxyethyl(meth)acrylate, glycerol(meth)acrylate, polyoxyethylene (meth)acrylate and glycidyl(meth)acrylate; nitrile-containing monomers such as (meth)acrylonitrile; vinyl ethers such as methyl vinyl ether, ethyl vinyl ether and propyl vinyl ether; acid vinyl esters such as vinyl acetate, vinyl butyrate, vinyl laurate, vinyl stearate, vinyl fluoride, vinyl chloride and vinyl propionate; and unsaturated hydrocarbons such as ethylene, propylene, butylene, methyl pentene, isoprene and butadiene.

The crosslinking monomer is not particularly limited, and, examples thereof include: multifunctional (meth)acrylates, such as tetramethylolmethane tetra(meth)acrylate, tetramethylolmethane tri(meth)acrylate, tetramethylolmethane di(meth)acrylate, trimethylolpropane tri(meth)acrylate, dipentaerythritol hexa(meth)acrylate, dipentaerythritol penta(meth)acrylate, glycerol tri(meth)acrylate, glycerol di(meth)acrylate, polyethylene glycol di(meth)acrylate and polypropylene glycol di(meth)acrylate; diallyl ethers such as triallyl (iso)cyanurate, triallyl trimellitate, divinyl benzene, diallyl phthalate and diallyl acrylamide; silane-containing monomers such as γ-(meth)acryloxypropyl trimethoxysilane, trimethoxy silylstyrene and vinyl trimethoxysilane; dicarboxylic acids such as phthalic acid; diamines; diallyl phthalate, benzoguanamine, triallyl isocyanate, acrylamides such as acrylamide and N-isopropyl acrylamide, and the like.

The organic materials of the polymerizable monomer are not particularly limited, and examples thereof include: polyolefins such as polyethylene and polybutadiene; polyethers such as polyethylene glycol and polypropylene glycol; polystyrene, poly(meth)acrylic acid, poly(meth)acrylate, polyvinyl alcohol, polyvinyl ester, polyvinyl ether, polyimide, polyamide imide, polyethylene terephthalate, polyether ether ketone, phenolic resin, allyl resin, furan resin, polyester, epoxy resin, silicone resin, polyimide resin, melamine resin, benzoguanamine resin, polyurethane, fluororesin, acrylonitrile/styrene resin, styrene/butadiene resin, ABS resin, vinyl resin, polyamide resin, polycarbonate, polyacetal, polysulfone, polyether sulfone, polyphenylene oxide, sugar, starch, cellulose, condensation products having polypeptide and the like as a principal component, polymers and the like.

These organic materials may be used alone, or two or more kinds thereof may be used in combination.

The inorganic materials are not particularly limited, and examples thereof include metal, metal oxide, and silica.

In the liquid crystal spacer of the present invention, the base particle may be made only of the organic materials or only of the inorganic materials or have a composite structure between the organic materials and inorganic materials. Among others, the base particle is preferably made only of the organic materials because the organic materials have a proper hardness that does not damage an alignment layer formed on the substrate of the liquid crystal display apparatus and tend to follow any variation in thickness due to thermal expansion and thermal shrinkage.

In addition, the base particle may be a colored base particle to improve the contrast of liquid crystal display elements produced using the liquid crystal spacer of the present invention.

The method for coloring the base particle is not particularly limited, and examples thereof include a coloring method using coloring agents such as carbon black, disperse dyes, acidic dyes, basic dyes, and metal oxide and also a method for coloring by forming films of organic materials on the surface of the base particle and decomposing or carbonizing the films of the organic materials at a high temperature, and any method can be used. Moreover, in the case where the materials themselves for forming the particles are colored themselves, they may be used as colored base particles with no need of a coloration treatment.

In the case where the base particle comprises organic materials obtained by polymerizing the above-described non-crosslinking monomers and/or crosslinking monomers, the polymerization method thereof is not particularly limited. Examples thereof include conventionally well-known polymerization methods such as suspension polymerization, emulsion polymerization, seed polymerization, and dispersion polymerization, and any polymerization method can be used.

In the suspension polymerization and the emulsion polymerization, since a particle diameter distribution is relatively wide and poly-disperse particles can be obtained, these polymerizations are preferably used for producing microparticles having various types of particle diameters. However, in the case where particles produced by the suspension polymerization are used as spacer particles, particles having a desired particle diameter or particle diameter distribution are preferably selected for use by carrying out classification step.

In addition, since the seed polymerization does not need polymerization step and mono-disperse particles can be obtained, this polymerization is preferably used for producing a large quantity of microparticles having a specific particle diameter.

The initiator used in the polymerization method is not particularly limited, and examples thereof include organic peroxides such as benzoyl peroxide, lauroyl peroxide, o-chlorobenzoyl peroxide, o-methoxybenzoyl peroxide, 3,5,5-trimethylhexanoyl peroxide and t-butylperoxy-2-ethylhexanoate and di-t-butyl peroxide; and azo compounds such as azobis(isobutyronitrile), azobis(cyclohexacarbonitrile), azobis(2,4-dimethylvaleronitrile), and the like. Here, with respect to the amount of the initiator to be used, the preferable lower limit thereof is 0.1 parts by weight and the preferable upper limit is 10 parts by weight per 100 parts by weight of the above-mentioned non-crosslinking monomers and/or crosslinking monomers.

The medium to be used in the polymerization method is not particularly limited, it may be selected appropriately depending on the types and the compositions of monomers to be used, and examples thereof include water; alcohols such as methanol, ethanol, and propanol; cellosolves methyl cellosolve and ethyl cellosolve; ketones such as acetone, methyl ethyl ketone, methyl butyl ketone, and 2-butanone; acetic acid esters such as ethyl acetate and butyl acetate; and hydrocarbons such as acetronitrile, N,N-dimethylformamide, and dimethyl sulfoxide. These media may be used alone or two or more types thereof may be used in combination.

An average particle diameter of the base particles is not particularly limited because it depends on a liquid crystal display apparatus used therein, but the preferable lower limit thereof is 0.5 μm. When it is less than 0.5 μm, a cell gap of a liquid crystal display apparatus produced using the liquid crystal spacer of the present invention will be so narrow that a liquid crystal display apparatus excellent in display picture quality sometimes cannot be obtained. The more preferable lower limit thereof is 1 μm.

Moreover, the average particle diameter of the base particles can be calculated by statistically processing particle diameters measured by using an optical microscope, an electronic microscope, a Coulter Counter or the like.

The variation coefficient of the average particle diameter of the base particles is preferably set to 10% or less. The variation coefficient of more than 10% makes it difficult to desirably control the interval between two substrates that face each other when producing the liquid crystal display apparatus. Moreover, the term, variation coefficient used herein refers to a numeric value obtained by dividing the standard deviation derived from the particle diameter distribution by the average particle diameter.

In addition, since the base particle is used as a spacer (gap member) for controlling the interval of two substrates, it is preferable to have a certain degree of strength. The preferable lower limit of compressive elasticity modulus (10% K value) in the case of 10% deformation of a diameter of the base particle is 2000 MPa, and the preferable upper limit thereof is 15000 MPa. When it is less than 2000 MPa, the base particle may be deformed by press pressure in assembling it into a liquid crystal display apparatus and a proper gap may not be maintained. When it is more than 15000 MPa, the alignment layer on the substrate may be damaged to cause display anomalies in incorporation of the liquid crystal spacer of the present invention in a liquid crystal display apparatus.

Moreover, the 10% K value can be derived based on the following equation by using Micro Compression Testing Machine (for example, PCT-200, produced by SHIMADZU CORPORATION) and measuring a compression displacement (mm) in the case where the particle is compressed at a compression velocity of 2.6 mN/sec and maximum test load of 10 g with a flat end face of a diamond column of 50 μm in diameter.

K value (N/mm²)=(3/2^{1/2})·F·S^{-3/2}·R^{-1/2}
F: load value (N) at 10% compression deformation of base particle
S: compression displacement (mm) at 10% compression deformation of base particle
R: radius of base particle (mm)

In order to obtain base particles of which 10% K value satisfies the conditions, the base particles are preferably formed by a resin that is prepared by polymerizing the polymerizable monomer having an ethylenic unsaturated group, and in this case, at least 20% by weight of the crosslinking monomer is preferably contained therein as a constituent component.

With respect to a recovery rate of the base particles, the preferable lower limit thereof is 20%. In the case of the recovery rate of less than 20%, since, when compressing the liquid crystal spacer of the present invention, the deformed spacer fails to return to its original state, the substrates that face each other in the liquid crystal display apparatus sometimes cannot be fixed to each other. The more preferable lower limit thereof is set to 40%. Moreover, the recovery rate refers to a recovery rate obtained after imposing a load of 9.8 mN to the base particles.

The materials forming the adhesive layer are not particularly limited as long as they are made of a resin having adhesiveness, and the same kinds of materials as used in the base particles can be used. Since softening deformation is caused by heating, the contact surface area between the substrate and the base particle increases, leading to a resultant strong adhesion, a thermoplastic resin is preferably used among these.

The monomer forming the adhesive resin is not particularly limited, and examples thereof include: olefins and their derivatives such as ethylene, propylene, butylene, methyl pentene, butadiene, and isoprene; styrene derivatives such as styrene, α-methylstyrene, p-methylstyrene, p-chlorostyrene, divinyl benzene, and chloromethylstyrene; vinyl esters such as vinyl fluoride, vinyl chloride and vinyl propionate; unsaturated nitrites such as acrylonitrile; (meth)acrylic ester derivatives such as (meth)methylacrylate, ethyl(meth)acrylate, butyl(meth)acrylate, butyl(meth)acrylate, 2-ethylhexyl(meth)acrylate, stearyl(meth)acrylate, cyclohexyl(meth)acrylate, isobornyl(meth)acrylate, ethylene glycol(meth)acrylate, trifluoroethyl(meth)acrylate and pentafluoropropyl(meth)acrylate, cyclohexyl(meth)acrylate, tetramethylolmethane tetra(meth)acrylate, tetramethylolmethane tri(meth)acrylate, tetramethylolmethane di(meth)acrylate, trimethylolpropane tri(meth)acrylate, dipentaerythritol hexa(meth)acrylate, dipentaerythritol penta(meth)acrylate, glycerol tri(meth)acrylate, glycerol di(meth)acrylate, polyethylene glycol di(meth)acrylate and polypropylene glycol di(meth)acrylate; acrylamides such as acrylamide, isopropyl acrylamide, propylenediacrylamide; silane-containing monomers such as γ-(meth)acryloxypropyl trimethoxysilane, trimethoxy silylstyrene and vinyl trimethoxysilane; dicarboxylic acids such as phthalic acid; diamines; epoxies; diallyl phthalate; benzoguanamine; triallyl(iso)cyanate, triallyl trimellitate, diallyl ether, diallyl phthalate, benzoguanamine, triallylisocyanate and the like. The monomers may be used alone, or two or more kinds thereof may be used in combination.

A softening point of the adhesive layer is not particularly limited, and the preferable lower limit thereof is 50° C. and the preferable upper limit thereof is 120° C. When it is less than 50° C., a handling property of the liquid crystal spacer of the present invention will be inferior because of agglomeration and the like. When it exceeds 120° C., a heating temperature will be higher at the time of fixing the liquid crystal spacer of the present invention between the two substrates, a burden on a glass substrate will be large, and it may cause a distortion.

A method for providing the adhesive layer on at least a portion of surface of the base particle is not particularly limited, and after forming a complex with the polymerizable droplets comprising monomers forming the adhesive layer, a method for polymerizing the polimerizable droplets comprising the monomers is preferably used.

As a method for forming the polymerizable droplets comprising monomers forming the adhesive layer and combining them with the base particle, examples thereof include (1) a method for suspending the monomer forming the adhesive layer in a insoluble medium in the presence of a dispersion stabilizer, thereafter adding base particles thereto, and combining them; and (2) a method for forming a resin layer swellable in the monomer forming the adhesive layer (hereinafter, also referred to as a shell seed layer) on the surface of the base particle, and thereafter swelling the resin layer in the monomer forming the adhesive layer. As a method for combining with the base particle, a method for forming the shell seed layer is preferable because the adhesive layer to be formed will have a highly uniform size. Moreover, a combination state can be controlled by properly selecting a polarity between the base particle and the monomer forming the adhesive layer, the interfacial tension, and the like.

The medium is not particularly limited as long as it is incompatible with the monomer, and examples thereof include water, methanol, ethanol, dimethyl sulfoxide, dimethylformamide and the like, and mixed liquids thereof. Water is preferable among these because of its easy handling.

In order to stably disperse the polymerizable droplets into the medium, it is preferable to add, for example, ionic or nonionic surfactants such as polyvinyl alcohol, polyvinyl pyrrolidone, polyoxyethylene, dispersion stabilizers such as cellulose, polyalkylene glycol alkyl ether, polyalkylene glycol alkylphenyl ether, fatty acid diethanolamide, sodium lauryl sulfate, alkyl benzene sodium sulfonate, long chain fatty acid, long chain alkyltrimethylamine hydrochloride, and dimethyl alkyl betaine.

In addition, additives such as an auxiliary stabilizer, a pH adjuster, an aging preventing agent, an antioxidant, and antiseptics that are usually used in a suspension polymerization or an emulsion polymerization may be further added into the medium.

The resin layer forming the shell seed layer is not particularly limited as long as it absorbs the monomers forming the adhesive layer and forms polymerizable droplets, and it is possible to use organic materials forming the base particles. Moreover, materials forming the shell seed layer are preferably non-crosslinking monomers because they absorb the monomers forming the adhesive layer and tend to form polymerizable droplets.

A method for producing the shell seed layer is not particularly limited, and examples thereof include: (1) a method for precipitating a resin layer forming the shell seed layer on the base particle; (2) a method for dispersing a base particle and a raw material monomer of the resin layer on a medium and forming the resin layer on the surface of the base particle by dispersion polymerization, emulsion polymerization, suspension polymerization, soap-free precipitation polymerization, and the like; (3) a method for introducing a reactive functional group on the surface of a base particle and grafting a resin having a functional group chemically bondable with the reactive functional group; and (4) a method for introducing a polymerizable functional group on the surface of the base particle and subjecting the raw material monomer of a resin to graft polymerization on a basis of the polymerizable functional group.

A method for swelling the shell seed layer with the monomer forming the adhesive layer is not particularly limited, and examples thereof include: (1) a method for adding a solvent incompatible with the monomer forming the adhesive layer after mixing the monomer forming the adhesive layer and the base particle having the shell seed layer; and (2) a method for adding the monomer forming the adhesive layer after dispersing a base particle having the shell seed layer in a solvent incompatible with the monomer forming the adhesive layer. Moreover, in order to prevent the shell seed layers swelled by the monomer forming the adhesive layer from being combined with each other, a surfactant an/or a dispersion stabilizer, and the like used for emulsion polymerization, suspension polymerization, dispersion polymerization, and the like. may be added.

In addition, in order to improve dispersibility to the below-described medium of the spacer dispersion, a step such as introduction of a hydrophilic group may be further carried out on the surface of the obtained adhesive layer.

A thickness of the shell seed layer is not particularly limited because it depends on the size of the obtained adhesive layer, but it is preferably in the range of 0.01 μm up to 20% of a particle diameter of the base particle. When it is less than 0.01 μm, the shell seed layer may not be swelled with a needed amount of the monomer or a swelling state may be ununiform in the case where it is swelled by the monomer forming the adhesive layer. When it exceeds 20% of the particle diameter of the base particle, the property of the obtained adhesive layer may be controlled by the property of the shell seed layer.

This liquid crystal spacer of the present invention is dispersed in a solvent, and thereby can be dispersed precisely on a predetermined position of the substrate, using an ink-jet apparatus.

This liquid crystal spacer of the present invention and the spacer dispersion comprising the solvent for dispersing the liquid crystal spacer are also one of the present inventions.

### (Spacer Dispersion According to the First Invention)

A spacer dispersion according to the first invention comprises a liquid crystal spacer according to the present invention and a solvent for dispersing the liquid crystal spacer.

The above-described solvent forming the spacer dispersion of the first invention preferably comprises water and/or a hydrophilic organic solvent.

Generally, an ink-jet apparatus tends to be able to eject a liquid stably in the case of using water or a hydrophilic organic solvent as a medium. When a highly hydrophobic organic solvent is used as the medium, the medium may affect a member composing a head or may elute a part of adhesives, which bond the member.

Therefore, in arranging the liquid crystal spacer of the present invention using an ink-jet apparatus, the medium of the spacer dispersion is preferably water or a hydrophilic organic solvent.

The water is not particularly limited, and examples thereof include ion-exchanged water, pure water, groundwater, running water and industrial water. These may be used alone or may be used in combination of two or more species.

The hydrophilic organic solvent is not particularly limited, and examples thereof include monoalcohols such as ethanol, n-propanol, 2-propanol, 1-butanol, 2-butanol, 1-methoxy-2-propanol, furfuryl alcohol, tetrahydrofurfuryl alcohol, and the like; polymers of ethylene glycol such as ethylene glycol, diethylene glycol, triethylene glycol, tetraethylene glycol, and the like; polymers of propylene glycol such as propylene glycol, dipropylene glycol, tripropylene glycol, tetrapropylene glycol, and the like; lower monoalkyl ethers such as monomethyl ether, monoethyl ether, monoisopropyl ether, monopropyl ether and monobutyl ether of polymers of ethylene glycol and polymers of propylene glycol; lower dialkyl ethers such as dimethyl ether, diethyl ether, diisopropyl ether and dipropyl ether of polymers of ethylene glycol and polymers of propylene glycol; alkyl esters such as monoacetate and diacetate of polymers of ethylene glycol and polymers of propylene glycol; diols such as 1,3-propanediol, 1,2-butanediol, 1,3-butanediol, 1,4-butanediol, 3-methyl-1,5-pentanediol, 3-hexene-2,5-diol, 1,5-pentanediol, 2,4-pentanediol, 2-methyl-2,4-pentanediol, 2,5-hexanediol, 1,6-hexanediol, neopentyl glycohol, and the like; ether derivatives of diols; acetate derivatives of diols; polyhydric alcohols such as glycerin, 1,2,4-butanetriol, 1,2,6-hexanetriol, 1,2,5-pentanetriol, trimethylol propane, trimethylol ethane, pentaerythritol, and the like; ether derivatives of polyhydric alcohols; acetate derivatives of polyhydric alcohols; dimethyl sulfoxide, thiodiglycol, N-methyl-2-pyrrolidone, N-vinyl-2-pyrrolidone, γ-butyrolactone, 1,3-dimethyl-2-imidazolidine, sulfolane, formamide, N,N-dimethylformamide, N,N-diethylformamide, N-methylformamide, acetamide, N-methylacetamide, α-terpineol, ethylene carbonate, propylene carbonate, bis-β-hydroxyethyl sulfone, bis-β-hydroxyethyl urea, N,N-diethylethanolamine, abietynol, diacetone alcohol and urea. These hydrophilic organic solvents may be used alone or in combination of two or more species.

In addition, the water and the hydrophilic organic solvent may be used alone or in combination of both species.

In the spacer dispersion of the first invention, in the case where the liquid crystal spacer of the present invention is arranged using an ink-jet apparatus, with respect to the solvents comprising the water and/or the hydrophilic organic solvent, the preferable lower limit of the surface tension thereof at 20° C. is 25 mN/m, and the preferable upper limit thereof is 50 mN/m. When the surface tension of the solvents at 20° C. departs from the range, the ejecting property and ejection accuracy of the obtained spacer dispersion may become insufficient. In particular, when the surface tension is less than 25 mN/m, the nozzle side of the head of the ink-jet apparatus may get wet, and an ejection state may become unstable. When it exceeds 50 mN/m, inconveniences that air bubbles tend to remain in an ink chamber in the head (an ink chamber adjacent to a piezo element right in front of a nozzle hole) and ejection stops and the like may occur when the head is filled in with the spacer dispersion. However, in the case where wetted portions, such as an ink chamber in the head of the ink-jet apparatus, are formed by hydrophilic materials (for example, SUS, ceramics, and glass), and/or in the case where before charge of the spacer dispersion the head is filled in with solvents such as 2-propanol that have a lower surface tension and wet an ink chamber thoroughly, and after complete removal of the air bubbles, a passage can be replaced with the inside of the head by using the spacer dispersion so as not to be involved in the air bubbles, ejection can be carried out even with the spacer dispersion exceeding 50 mN/m although it entails a lot of time and effort, as thus described, in terms of the equipment and steps.

In the spacer dispersion of the first invention, for example, in order to satisfy the above-described requirements concerning the surface tension, it is preferable to mix a solvent with a lower surface tension at a lower boiling point and a solvent with a higher surface tension at a higher boiling point. By selecting such a combination, since a surface tension becomes higher as droplets of the spacer dispersion deposited dry, a power that decreases a diameter of droplets is applied as droplets dry, and the range where the final spacer particles are fixed can be limited.

In addition, in the solvent with a lower boiling point used in the present invention, a hydrophilic organic solvent with a boiling point of less than 150° C. is preferably contained and a hydrophilic organic solvent with a boiling point of 70° C. or more and less than 100° C. is more preferably contained. Moreover, in the present description, the boiling point means a boiling point under the condition of 1 atm.

The organic solvent with the boiling point of less than 150° C. is not particularly limited, and examples thereof include lower monoalcohols such as ethanol, n-propanol, and 2-propanol, 1-butanol, 2-butanol, and tert-butanol, acetone and the like. These may be used alone, or two or more kinds thereof may be used in combination. And 2-propanol is the most preferable among these.

The hydrophilic organic solvent with a boiling point of less than 150° C. is vaporized at a relatively low temperature when dried after the spacer dispersion of the first invention is ejected on the substrate. Particularly in the spacer dispersion of the first invention, the drying temperature cannot be raised because, when solvents contact an alignment layer at a higher temperature, the alignment layer will be contaminated and the display picture quality of the liquid crystal display apparatus will be impaired; therefore, the drying temperature cannot be raised too high. Accordingly, it is preferable to use the hydrophilic organic solvent with a boiling point of less than 150° C.

However, when the hydrophilic organic solvent with a boiling point of less than 150° C. tends to be vaporized at room temperature, agglomerate particles tend to occur at the time of manufacture and storage of the spacer dispersion of the first invention, and the spacer dispersion of the first invention tends to dry in the vicinity of the nozzle of the ink-jet apparatus, likely leading to impairment of the ejecting property and ejection accuracy; accordingly the hydrophilic organic solvent that tends to be vaporized at room temperature is not favorable.

In addition, the hydrophilic organic solvent with a boiling point of less than 150° C. is not particularly limited, and the preferable upper limit of a surface tension at 20° C. is 28 mN/m.

In general, ink-jet apparatuses show a good ejection accuracy in the case where a surface tension of the spacer dispersion at 20° C. to be ejected is 30 to 50 mN/m. Meanwhile, the higher the surface tension of the spacer dispersion ejected on the substrate is, the more proper it will be for moving the spacer in the drying step.

In the case where the surface tension of the hydrophilic organic solvent at 20° C. with a boiling point of less than 150° C. is 28 mN/m, since the surface tension of the spacer dispersion of the first invention at the time of ejection is in a lower state, it will become possible to obtain a better ejection accuracy. In this case, after the spacer dispersion is ejected on the substrate, since it is vaporized earlier than other medium components and the surface tension of the spacer dispersion of the first invention becomes higher, it will become easier to move the liquid crystal spacer in the drying step.

A content of the hydrophilic organic solvent in which a boiling point in the solvent used in the present invention is less than 150° C. is not particularly limited as long as it does not depart from the following range; the lower limit of a surface tension of the solvent at 20° C. is 25 mN/m and the upper limit thereof is 50 mN/m. However, the preferable lower limit thereof is 10% by weight, and the preferable upper limit thereof is 80% by weight. When it is less than 10% by weight, the effect by containing the hydrophilic organic solvent with a boiling point of less than 150° C. sometimes cannot be obtained sufficiently. When it exceeds 80% by weight, the spacer dispersion of the first invention is more likely to dry at the time of manufacture and storage thereof and then agglomerate particles may occur, the spacer dispersion of the first invention may dry excessively in the vicinity of the nozzle of the ink-jet apparatus, and then the ejecting property and ejection accuracy may be impaired.

Moreover, in the case where wetted portions, such as an ink chamber in the head of the ink-jet apparatus, are formed by hydrophilic materials (for example, SUS, ceramics, and glass), and/or in the case where before charge of the spacer dispersion the head is filled in with solvents such as 2-propanol that have a lower surface tension and wet an ink chamber thoroughly, and after complete removal of the air bubbles, a passage can be replaced with the inside of the head by using the spacer dispersion so as not to be involved in air bubbles, and besides the spacer dispersion exceeding 50 mN/m is used, these solvents with a lower surface tension are preferably not added thereto or made less than 10% by weight.

In addition, in the solvent used in the present invention, a hydrophilic organic solvent with a boiling point of 150° C. or more is preferably contained and a hydrophilic organic solvent with a boiling point of 150 to 200° C. is more preferably contained.

The hydrophilic organic solvent with a boiling point of 150° C. or more is not particularly limited, and examples thereof include ethylene glycol, propylene glycol, 1,3-propanediol, and various butanediols such as 1,4-butanediol. These may be used alone, or two or more kinds thereof may be used in combination. Ethylene glycol is the most preferable among these, and propylene glycol and 1,3-propanediol are the second most preferable.

The hydrophilic organic solvent with a boiling point of 150° C. or more can prevent the spacer dispersion of the first invention from drying at the time of manufacture and storage thereof and then prevent the resulting occurrence of agglomerate particles, and can prevent the spacer dispersion of the first invention from drying excessively in the vicinity of the nozzle and then prevent the ejecting property and ejection accuracy from being impaired when arranging the liquid crystal spacer of the present invention using an ink-jet apparatus.

In addition, the hydrophilic organic solvent with a boiling point of 150° C. or more is not particularly limited, and the lower limit of a surface tension at 20° C. is 30 mN/m. In the case where the lower limit of the surface tension of the hydrophilic organic solvent at 20° C. with a boiling point of 150° C. or more is 30 mN/m, movement of the liquid crystal spacer in the drying step will be easier because a surface tension of the spacer dispersion of the first invention is maintained at a higher level after a hydrophilic organic solvent with a lower boiling point is vaporized from the spacer dispersion of the first invention ejected on the substrate.

A content of the hydrophilic organic solvent with a boiling point of 150° C. or more in the solvent used in the present invention is not particularly limited as long as it does not depart from the following range; the lower limit of a surface tension of the solvent at 20° C. is 25 mN/m and the upper limit thereof is 50 mN/m. However, the preferable lower limit thereof is 10% by weight, and the preferable upper limit thereof is 80% by weight. When it is less than 10% by weight, the effect by containing the hydrophilic organic solvent with a boiling point of 150° C. or more sometimes cannot be obtained sufficiently. When it exceeds 80% by weight, the drying period of time of the spacer dispersion of the first invention may become strikingly long and productivity may be lowered, or contamination of an alignment layer may impair the display picture quality of the liquid crystal display apparatus.

Moreover, with regard to water, the boiling point thereof is 100° C. and the surface tension thereof is 72.6 mN/m, which are a lower boiling point and a higher surface tension. In the case where a boiling point is 150° C. or more and a surface tension is 30 mN/m or more, more preferably, in the case where a solvent of 35 mN/m or more is added, since the object of mixing the solvent with a lower boiling point and a lower surface tension and the solvent with a higher boiling point and a higher surface tension, namely the object of gathering of the spacers as drying progresses, is not inhibited, it is possible to add the solvent.

In addition, the spacer dispersion of the first invention may contain a solvent X with a boiling point of 200° C. or more and a surface tension at 20° C. of 42 mN/m or more. When the solvent X is contained, the liquid crystal spacer can be effectively gathered at a predetermined position by drying droplets formed by ejecting the spacer dispersion of the first invention on the surface of the substrate. Thus, the liquid crystal spacer can be precisely arranged on an area of the substrate corresponding to a non-pixel area, leading to improvement of display picture quality of the liquid crystal display apparatus to be produced.

When the spacer dispersion of the first invention contains the solvent X, 1% by weight or more of the solvent X is preferably contained in the spacer dispersion of the first invention apart from the liquid crystal spacer. When it is less than 1% by weigh, the spacer dispersion of the present invention may not be stably ejected from a nozzle of an ink-jet apparatus described below, or the liquid crystal spacer sometimes tends not to gather. The more preferable lower limit is 10% by weight, and the more preferable upper limit is 100% by weight. Moreover, in the case where the liquid crystal spacer tends to precipitate in the spacer dispersion, the more preferable lower limit of a content percentage of the solvent X is 80% by weight, and the more preferable upper limit thereof is 100% by weight.

In addition, the solvent X is preferably prepared so that the lower limit of an amount of the solvent X included in droplets ejected at a time from one nozzle of the below described ink-jet apparatus of the first invention is 0.5 ng and the upper limit thereof is 15 ng. When it is less than 0.5 ng, since the liquid crystal spacer does not gather in drying droplets of the spacer dispersion of the first invention formed on the surface of the substrate, the liquid crystal spacer tends to be arranged on an area corresponding to a non-pixel area. When it exceeds 15 ng, in drying droplets comprising the spacer dispersion of the first invention formed on the surface of the substrate, it is necessary to dry the droplets, for example, at a high temperature of 70° C. or more, or at a temperature of less than 70° C. for a long period of time. In the case where they are dried at a high temperature of 70° C. or more, an alignment layer will become susceptible to damage; whereas in the case where they are dried at a temperature of less than 70° C. for a long period of time, it will take ten minutes or more to dry and production efficiency will deteriorate.

When a boiling point of the solvent X is less than 200° C., the spacer dispersion of the first invention tends to dry at the head tip of the nozzle of the ink-jet apparatus described below, and clogging of the nozzle tends to occur. Moreover, in the spacer dispersion comprising only a solvent with a boiling point of less than 180° C., clogging of the nozzle sometimes tends to occur. In addition, since a solvent with a boiling point of less than 200° C. has a lower viscosity and density, in the case where a solvent with a boiling point of 200° C. or more is not included, it may become difficult to set a viscosity of the spacer dispersion in an appropriate range. In addition, in the spacer dispersion comprising only a solvent with a boiling point of less than 200° C., it may become easier for the liquid crystal spacer to precipitate.

When a surface tension of the solvent X is less than 42 mN/m, in drying droplets comprising the spacer dispersion of the first invention formed on the substrate, a liquid crystal spacer does not gather and the liquid crystal spacer tends to be arranged on a non-pixel area.

The solvent X is not particularly limited as long as it has the above-described boiling point and surface tension, and examples thereof include 1,3-propanediol, 1,4-butanediol, 1,5-pentanediol, 1,6-hexanediol, diethylene glycol, triethylene glycol, glycerin, 2-pyrrolidone, and nitrobenzene. Since a liquid crystal spacer can be effectively gathered in a short period of time in drying, 1,3-propanediol, 1,4-butanediol and glycerin are preferably used among these. Since a liquid crystal spacer can be gathered much more effectively in a short period of time in drying, glycerin is more preferably used. These solvents X may be used alone, or two or more kinds thereof may be used in combination.

A solid concentration of the liquid crystal spacer in the spacer dispersion of the first invention is not particularly limited, and the preferable lower limit thereof is 0.05% by weight, and the preferable upper limit thereof is 5% by weight. When it is less than 0.05% by weight, an effective amount of the liquid crystal spacer may not be included in ejected droplets of the liquid crystal dispersion of the first invention. When it exceeds 5% by weight, in the case where the liquid crystal spacer is arranged using an ink-jet apparatus, nozzles of the ink-jet apparatus tend to be clogged, or a content of the liquid crystal spacer in ejected droplets of the spacer dispersion of the first invention may become excessive, and movement of the liquid crystal spacer in the drying step may become difficult. The more preferable lower limit thereof is 0.1% by weight, and the more preferable upper limit thereof is 2% by weight.

The liquid crystal spacer of the present invention is preferably dispersed in the form of a single particle in the spacer dispersion of the first invention. When the liquid crystal spacer of the present invention is not dispersed in the form of a single particle but is in a state of aggregation, in the case where the liquid crystal spacer is arranged using an ink-jet apparatus, they may cause reduction in ejecting property and ejection accuracy, and also may cause clogging of a nozzle of an ink-jet apparatus.

In addition, for example, one species or two or more species of various additives including a tackifier such as an adhesive, a viscosity adjuster, a pH adjuster, a surfactant, a defoaming agent, an antioxidant, a heat stabilizer, a light stabilizer, an ultraviolet absorber, and a coloring agent may be added as required to the extent that achievement of the issues of the present invention is not inhibited.

### (Spacer Dispersion of the Second Invention)

The spacer dispersion of the second invention is a spacer dispersion, which comprises a spacer particle, an adhesive particle, and a solvent containing water and/or a hydrophilic organic solvent.

Inventors of the invention have made investigations and have found that the spacer dispersion, having dispersed in a predetermined solvent the spacer particles and the adhesive particles that fix the spacer particles on the substrate, can very firmly adhere and fix the spacer particles to the surface of the substrate, and thus have completed the spacer dispersion of the second invention.

The spacer dispersion of the second invention contains a spacer particle, an adhesive particle, and a solvent.

In producing a liquid crystal display apparatus using a liquid crystal spacer of the present invention, the spacer particles are held between two substrates, control the interval of these two substrates, and serve to maintain a proper cell gap.

Such a spacer particle is not particularly limited, and examples thereof include the same particle as the above described base particle of the spacer dispersion of the first invention. In addition, the above-described liquid crystal spacer of the present invention can also be used.

In the spacer dispersion of the second invention, for the purpose of improvement of dispersibility and adhesiveness in the spacer dispersion, the spacer particles may be coated with an organic material that can add hydrophilicity and adhesiveness, or physical or chemical treatment may be carried out thereon.

The organic materials for coating the spacer particles are not particularly limited as long as they can impart hydrophilicity and adhesiveness, and examples thereof include (un)saturated hydrocarbon, aromatic hydrocarbon, (un)saturated fatty acid, aromatic carboxylic acid, (un)saturated ketone, aromatic ketone, (un)saturated alcohol, aromatic alcohol, (un)saturated amine, aromatic amine, (un)saturated thiol, aromatic thiol, organosilicon compound, these derivatives, condensation products derived from one or more of these, and polymers derived from one or more of these. These organic materials may be used alone, or two or more kinds thereof may be used in combination.

Moreover, in the present description, the term (un)saturated means both saturated and unsaturated.

The condensation products and polymers are not particularly limited, and examples thereof include: polyolefins such as polyethylene and polybutadiene; polyethers such as polyethylene glycol and polypropylene glycol; polystyrene, poly(meth)acrylic acid, poly(meth)acrylate, polyvinyl alcohol, polyvinyl ester, phenolic resin, melamine resin, allyl resin, furan resin, polyester, epoxy resin, silicone resin, polyimide resin, polyurethane, fluororesin, acrylonitrile/styrene resin, styrene/butadiene resin, ABS resin, vinyl resin, polyamide resin, polycarbonate, polyacetal, polyether sulfone, polyphenylene oxide, sugar, starch, cellulose, condensation products mainly comprising polypeptide and the like, and polymers and the like.

A method for coating the spacer particles with the organic material is not particularly limited, and conventionally well-known methods can be used. Examples thereof include: (1) a method for adding spacer particles into a solution of the organic material, thereafter uniformly dispersing the spacer particles, drying the solvent, and coating the spacer particles with the organic material; (2) a method for adhering the organic material on the surface of the spacer particles by stirring fine powder and spacer particles, both comprising the organic material, under heat at high velocities (hybridization method); (3) a method for introducing the organic material to the surface of the particles by a single-stage or multistage reaction; (4) a method for introducing a polymerizable functional group such as a vinyl group, a radical initiation group, and a chain transfer group, into the surface of the particles and thereafter carrying out graft polymerization on a basis of the polymerizable functional group; and (5) a method for introducing a hydroxyl group into the surface of the particles by chemical reaction, plasma radiation, and the like, thereafter allowing a redox initiator to coexist with a monomer forming the organic material, and carrying out graft polymerization.

A solid concentration of the spacer particles in the spacer dispersion of the second invention is not particularly limited, but the preferable lower limit thereof is 0.05% by weight, and the preferable upper limit is 8% by weight. When it is less than 0.05% by weight, an effective amount of the spacer particles may not be included in ejected droplets of the spacer dispersion of the second invention. When it exceeds 8% by weight, in the case where the spacer particles are arranged using an ink-jet apparatus, nozzles of the ink-jet apparatus tend to be clogged, or a content of the spacer particles in the ejected droplets of the spacer dispersion of the second invention may become excessive, and movement of the spacer particles and adhesive particles in the drying step may become difficult. The more preferable lower limit thereof is 0.1% by weight, and the more preferable upper limit is 4% by weight.

In producing a liquid crystal display apparatus using the liquid crystal spacer of the second invention, the adhesive layer serves to firmly adhere and fix the base particle to the surface of the substrate by melting after being heated after the spacer particles are held between the two substrates.

The material forming the adhesive particle is not particularly limited as long as it melts or softens after being heated and can adhere the spacer particles to the surface of the substrate. However, the material melts or softens and deforms after being heated, a bonding area between the substrate and the spacer particles increase, and consequently adhesiveness increases; therefore, a thermoplastic resin is preferably used.

The monomer configuring resins forming the adhesive particles is not particularly limited, and the same material as an organic material forming the above-described spacer particles can be employed.

A softening point of the adhesive particle is not particularly limited, and the preferable lower limit thereof is 40° C. and the preferable upper limit thereof is 120° C. When it is less than 40° C., the adhesive particle will soften and the risk will increase that adherence of the spacer is impaired. When it exceeds 120° C., a heating temperature will be higher at the time of fixing the spacer particles of the present invention between the two substrates, a burden on a glass substrate will be large, and it may cause a distortion.

A method for controlling the softening point of the adhesive particle in the above-described range is not particularly limited, and examples thereof include a method for selecting a Tg of the organic material forming the adhesive particle and a method for controlling the degree of the crosslinkage of the organic material.

In the case where the organic material is crosslinked, the crosslinkable component preferably contain 5% by weight or less of the organic material. When the adhesive particles are slightly crosslinked in such a manner, the organic material forming the adhesive particles can be prevented from eluting in the liquid crystal of the spacer dispersion and the liquid crystal display apparatus; therefore, a good non-polluted liquid crystal display apparatus can be obtained.

In order to reduce pollution to the liquid crystal, it is preferable to use the adhesive particles with a small ion component. For example, when 1 g of adhesive particles and 10 mL of super pure water are enclosed in a quartz tube and extracted at 120° C. for 24 hours, the content of metal ions such as sodium and potassium in an extract and halide ions such as chlorine is preferably 10 ppm or less.

Examples of a method for setting the content of the metal ions and halide ions to 10 ppm or less include a method disclosed in Japanese Kokai Publication 2005-82695.

A method for producing the adhesive particle is not particularly limited, and conventionally well-known methods can be used. Examples thereof include mini emulsion polymerization, emulsion polymerization, phase-inversion emulsion polymerization, micro suspension polymerization, suspension polymerization, dispersion polymerization, and soap-free (precipitation) polymerization. The dispersion polymerization and the soap-free (precipitation) polymerization with no need of a surfactant and with excellent controllability of a particle diameter are used among these.

An average particle diameter of the adhesive particles is not particularly limited, and the preferable upper limit of the spacer particles is ½ of the average diameter of the spacer particles. When it exceeds ½, an adhesive layer present between the spacer and the panel substrate is so thick that cell gaps may be ununiform. The lower limit thereof is not particularly limited, but the preferable lower limit thereof is 50 nm. When it is less than 50 nm, sufficient adhesiveness sometimes cannot be imparted.

Moreover, as the adhesive particles, two or more kinds thereof having different average particle diameters may be mixed and used.

With regard to a mixing amount of the adhesive particles in the spacer dispersion of the second invention to 100 parts by weight of the spacer particles, the preferable lower limit thereof is 1 part by weight, and the preferable upper limit thereof is 200 parts by weight. When it is less than one part by weight, the spacer particles sometimes cannot be sufficiently adhered to the surface of the substrate. When it exceeds 200 parts by weight, some adhesive particles cannot gather around the periphery of the spacer at the time when ink is dried, and light blank may be caused to deteriorate the contrast and color tone and worsen the display picture quality. The more preferable lower limit is 3 parts by weight, and the more preferable upper limit is 100 parts by weight.

In the spacer dispersion of the second invention, the adhesive particles may be mixed separately from the spacer particles or in such a manner that the adhesive particles 42 illustrated in FIG. 8 are fixed on and combined with the surface of the spacer particles 41.

An embodiment in which the adhesive particles are fixed to the surface of the spacer particles is not particularly limited, and the adhesive particles may be fixed physically or chemically.

The spacer dispersion of the second invention contains solvents comprising water and/or a hydrophilic organic solvent for dispersing the spacer particles and adhesive particles.

Examples of the solvents comprising water and/or a hydrophilic organic solvent include the same solvents as the above-described solvents comprising water and/or a hydrophilic organic solvent described in the liquid crystal spacer of the first invention.

Furthermore, the spacer dispersion of the second invention may contain the solvent X described in the spacer dispersion of the first invention, namely the solvent with a boiling point of 200° C. or more and a surface tension of 42 mN/m or more under the same conditions as in the spacer dispersion of the first invention.

Next, a method for firmly fixing spacer particles on the surface of a substrate using the spacer dispersion of the second invention is described.

FIGS. 7(a) to 7(d) are cross-sectional views schematically illustrating a state where spacer particles are firmly fixed to a predetermined position of the surface of the substrate using the spacer dispersion.

First, the spacer dispersion of the second invention is ejected on predetermined positions on the substrate to form droplets.

In this case, as illustrated in FIG. 7 (a), in the droplets ejected on a predetermined position on a substrate 44, spacer particles 41 and adhesive particles 42 are dispersed in a solvent 43.

Here, the droplets need to be formed in such a manner that the vicinity of the center portion is a location where the spacer particles are arranged. Through the below-described steps, the spacer particles are gathered in the vicinity of the center portion of the ejected droplets.

A method for ejecting the spacer dispersion of the present invention on a predetermined position on the substrate is determined appropriately depending on the ink-jet apparatus and the like to be used. Moreover, the ink-jet apparatus will be described later.

A diameter of the droplets ejected from the nozzle of the ink-jet apparatus is not particularly limited, and the preferable lower limit thereof is 10 μm, and the preferable upper limit thereof is 80 μm.

A method for controlling the diameter of the droplets ejected from the nozzle in the preferable range is not particularly limited, and examples thereof include a method for optimizing an opening of the nozzle and a method for optimizing an electrical signal that controls the ink-jet apparatus, and any one of the methods may be selected. In particular, in the case where the below-described ink-jet apparatus of a piezo type is used, the latter method is preferably selected.

In addition, a diameter of the droplets ejected on the substrate is not particularly limited, and the preferable lower limit thereof is 30 μm, and the preferable upper limit thereof is 150 μm. When it is to be set to less than 30 μm, it becomes necessary to dramatically decrease the opening of the nozzle, clogging of the nozzle due to the liquid crystal spacer of the present invention is more likely to occur, and accuracy of nozzle processing may have to be increased. When it exceeds 150 μm, arrangement accuracy of the spacer particles may be deteriorated.

A substrate on which the spacer dispersion of the second invention is to be ejected is not particularly limited, and examples thereof include plates, such as a glass plate and a resin plate, which are typically used as a panel substrate of the liquid crystal display apparatus. In addition, an alignment layer such as a polyimide layer is provided on the surface of the panel substrate of the liquid crystal device, the liquid crystal spacer of the second invention is ejected on the alignment layer.

Next, as illustrated in FIG. 7(b), spacer particles 41 and adhesive particles 42 dispersed on the droplets are precipitated by still standing of the droplets ejected on the substrate 44 for a certain period of time.

Here, in order to assure a uniform cell gap of the liquid crystal display apparatus to be produced, it is necessary to adjust the precipitated spacer particles 41 and the adhesive particles 42 so as not to be laminated and but to form a single layer on the substrate 44.

Examples of a method for adjusting precipitating spacer particles and adhesive particles to form a single layer include a method for appropriately adjusting a size and a concentration of the spacer particles and adhesive particles in the spacer dispersion of the present invention and a viscosity of the media.

Next, solvents 43 in the droplets ejected on the substrate 44 are dried.

As illustrated in FIG. 7(c), drying of the solvent 43 in the droplets will reduce a volume of the droplets on the substrate 44 as a solvent 43 is dried and vaporized, and the spacer particles 41 and the adhesive particles 42 precipitated by a surface tension of the solvent 44 will be gathered in the vicinity of the center portion of the droplets immediately after the droplets are ejected on the substrate 44.

In the drying step of the solvent 43 as thus described, in order to gather the spacer particles 41 and the adhesive particles 42 in the vicinity of the center portion of the droplets of the spacer dispersion immediately after the ejection, it is important to set to appropriate conditions a boiling point, a drying temperature, and a drying period of time of the solvent 43, a surface tension of the solvent 43, a contact angle of the solvent 43 to the surface of the substrate (or the alignment layer), a concentration of the spacer particles 41 and adhesive particles 42, and the like; the drying conditions are particularly important.

As the drying conditions, it is preferable to dry with a certain time interval, for example, so that the solvent 43 will not be eliminated while the spacer particles 41 and adhesive particles 42 move on the substrate.

Therefore, a drying condition is not preferable such that the solvent 43 is dried rapidly. In addition, a drying condition at a high temperature for a long period of time is not preferable since display picture quality of the liquid crystal display apparatus to be produced may be impaired due to contamination of the alignment layer in the case where the solvent 43 is ejected on the alignment layer while contacting the alignment layer at a high temperature for a long period of time. In addition, when the solvent 43 tends to be vaporized at normal temperature, the spacer dispersion of the second invention is more likely to dry in the vicinity of the nozzle of the ink-jet apparatus, the ejecting property may be impaired, and agglomeration of the spacer dispersion of the second invention due to drying thereof may take place at the time of production of the spacer dispersion of the second invention and storage thereof in a storage tank; therefore, the solvent 43 that tends to be vaporized at normal temperature is not favorable. Furthermore, even under the condition where a surface temperature of the substrate is relatively low, productivity of the liquid crystal display apparatus will deteriorate as a drying period of the time becomes remarkably longer; therefore, a drying condition of a low temperature for a long period of time is not favorable.

Taking these limiting conditions into consideration, a surface temperature at the time when the droplets of the spacer dispersion of the second invention is deposited on the substrate is not particularly limited, and a temperature 20° C. or more lower than the boiling point of the solvent component having the lowest boiling point included in the solvent of the spacer dispersion is favorable. When it is less than 20° C., the solvent component having the lowest boiling point is rapidly vaporized, spacer particles and adhesive particles may become unable to move in the drying step, or rapid boiling of the solvent component having the lowest boiling point may make the spacer particles and the adhesive particles with the droplets move around on the substrate, likely leading to remarkable reduction of the arrangement accuracy of the spacer particles.

In addition, in a drying method for vaporizing a solvent while gradually increasing a surface temperature of the substrate after the droplets of the spacer dispersion are deposited on the substrate, a surface temperature of the substrate at the time when the droplets of the spacer dispersion are deposited on the substrate is not particularly limited, and a temperature 20° C. or more lower than the boiling point of the medium component having the lowest boiling point included in the solvent of the spacer dispersion is favorable, and a surface tension of the substrate until completion of drying is favorably 90° C. or less, and more favorably 70° C. or less. When it is less than 20° C., the dispersion medium component having the lowest boiling point is rapidly vaporized, the spacer particles and the adhesive particles may become unable to move in the drying step, or rapid boiling of the dispersion medium component having the lowest boiling point may make the spacer particles and the adhesive particles with the droplets move around on the substrate, leading to remarkable reduction of the arrangement accuracy of the spacer particles. In addition, when a surface temperature of the substrate until completion of drying exceeds 90° C., a display picture quality of the liquid crystal display apparatus to be produced may be impaired due to contamination of the alignment layer in the case of ejection on the alignment layer.

Next, as illustrated in FIG. 7(d), by completion of drying of the solvent 43 in the droplets, the spacer particles 41 and the adhesive particles 42 having existed in the droplets will be agglomerated and arranged in the vicinity of the center portion of the droplets immediately after the droplets are ejected on the substrate 44. Moreover, the term completion of drying of the solvent means the time when the droplets of the spacer dispersion ejected on the substrate are eliminated.

Afterward, when other substrates are superimposed via the pacer particles and heated to a glass transition temperature (Tg) or more of the adhesive particles, the adhesive particles will melt or soften around the periphery of the spacer particles, firmly adhere and fix the spacer particles and the substrate, and fix a plurality of spacer particles to each other; thereby spacer particles are adhered to the substrate in multiple points, leading to having excellent adhesiveness.

FIG. 9 is a cross-sectional view schematically describing a mechanism where a spacer particle arranged on a substrate is firmly fixed via adhesive particles. FIG. 9(a) illustrates a state after droplets of the spacer dispersion of the second invention are ejected on any position on s substrate using an ink-jet method, and media is dried. Here spacer particles 41 are in close contact with a substrate 44 with adhesive particles 42 arranged therebetween. The spacer particles 41 are firmly fixed to the substrate 44 by melting (FIG. 9(b1)) or softening (FIG. 9(b2)) the adhesive particles 42 in this state.

According to the spacer dispersion of the second invention, using an ink-jet apparatus, the spacer particles can be arranged precisely on any position of the surface of the substrate, and the arranged spacer particles can be firmly adhered and fixed to the surface of the substrate. In addition, since adhesive particles are not interposed between the substrate and the spacer particles, the spacer dispersion of the second invention can precisely control an interval between two substrates in producing the liquid crystal display apparatus.

### (Spacer Dispersion of the Third Invention)

A spacer dispersion of the third invention is a spacer dispersion, which comprises a spacer particle and a solvent component, the spacer dispersion being ejected on a substrate of a liquid crystal display element using an ink-jet apparatus and being used when the spacer particle is arranged on the substrate, and the solvent component containing 1% by weight or more of an solvent with a boiling point of 200° C. or more and a surface tension of 42 mN/m or more.

The material to be used for a spacer dispersion of the third invention is not particularly limited, and may be, for example, inorganic particles such as silica particles or organic particles such as organic polymer. The organic type particles are preferably used among them since they have proper hardness not to damage an alignment layer formed on the substrate of a liquid crystal display apparatus, they tend to follow the alteration of the thickness owing to thermal expansion and thermal shrinkage, and further, movement of spacers inside the cell is difficult. Moreover, the above-described liquid crystal spacers of the present invention can also be used as the spacer particles.

The organic type particles are not particularly limited, but since strength and the like, for example, fall in an appropriate range, the copolymer of a monofunctional monomer and a multifunctional monomer is preferably used. A ratio of the monofunctional monomer to the multifunctional monomer is not particularly limited, and can be adjusted based on the strength and hardness required for the organic type particles.

Examples of the monofunctional monomer include: styrene derivatives such as styrene, α-methylstyrene, p-methylstyrene, p-chlorostyrene; and chloromethylstyrene; vinyl esters such as vinyl chloride and vinyl propionate; unsaturated nitrites such as acrylonitrile; (meth)acrylic ester derivatives such as (meth)methylacrylate, ethyl(meth)acrylate, butyl(meth)acrylate, butyl(meth)acrylate, 2-ethylhexyl(meth)acrylate, stearyl(meth)acrylate, cyclohexyl(meth)acrylate, isobornyl(meth)acrylate, ethylene glycol(meth)acrylate, trifluoroethyl(meth)acrylate and pentafluoropropyl (meth)acrylate and cyclohexyl(meth)acrylate. The above-mentioned monofunctional monomers may be used alone, or two or more kinds thereof may be used in combination.

Examples of the above-mentioned polyfunctional monomer include divinylbenzene, 1,6-hexanediol di(meth)acrylate, trimethylolpropane tri(meth)acrylate, tetramethylolmethane tri(meth)acrylate, tetramethylolpropane tetra(meth)acrylate, diallyl phthalate and isomer thereof, triallyl isocyanurate and derivatives thereof, trimethylolpropane tri(meth)acrylate and derivatives thereof, pentaerythritol tri(meth)acrylate, pentaerythritol tetra(meth)acrylate, dipentaerythritol hexa(meth)acrylate, polyethylene glycol di(meth)acrylate of ethylene glycol di(meth)acrylate, polypropylene glycol di(meth)acrylate of propylene glycol di(meth)acrylate, polytetramethylene glycol di(meth)acrylate, neopentyl glycol di(meth)acrylate, 1,3-butylene glycol di(meth)acrylate, 2,2-bis[4-(methacryloxypolyethoxy)phenyl]propane di(meth)acrylate of 2,2-bis[4-(methacryloxyethoxy)phenyl]propane di(meth)acrylate, 2,2-hydrogenated bis[4-(acryloxypolyethoxy)phenyl]propane di(meth)acrylate and 2,2-bis[4-(acryloxyethoxypolypropoxy)phenyl]propane di(meth)acrylate. These polyfunctional monomers may be used alone or may be used in combination of two or more species.

Monomers having hydrophilic groups may be used as the above-mentioned monofunctional or polyfunctional monomer. Examples of the hydrophilic groups include a hydroxyl group, a carboxyl group, a sulfonyl group, a phosphonyl group, an amino group, an amido group, an ether group, a thiol group, a thioether group and the like.

Examples of the monomers having hydrophilic groups include monomers having a hydroxyl group such as 2-hydroxyethyl(meth)acrylate, 1,4-hydroxybutyl (meth)acrylate, (poly)caprolactone-modified hydroxyethyl (meth)acrylate, allyl alcohol, and glycerin monoallyl ether; acrylic acids such as (meth)acrylic acid, α-ethylacrylic acid, and crotonic acid and α- or β-alkyl derivatives thereof; unsaturated dicarboxylic acids such as fumaric acid, maleic acid, citraconic acid, and itaconic acid; monomers having a carboxylic group such as mono(2-(meth)acryloyloxyethyl ester derivatives of these unsaturated dicarboxylic acids; monomers having a sulfonyl group such as tert-butylacrylamidosulfonic acid, styrenesulfonic acid and 2-acrylamido-2-methylpropanesulfonic acid; monomers having a phosphonyl group such as vinyl phosphate and 2-(meth)acryloyloxyethylphosphate; compounds having an amino group such as amines having an acryloyl group such as dimethylaminoethyl methacrylate and diethylaminoethyl methacrylate; monomers having a hydroxyl group and an ether group together such as (poly)ethylene glycol (meth)acrylate and propylene glycol (meth)acrylate; monomers having an ether groups such as alkyl ether-terminated (poly)ethylene glycol (meth)acrylate, alkyl ether-terminated (poly)propylene glycol (meth)acrylate, and tetrahydrofurfuryl(meth)acrylate; and monomers having an amido group such as (meth)acrylamide, methylol (meth)acrylamide, and vinylpyrrolidone.

A method for obtaining spacer particles by copolymerizing the above-described monofunctional monomer and the above-described multifunctional monomer is not particularly limited and may include various kinds of polymerization such as suspension polymerization, seed polymerization, and dispersion polymerization.

In the suspension polymerization, a particle diameter distribution of spacer particles to be obtained is wide, and poly-disperse spacer particles can be obtained. Various kinds of particles having a desired particle diameter or a particle diameter distribution can be obtained by carrying out classification step for the spacer particles obtained by the above-described suspension polymerization. On the other hand, the seed polymerization and the dispersion polymerization are preferably used for obtaining a large quantity of spacer particles with a specified particle diameter since mono-disperse spacer particles are obtained without classification step.

The suspension polymerization is a method for polymerizing a monomer composition comprising a monomer and a polymerization initiator by dispersing the composition in a poor solvent so as to control the particle diameter as aimed. The dispersing medium to be used for the suspension polymerization may generally be a dispersing medium obtainable by adding a dispersion stabilizer in water. Examples of the dispersion stabilizer include polymers soluble in media such as poly(vinyl alcohol), polyvinylpyrrolidone, methyl cellulose, ethyl cellulose, poly(acrylic acid), polyacrylamide, and polyethylene oxide. In addition, nonionic or ionic surfactant is adequately used. Although differing depending on the above-described polymerization initiator or the types of the monomers, the polymerization conditions are generally 50 to 80° C. for a polymerization temperature and 3 to 24 hours for a polymerization period of time.

The seed polymerization is a polymerization method for expanding mono-disperse seed particles to a desired particle diameter synthesized by soap-free polymerization or emulsion polymerization by making the particles further adsorb a monomer. The organic monomer to be used for the seed particles is not particularly limited, and the above-described monomers may be used. As monomers that are attracted to the mono-disperse seed particles, monomers compatible with mono-disperse seed particles are preferably used so as to suppress phase separation at the time of the seed polymerization. As monomers that are attracted to the mono-disperse seed particles, styrene and its derivatives are more preferably used in order to obtain the particle diameter dispersion further as a monodispersion.

A particle diameter distribution of the seed particles is reflected also to the particle diameter distribution after the seed polymerization, therefore, it is preferably mono-disperse, and a CV value thereof is preferably 5% or less. As a monomer to be absorbed at the time of the seed polymerization, it is preferable to use a monomer having a composition similar to that of the seed particles in order to prevent a phase separation. In the case where the seed particles are particles of a styrene type, it is more preferable to use an aromatic divinyl monomer as a monomer to be absorbed at the time of the seed polymerization. In the case where the seed particles are particles of an acrylic type, it is more preferable to use an acrylic type polyfunctional vinyl monomer as a monomer to be absorbed at the time of the seed polymerization.

A dispersion stabilizer may be used in the seed polimerization if necessary. The dispersion stabilizer is not particularly limited as long as it is a polymer soluble in media, and examples thereof include poly(vinyl alcohol), polyvinylpyrrolidone, methyl cellulose, ethyl cellulose, poly(acrylic acid), polyacrylamide, and polyethylene oxide. In addition, nonionic or ionic surfactants are adequately used.

In the above-mentioned seed polymerization, it is preferable to add 20 to 100 parts by weight of monomers with respect to 1 part by weight of seed particles and attract them.

The medium to be used for the seed polymerization is not particularly limited, and it can be determined properly based on the monomer to be used. However, in general, alcohols, cellosolves, ketones and hydrocarbons can be cited as preferable organic solvents. They may be used alone or in form of medium mixtures with other organic solvents compatible with one another and water. Specifically, examples are acetonitrile, N,N-dimethylformamide, dimethyl sulfoxide, ethyl acetate, alcohols such as methanol, ethanol, and propanol, cellosolves such as methyl cellosolve and ethyl cellosolve, and ketones such as acetone, methyl ethyl ketone, methyl butyl ketone, and 2-butanone.

The dispersion polymerization is a method for carrying out polymerization in a poor solvent in which a monomer is dissolved but the produced polymer is not dissolved and adding a polymer type dispersion stabilizer to precipitate the produced polymer in particle shape.

If crosslinkable monomers are included in the above-described dispersion polymerization, agglomeration of particles tends to take place easily and it is difficult to stably obtain mono-dispersion type crosslinked particles; however, adjustment of the conditions makes it possible to obtain the mono-dispersion type crosslinked particles.

A polymerization initiator may be used at the time of the polymerization. The polymerization initiator is not particularly limited and examples to be used are organic peroxides such as benzoyl peroxide, lauroyl peroxide, o-chlorobenzoyl peroxide, o-methoxybenzoyl peroxide, and 3,5,5-trimethylhexanoyl peroxide, tert-butyl peroxy-2-ethylhexanoate, di-tert-butyl peroxide; and azo type compounds such as azobisisobutyronitrile, azobiscyclohexacarbonitrile, and azobis(2,4-dimethylvaleronitrile). The polymerization initiator in the range of 0.1 to 10 parts by weight with respect to 100 parts by weight of monomers used in polymerization is preferably added.

A particle diameter of the spacer particle is not particularly limited, and can be determined properly based on the types of the liquid crystal display elements. The preferable lower limit of the particle diameter of the spacer particles is 1 μm, and the preferable upper limit thereof is 20 μm. Spacer particles having a particle diameter of less than 1 μm may not function sufficiently, likely leading to a mutual contact between the substrates facing each other, and spacer particles exceeding a particle diameter of 20 μm tend to protrude from an non-pixel area on the substrate and the like. In addition, when particles have too large a particle diameter, a distance between the substrates facing each other becomes large, and it cannot meet the miniaturization demand of liquid crystal display elements and the like in recent years.

The spacer particles are used as a gap material to keep a proper thickness of a liquid crystal layer. Therefore, the particles are required to have a certain strength. As an index showing the compressive strength of the spacer particles is used the compressive modulus of elasticity (10% K value) at the time when the diameter of a spacer particle is displaced by 10%. In order to keep a proper thickness of the liquid crystal layer, the compressive modulus of elasticity is preferably in the range of 2000 to 15000 MPa. If the compressive modulus of elasticity is less than 2000 MPa, it may become difficult to obtain a desired thickness of the liquid crystal layer owing to deformation of the spacer particles by the press pressure at the time of fabrication of the liquid crystal display. If the compressive modulus of elasticity exceeds 15000 MPa, the particles cause damages on alignment layers on the surface of substrates when the spacer particles are arranged on the liquid crystal display.

The compressive modulus of elasticity (10% K value) of the spacer particles is the value calculated in accordance with the method described in Japanese Kohyo Publication Hei-6-503180. For example, a micro-compressive testing machine (PCT-200, produced by Shimadzu Corp.) is used, the spacer particles are compressed with a smooth end face of a column with a diameter of 50 μm made of diamond, and the compressive load is measured at the time when the diameter of the spacer particles is deformed by 10%.

The spacer particles may be colored in order to improve the contrast of liquid crystal display elements. Examples of the colored spacer particles include spacer particles treated with carbon black, disperse dyes, acidic dyes, basic dyes, and metal oxide and also spacer particles colored by forming films of organic materials on the surfaces and thereafter decomposing or carbonizing the films at a high temperature. Moreover, in the case the materials themselves for forming the spacer particles have colors, the spacer particles may be used as they are without coloration.

An electrostatic charge treatment may be carried out on the spacer particles. The above-mentioned electrostatic charge treatment means a treatment for making the spacer particles have some potential even in the spacer particle dispersion. The potential (electric charge) of the spacer particles can be measured by an already existing measuring method using a zeta potential measurement meter and the like.

Examples of the method for carrying out the electrostatic charge treatment include a method for adding a charge control agent to the spacer particles; a method for producing the spacer particles from monomers containing a monomer component easy to be electrostatically charged; and a method for carrying out surface treatment capable of charging the spacer particles.

In the case where the spacer particles are electrostatically chargeable, the dispersibility and dispersion stability of the spacer particles in the spacer dispersion are heightened. Therefore, the spacer particles will easily gather in the vicinity of the wiring part (portion different in level) by an electrophoretic effect at the time of dispersing the spacer particles.

Examples of the method for adding a charge control agent to the spacer particles include: a method for carrying out polymerization with the coexistence of a charge control agent at the time of obtaining the spacer particles; a method for copolymerizing a monomer composing the spacer particles and a charge control agent having a functional group copolymerizable with the monomer composing the spacer particles; a method for copolymerizing a charge control agent having a functional group copolymerizable with the monomer to be used for surface modification of the spacer particles at the time of surface-modifying the spacer particles, which will be described later; and a method for reacting the surface of the spacer particles and charged particles having a functional group reactive on the surface-modification layer or surface functional groups of the spacer particles.

The charge control agent is not particularly limited, and the charge control agent described in, for example, Japanese Kokai Publication 2002-148865 can be used. The charge control agent is not particularly limited, and examples thereof include organometal compounds, chelating compounds, monoazo type dye-metal compounds, acetylacetone-metal compounds, aromatic hydroxycarboxylic acids, aromatic mono and polycarboxylic acids, and their metal salts, anhydrides, esters, and phenol derivatives such as bisphenol.

Specifically, examples of the above-described charge control agent also include urea derivatives, metal-containing salicylic acid type compounds, quaternary ammonium salts, Calixarene, silicon compounds, styrene-acrylic acid copolymers, styrene-methacrylic acid copolymers, styrene-acrylsulfonic acid copolymers, non-metal carboxylic acid compounds, Nigrosine and fatty acid metal salt-modified compounds, tributylbenzyl ammonium 1-hydroxy-4-naphthosulfonate, quaternary ammonium salts such as tetrabutylammonium tetrafluoroborate, onium salts such as phosphoniums which are their analogous compounds, lake pigments of them, and triphenylmethane dyes and their lake pigments, higher fatty acid metal salts, diorganotin oxides such as dioctyltin oxide, dioctyltin oxide, and dicyclohexyltin oxide, and diorganotin borates such as dibutyltin borate, dioctyltin borate, and dicyclohexyltin borate. As agents for lake formation are exemplified phosphorus tungstic acid, phosphorus molybdic acid, tannic acid, lauric acid, gallic acid, ferricyanides, ferrocyanides and the like. These charge control agents may be used alone or two or more kinds thereof may be used in combination.

The polarity of the spacer particles containing the charge control agents can be set by properly selecting an adequate charge control agent among the charge control agents. That is, the spacer particles can be made positive charge or negative charge relatively to the ambient environments of the spacer particles.

Examples of the method for producing spacer particles using monomers comprising the above described electrostatically chargeable monomer include a method for using monomers having hydrophilic functional groups in combination among the above-described monomers. The spacer particles can be made to have positive charge or negative charge relatively to the ambient environments by properly selecting an adequate monomer among these monomers having hydrophilic functional groups.

Examples of the method for carrying out an electrostatic charge surface treatment on the spacer particles include a method for modifying the spacer particles by precipitating resin on the surfaces of the spacer particles as described in Japanese Kokai Publication Hei-1-247154; a method for modifying the spacer particles by reaction of compounds reactive on the functional groups on the surfaces of the spacer particles as described in Japanese Kokai Publication Hei-9-113915 or Japanese Kokai Publication Hei-7-300587; and a method for surface-modifying the spacer particles by graft polymerization and a method for forming the surface layer chemically combined with the surface of the spacer particles as described in Japanese Kokai Publication Hei-11-223821 or Japanese Kokai Publication 2003-295198. In carrying out these surface treatments, a proper method is selected so that the spacer particles are electrostatically charged.

As a method for carrying out an electrostatic charge surface treatment on the spacer particles, a surface layer chemically combined with the surface of the spacer particles is preferably formed in order to prevent the surface layer in the cells of the liquid crystal display apparatus from peeling and eluting in the liquid crystal.

As described above, adhesiveness to the substrate of spacer particles can be increased by carrying out a surface treatment on the spacer particles. In addition, when the monomer comprising the spacer particles is appropriately selected, the alignment disorder of the liquid crystal in the liquid crystal display elements can be prevented.

The spacer dispersion of the third invention can be obtained by dispersing the spacer particles in the solvent component that can disperse the spacer particles.

The spacer dispersion of the third invention contains at least a solvent X with a boiling point of 200° C. or more and a surface tension of 42 mN/m or more at 20° C.

With respect to the content amount of the solvent X, the solvent X is preferably prepared so that the lower limit of an content amount of the spacer dispersion of the third invention included in droplets ejected at a time from one nozzle of the below described ink-jet apparatus of the third invention is 0.5 ng and the upper limit thereof is 15 ng. When it is less than 0.5 ng, since the spacer particles do not gather in drying droplets of the spacer dispersion formed on the surface of the substrate, the spacer particles tend to be arranged on an area corresponding to a non-pixel area. When it exceeds 15 ng, in drying droplets comprising the spacer dispersion of the third invention formed on the surface of the substrate, it is necessary to dry the droplets, for example, at a high temperature of 70° C. or more, or at a temperature of less than 70° C. for a long period of time. In the case where they are dried at a high temperature of 70° C. or more, an alignment layer will become susceptible to damage; whereas in the case where they are dried at a temperature of less than 70° C. for a long period of time, it will take ten minutes or more to dry and production efficiency will be deteriorated.

The spacer dispersion of the third invention apart from the spacer particles contains 1% by weight or more of the solvent X. When it is less than 1% by weight of the solvent X, the spacer dispersion of the third invention may not be stably ejected from a nozzle of an ink-jet apparatus described below, and the spacer particles tend not to gather. The preferable lower limit is 10% by weight, and the preferable upper limit is 100% by weight. Moreover, in the case the spacer particles tend to precipitate in the spacer dispersion, the more preferable lower limit of a content percentage of the solvent X is 80% by weight, and the more preferable upper limit thereof is 100% by weight.

When a boiling point of the solvent X is less than 200° C., the spacer dispersion of the third invention tends to dry at the head of the nozzle of the ink-jet apparatus described below, and clogging of the nozzle tends to occur. Moreover, in the spacer dispersion comprising only the solvent with a boiling point of less than 180° C., clogging of the nozzle sometimes tends to occur. In addition, since a solvent with a boiling point of less than 200° C. has a lower density, it may become difficult to set a viscosity of the spacer dispersion in an appropriate range in the case where a solvent with a boiling point of 200° C. or more is not included. In addition, in the spacer dispersion comprising only the solvent with a boiling point of less than 200° C., it may become easier for the spacer particles to precipitate.

When a surface tension of the solvent X is less than 42 mN/m, in drying droplets comprising the spacer dispersion of the third invention formed on the substrate, spacer particles do not gather and the spacer particles tend to be arranged on a non-pixel area.

The solvent X is not particularly limited as long as it has the above-described boiling point and surface tension, and examples thereof include 1,3-propanediol, 1,4-butanediol, 1,5-pentanediol, 1,6-hexanediol, diethylene glycol, triethylene glycol, glycerin, 2-pyrrolidone, and nitrobenzene. Since spacer particles can be effectively gathered in a short period of time in drying, 1,3-propanediol, 1,4-butanediol and glycerin are preferably used among these. Since a liquid crystal spacer can be gathered much more effectively in a shorter period of time in drying, glycerin is more preferably used. These solvents X may be used alone, or two or more kinds thereof may be used in combination.

Various solvents, which are liquids in terms of a temperature at which ejection from a nozzle is carried out, may be included in the spacer dispersion of the third invention apart from the solvent X. A water-soluble and/or hydrophilic solvent(s) are/is preferable among them. As an ink-jet apparatus, the nozzle for the aqueous medium may be used. In the case where the nozzle for the aqueous medium is used and a highly hydrophobic solvent is used as the medium of the spacer dispersion, the solvent may affect a member composing a nozzle or may elute a part of adhesives, which bond the member. Therefore, in the case where the nozzle for the aqueous medium is used, the spacer dispersion preferably comprises a water and/or hydrophilic solvent(s).

Examples of the water-soluble and/or hydrophilic organic solvent(s) include the same solvents as the water-soluble and/or hydrophilic organic solvent(s) described in the spacer dispersion of the first invention.

The spacer dispersion of the third invention preferably comprises a solvent with a boiling point of 150° C. or more. Furthermore, more preferably, it comprises a solvent with a boiling point of 150° C. or more and a surface tension of 30 mN/m or more. When it comprises the solvent with a boiling point of 150° C. or more and a surface tension of 30 mN/m or more, the below-described receding contact angle (θr) can be enlarged. In addition, when it comprises the solvent with a boiling point of 150° C. or more and a surface tension of 30 mN/m or more, since a droplet diameter at the time when the spacer dispersion of the third invention is ejected and deposited on the substrate becomes small, droplets tend not to enlarge. Furthermore, it becomes easier for spacer particles to move to the deposition center of a droplet. Thereby, this enables the spacer particles to be precisely arranged on the substrate.

The preferable lower limit of the surface tension of the spacer dispersion of the third invention is 25 mN/m, and the preferable upper limit thereof is 50 mN/m. When the surface tension of the spacer dispersion of the third invention is lower than 25 mN/m, a droplet diameter at the time when the spacer dispersion of the third invention is ejected and deposited on the substrate may become too large, or the nozzle side of the head of the ink-jet apparatus may get wet and an ejection state may become unstable. When the surface tension exceeds 50 mN/m, inconveniences that air bubbles tend to remain in an ink chamber in the head of the ink-jet apparatus and ejection stops and the like may occur when the head is filled in with the spacer dispersion. However, in the case where wetted portions, such as the ink chamber in the head of the ink-jet apparatus, are formed by hydrophilic materials (for example, SUS, ceramics, and glass), and/or in the case where before charge of the spacer dispersion the head is filled in with solvents such as 2-propanol that have a lower surface tension and wet an ink chamber thoroughly, and after complete removal of air bubbles, a passage can be replaced with the inside of the head by using the spacer dispersion so as not to be involved in the air bubbles, ejection can be carried out even with the spacer dispersion exceeding 50 mN/m although it entails a lot of time and effort as thus described in terms of the equipment and steps.

The surface tension of the spacer dispersion of the third invention is adjusted by appropriately combining the above-described solvents.

In order to set the surface tension of the spacer dispersion of the third invention to 50 mN/m or less, preferably, solvents of the spacer dispersion of the third invention further comprise a solvent with a boiling point of less than 150° C. as well as the solvent X. Further preferably, the solvents comprise a solvent with a boiling point of 70° C. or more at less than 100° C.

Examples of the solvent with a boiling point of less than 150° C. include lower monoalcohols, such as ethanol, n-propanol, 2-propanol, 1-butanol, 2-butanol, and tert-butanol, and acetone and the like. These may be used alone, or two or more kinds thereof may be used in combination. Here, 2-propanol is the most favorable among these.

The solvent with a boiling point of less than 150° C. is vaporized at a relatively low temperature when dried after the spacer dispersion of the third invention is ejected on the substrate. Particularly in the spacer dispersion of the third invention, the drying temperature cannot be raised because, when solvents contact an alignment layer at a high temperature, the alignment layer will be contaminated and the display picture quality of the liquid crystal display apparatus will be damaged. Accordingly, it is preferable to use the solvent with a boiling point of less than 150° C. However, when the solvent with a boiling point of less than 150° C. tends to be vaporized at room temperature, agglomerate particles tend to occur at the time of manufacture and storage of the spacer dispersion of the third invention, the spacer dispersion of the third invention tends to dry in the vicinity of the nozzle of the ink-jet apparatus, the ejecting property and ejection accuracy may be impaired; therefore, the solvent that tends to be vaporized at room temperature is not favorable.

When a temperature to dry the spacer dispersion of the third invention is high, the alignment layer may be damaged, and the display picture quality of the liquid crystal display apparatus may be deteriorated. By using the solvent with a boiling point of less than 150° C., a drying temperature can be maintained at a lower value, and damage of the alignment layer can be prevented.

With respect to 100 parts by weight of the spacer dispersion of the third invention apart from the spacer particles, the preferable lower limit of a content of the solvent with a boiling point of less than 150° C. is 1.5 parts by weight, and the preferable upper limit thereof is 50 parts by weight. When it is less than 1.5 parts by weight, a drying velocity may decrease, and production efficiency of the liquid crystal display apparatus may lower. When it exceeds 50 parts by weight, the spacer dispersion of the third invention tends to dry at the head tip of the nozzle of the ink-jet apparatus. Furthermore, when the spacer dispersion of the third invention is produced or the spacer dispersion of the third invention is stored, it may be dried, and the spacer particles may be agglomerated.

With respect to the solvent with a boiling point of less than 150° C., at 20° C., a surface tension is preferably less than 28 mN/m and more preferably 25 mN/m or less. When a surface tension of the solvent is 28 mN/m or more, the surface tension of the spacer dispersion of the third invention increases, and ejecting property may be deteriorated depending on a surface tension of wetted portions of nozzles of the ink-jet apparatus.

When the spacer dispersion of the third invention comprises the solvent with a boiling point of less than 150° C. and a surface tension of less than 28 mN/m, the spacer dispersion tends to be introduced in the below-described ink-jet apparatus, and ejecting property will improve at the time of ejection.

When drying the spacer dispersion of the third invention, a solvent with a lower boiling point will be vaporized first. When a solvent with a lower boiling point is vaporized first, a proportion of a solvent X in the residual spacer dispersion of the third invention will become higher. As the proportion of the solvent X becomes higher, a surface tension of the residual spacer dispersion of the third invention becomes even higher, and the spacer particles tend to move to the deposition center.

The preferable lower limit of a viscosity at 20° C. of the spacer dispersion of the third invention is more than 5 mPa·s, and the preferable upper limit thereof is less than 20 mPa·s. When the viscosity is 5 mPa·s or less, the spacer particles dispersed in the spacer dispersion of the third invention are more likely to precipitate as time lapses. When the viscosity is 20 mPa·s or more, it may be difficult to control the ejection amount at the time of ejection of the spacer dispersion of the third invention. In order to control the ejecting property, the spacer dispersion of the third invention may have to be excessively warmed.

The preferable lower limit of a density of the spacer dispersion of the third invention at 20° C. is 1.00 g/cm³. When it is less 1.00 g/cm³ the spacer particles dispersed in the spacer dispersion of the third invention is more likely to precipitate as time lapses.

The preferable lower limit of a precipitating speed of the spacer dispersion of the third invention is 150 minutes. The precipitating speed means a period of time until deposition of the spacer particles are observed with eyes at the bottom of the test tube when the spacer particles are made to still stand after the spacer dispersion of the third invention is introduced in the test tube with an inner diameter φ of 5 mm so as to have a height of 10 cm.

When the lower limit of the precipitating speed of the spacer dispersion of the third invention is 150 minutes, it will become difficult for the spacer particles to precipitate until the spacer dispersion of the third invention is ejected after introduction of the spacer dispersion of the third invention in the ink-jet apparatus. Therefore, the spacer dispersion of the third invention can be stably ejected using the ink-jet apparatus.

The preferable lower limit of a receding contact angle (θr) of the spacer dispersion of the third invention to the substrate is 5 degrees at the time of ejection thereof on the substrate. When the lower limit of the receding contact angle (θr) is 5 degrees, the droplets tend to shrink toward a deposition center of the spacer dispersion of the third invention. In addition, even in the case where one droplet comprises a plurality of spacer particles, the spacer particles tend to gather toward a deposition center.

The receding contact angle means the contact angle in the steps up to the drying step after the spacer dispersion of the third invention ejected on the substrate is deposited on the substrate when the deposition diameter of the spacer dispersion of the third invention deposited on the substrate becomes smaller, namely, when the droplet begins to shrink or when 80 to 95% by weight of the volatile component in the droplet is volatilized.

Examples of a method for setting the receding contact angle (θr) to 5 degrees or more include a method for preparing the composition of the solvent of the above-described third invention or a method for carrying out a surface treatment.

When the composition of the solvent of the third invention is prepared, a solvent with a receding contact angle (θr) of 5 degrees or more may be used alone, or two or more kinds may be used in combination. When two or more kinds of solvents are mixed and used, dispersibility of the spacer particles, workability in using the spacer dispersion of the third invention, a drying velocity of the spacer dispersion of the third invention, and the like can be adjusted easily.

In the case where two or more kinds of the solvents are mixed and used, the solvent having the highest boiling point among the solvents to be mixed preferably has a receding contact angle (θr) of 5 degrees or more. When the receding contact angle (θr) of the solvent having the highest boiling point is lower than 5 degrees, the solvent having the highest boiling point in the drying step will remain. In this case, a droplet diameter of the spacer dispersion of the third invention will become large, and the droplets tend to spread. In addition, the spacer particles tend to gather toward a deposition center.

The receding contact angle (θr) tends to become smaller in comparison with the contact angle measured immediately after the spacer dispersion of the third invention is deposited on the substrate. It is because the solvent forming the spacer dispersion of the third invention is not in sufficient contact with the surface of the substrate at the initial contact angle while the solvent is in sufficient contact with the surface of the substrate at the receding contact angle (θr). In the case where the receding contact angle is considerably low as compared with the initial contact angle, the alignment layer may be damaged by the solvent.

The preferable lower limit of the initial contact angle of the spacer dispersion of the third invention to the substrate is 10 degrees, and the preferable upper limit thereof is 110 degrees. When it is less than 10 degrees, the spacer dispersion of the third invention ejected on the substrate may spread on the substrate, and the arrangement intervals of the spacer particles may become large. When it exceeds 110 degrees, the droplets of the spacer particles may easily move on the substrate, the arrangement accuracy may be deteriorated, or the adhesiveness between the spacer particles and the substrate may be deteriorated.

The preferable lower limit of the viscosity of the spacer dispersion of the third invention at the time of ejection from the ink-jet apparatus is 0.5 mPa·s, and the preferable upper limit thereof is 15 mPa·s. When it is less than 0.5 mPa·s, it may become difficult to control an ejection amount. Meanwhile, when it exceeds 15 mPa·s, ejection may become difficult. The more preferable lower limit is 5 mPa·s, and the more preferable upper limit is 10 mPa·s.

In addition, at the time of ejecting the spacer dispersion of the third invention, preferably, the nozzle of the ink-jet apparatus is cooled by a Peltier element or a coolant or heated by a heater, thereby setting the temperature of the spacer dispersion of the third invention to the range of −5 to 50° C. at the time of ejecting the spacer particle dispersion.

The preferable lower limit of a solid concentration of the spacer particles in the spacer dispersion of the third invention is 0.01% by weight, and the preferable upper limit is 5% by weight. When it is less than 0.01% by weight, the spacer particles may not be included in ejected droplets. When it exceeds 5% by weight, nozzles of the ink-jet apparatus tend to be clogged, or a content of the spacer particles in the ejected droplets of the spacer dispersion of the second invention may become too much, and movement of the spacer particles and adhesive particles in the drying step may become difficult. The more preferable lower limit thereof is 0.2% by weight, and the more preferable upper limit thereof is 2% by weight.

Moreover, the solid concentration of the spacer particles in the spacer dispersion of the third invention can be appropriately determined by the arrangement number of the spacer particles to be arranged on the substrate.

The liquid crystal spacer of the present invention is preferably dispersed in the form of a single particle in the spacer dispersion of the third invention. When agglomerated spacer particles are in the spacer dispersion of the third invention, ejecting property may be lowered or nozzles of the ink-jet apparatus may be clogged.

In the spacer dispersion of the third invention, an adhesive component may be added to impart adhesiveness in the spacer dispersion of the third invention as long as it does not inhibit the effects of the present invention. Examples of the adhesive component include the above-described spacer particles of the second invention.

Furthermore, various surfactants or viscosity adjusters may be added to the spacer dispersion of the third invention in order to enhance dispersibility of the spacer particles, control physical properties such as a surface tension and a viscosity to enhance ejecting properties, and enhance movement performance of the spacer particles at the time of drying.

Here, the above-described spacer dispersion of the first, second, and third inventions (hereinafter, these are also collectively referred to as the spacer dispersion of the present invention) contain each the above-described solvent, and preferably, the composition of the solvent is appropriately combined and prepared in accordance with the below-described state of the ink chamber inside the head of the ink-jet apparatus and the like.

In the case where wetted portions, such as an ink chamber in the head of the ink-jet apparatus, are formed by hydrophilic materials (SUS, ceramics, and glass), and/or in the case where before charge of the spacer dispersion the head is filled in with solvents such as 2-propanol that have a lower surface tension and wet an ink chamber thoroughly, and after complete removal of air bubbles, a passage can be replaced with the inside of the head by using the spacer dispersion of the present invention so as not to be involved in the air bubbles, examples of a preferable combination of the solvent comprising the spacer dispersion of the present invention include a combination of: the solvent with a boiling point being 150° C. or more, a surface tension being 30 mN/m or more, the preferable lower limit being 30% by weight, and the preferable upper limit being 96% by weight (the further preferable lower limit being 45% by weight, the further preferable upper limit being 94% by weight); and water with the preferable lower limit being 4% by weight, and the preferable upper limit being 70% by weight (the further preferable lower limit being 6% by weight, and the further preferable upper limit being 55% by weight). In the case where the solvent has such a combination, when water is less than 4% by weight, a viscosity of the spacer dispersion of the present invention will be so high that the problem may occur that the spacer dispersion of the present invention tends not to be ejected from an ink-jet head (a driving voltage becomes excessively high); whereas when the water exceeds 70% by weight, a viscosity of the spacer dispersion of the present invention will become too low, the problem may occur that the spacer dispersion of the present invention will become excessively low, ejection stability, specifically stability of high-frequency driving conditions, will be lower.

In addition, in the case where the above-described head is not used in the ink-jet apparatus, examples of a preferable combination of the solvent include a combination of: a solvent with a boiling point of less than 150° C. and a surface tension of less than 28 mN/m, and with the preferable lower limit thereof being 2% by weight, the preferable upper limit thereof being 40% by weight (the further preferable lower limit thereof being 5% by weight, and the further preferable upper limit thereof being 20% by weight); a solvent with a boiling point of 150° C. or more, and a surface tension of 30 mN/m or more, and with the preferable lower limit thereof being 30% by weight, and the preferable upper limit thereof being 96% by weight (the further preferable lower limit thereof being 40% by weight, and the further preferable upper limit thereof being 90% by weight); and water with the preferable lower limit thereof being 0% by weight, and the preferable upper limit thereof being 60% by weight (the further preferable lower limit thereof being 5% by weight, and the further preferable upper limit thereof being 40% by weight). Moreover, in the case where the solvent has such a combination, the percentage obtained by adding the solvent with a boiling point of less than 150° C. and a surface tension of less than 28 mN/m to the water is a quantity obtained by excluding the solvent with a boiling point of 150° C. or more and a surface tension of 30 mN/m or more; namely, the preferable lower limit thereof is 4% by weight, and the preferable upper limit thereof is 70% by weight (the further preferable lower limit thereof is 6% by weight, and the further preferable upper limit thereof is 55% by weight). Moreover, in the case where the solvent has such a combination, the percentage obtained by adding the solvent with a boiling point of less than 150° C. and a surface tension of less than 28 mN/m to the water is a quantity obtained by excluding the solvent with a boiling point of 150° C. or more and a surface tension of 30 mN/m or more; namely, the preferable lower limit thereof is 4% by weight, and the preferable upper limit thereof is 70% by weight (the further preferable lower limit thereof is 6% by weight, and the further preferable upper limit thereof is 55% by weight).

When the solvent with a boiling point of less than 150° C. and a surface tension of less than 28 mN/m has less than 2% by weight, a surface tension of the spacer dispersion of the present invention will become so high that there are more likely to be problems that air bubbles will remain in an ink chamber at the time of introduction of the spacer dispersion in the head and non-ejecting nozzles will occur. When the solvent exceeds 40% by weight, a surface tension of the spacer dispersion of the present invention will become so low that there may arise problems that at the time of ejection of the spacer dispersion of the present invention on the substrate, the deposition diameter of the droplets deposited on the substrate will become so large that the spacer particles tend not to gather on the substrate.

In addition, in the case where the amount obtained by adding water and a solvent with a boiling point of less than 150° C. and a surface tension of less than 28 mN/m is less than 4% by weight, a viscosity of the spacer dispersion of the present invention will be so high that the problem may occur that the spacer dispersion of the present invention tends not to be ejected from an ink-jet head (a driving voltage becomes excessively high); whereas when the water exceeds 70% by weight, a viscosity of the spacer dispersion of the present invention will become so low that the problem may occur that the spacer dispersion of the present invention will become excessively low, ejection stability, specifically stability of high-frequency driving conditions will be lower.

Furthermore, in the case where the spacer dispersion of the third invention and the spacer dispersion of the first and second inventions contain a solvent X, namely in the case where spacers are made to gather even on the substrate having a high surface tension, examples of a preferable combination of the solvent include a combination of: a solvent with a boiling point of less than 150° C. and a surface tension of less than 28 mN/m, and with the preferable lower limit thereof being 2% by weight, the preferable upper limit thereof being 40% by weight (the further preferable lower limit thereof being 5% by weight, and the further preferable upper limit thereof being 20% by weight); and a solvent with a boiling point of 150° C. or more and a surface tension of 30 mN/m or more, and with the preferable lower limit thereof being 0% by weight, and the preferable upper limit thereof being 95% by weight (the further preferable lower limit thereof being 40% by weight, and the further preferable upper limit thereof being 90% by weight); a solvent X with the preferable lower limit thereof being 1% by weight, and the preferable upper limit thereof being 96% by weight (the further preferable lower limit thereof being 3% by weight, and the further preferable upper limit thereof being 40% by weight); and water with the preferable lower limit thereof being 0% by weight, and the preferable upper limit thereof being 60% by weight (the further preferable lower limit thereof being 5% by weight, and the further preferable upper limit thereof being 40% by weight). Moreover, in the case where the solvent containing the solvent X has such a combination, the percentage obtained by adding the solvent with a boiling point of less than 150° C. and a surface tension of less than 28 mN/m to the water is 4 to 70% by weight (further preferably 6 to 55% by weight), and the percentage obtained by adding the solvent with a boiling point of 150° C. or more and a surface tension of 30 mN/m or more to the solvent X is 30 to 96% by weight (further preferably 40 to 90% by weight).

When the solvent with a boiling point of less than 150° C. and a surface tension of less than 28 mN/m is less than 2% by weight, a surface tension of the spacer dispersion of the present invention will become so high that there are more likely to be problems that air bubbles will remain in an ink chamber at the time of introduction of the spacer dispersion in the head and non-ejecting nozzles will occur. When the solvent exceeds 40% by weight, a surface tension of the spacer dispersion of the present invention will become so low that there will arise problems that at the time of ejection of the spacer dispersion of the present invention on the substrate, the deposition diameter of the droplets deposited on the substrate will become so large that the spacer particles tend not to gather on the substrate.

In addition, in the case where the amount obtained by adding water and a solvent with a boiling point of less than 150° C. and a surface tension of less than 28 mN/m is less than 4% by weight, a viscosity of the spacer dispersion of the present invention will be so high that the problem may occur that the spacer dispersion of the present invention tends not to be ejected from an ink-jet head (a driving voltage becomes excessively high); whereas when the water exceeds 70% by weight, a viscosity of the spacer dispersion of the present invention will become so low that the problem may occur that the spacer dispersion of the present invention will become excessively low, ejection stability, specifically stability of high-frequency driving conditions will be lower.

When the solvent X is less than 1% by weight, a problem may arise that spacer particles tend not to gather on the substrate having a higher surface tension; whereas when it exceeds 96% by weight, it will take so much time to dry droplets of the spacer dispersion of the present invention deposited on the substrate that there may arise a problem that productivity will decrease, or the necessity to heat at a higher temperature may cause a problem that an alignment layer is more likely to be impaired.

Moreover, even when the above-described solvent X is contained, in the case where wetted portions, such as an ink chamber in the head of the ink-jet apparatus, are formed by hydrophilic materials (SUS, ceramics, and glass), and/or in the case where before charge of the spacer dispersion the head is filled in with solvents such as 2-propanol that have a lower surface tension and wet the ink chamber thoroughly, and after complete removal of air bubbles, a passage can be replaced the inside of the head by using the spacer dispersion of the present invention so as not to be involved in the air bubbles after completely removing air bubbles, with respect to a preferable combination of the solvent, addition of the solvent with a boiling point of less than 150° C. and a surface tension of less than 28 mN/m is not necessary, a combination of the other solvents are preferable; examples of the preferable combination include a combination of: the solvent with a boiling point of 150° C. or more and a surface tension of 30 mN/m or more, and with the preferable lower limit thereof being 0% by weight, the preferable upper limit thereof being 95% by weight (the further preferable lower limit thereof being 40% by weight, and the further preferable upper limit thereof being 90% by weight); the solvent X with the preferable lower limit thereof being 1% by weight, the preferable upper limit thereof being 65% by weight (the further preferable lower limit thereof being 3% by weight, and the further preferable upper limit thereof being 40% by weight); and water with the preferable lower limit thereof being 4% by weight, and the preferable upper limit thereof being 70% by weight (the further preferable lower limit thereof being 6% by weight, and the further preferable upper limit thereof being 55% by weight). Moreover, in the case where the solvent containing the solvent X has such a combination, the percentage obtained by adding the solvent with a boiling point of 150° C. or more and a surface tension of 30 mN/m or more to the solvent X is 30 to 96% by weight (further preferably 40 to 90% by weight).

In the case where the solvent has such a combination, when water is less than 4% by weight, a viscosity of the spacer dispersion of the present invention will be so high that the problem may occur that the spacer dispersion of the present invention tends not to be ejected from an ink-jet head (a driving voltage becomes excessively high); whereas when the water exceeds 70% by weight, a viscosity of the spacer dispersion of the present invention will become so low that the problem may occur that the spacer dispersion of the present invention will become excessively low, and ejection stability, specifically stability of high-frequency driving conditions will be lower.

When the solvent X is less than 1% by weight, the problem may arise that spacer particles tend not to gather on the substrate having a higher surface tension; whereas when it exceeds 96% by weight, it will take so much time to dry droplets of the spacer dispersion of the present invention deposited on the substrate that there may arise a problem that productivity will decrease, or the necessity to heat at a higher temperature may cause a problem that an alignment layer is more likely to be impaired.

The spacer dispersion of the present invention preferably contains an adhesive.

The adhesive will exert adhesiveness in the drying step of the spacer dispersion of the present invention deposited on the substrate, and have a role of more firmly fixing the spacer particles to the substrate. In particular, the spacer dispersion of the third invention preferably contains the adhesive. It is because the spacer particles arranged can be firmly fixed to the substrate in addition to the above-described effect of gathering the spacer particles effectively in a short period of time at the time of drying.

The adhesive may be dissolved or dispersed in the spacer dispersion of the present invention. In the case where the adhesive is dispersed therein, the dispersion diameter thereof is preferably 10% or less of the particle diameter of the spacer dispersion.

As the adhesive, an adhesive that is very flexible, namely, has a lower modulus of elasticity (after curing) than that of spacer particles, is preferably used in order not to impair gap retention capacity of the spacer particles.

Examples of the adhesive include thermoplastic resins with a glass transition point of 150° C. or less; resins that solidify by vaporization of a solvent; curable resins such as heat-curable resins, photo-curable resins, and photo- and heat-curable resins. Moreover, as the adhesive, an adhesive having a lower molecular weight is preferably used in particular.

The thermoplastic resins with a glass transition point of 150° C. or less melts or softens caused by heat when applying thermocompression bonding to the substrate to exert adhesiveness, and can firmly fix the spacer particles to the substrate.

The thermoplastic resins with a glass transition point of 150° C. or less are preferably not dissolved in the alignment layer solvent and preferably do not dissolve the alignment layer. In the case where thermoplastic resins that are dissolved in the alignment layer solvent and dissolve the alignment layer are used, they may cause contamination of the liquid crystal.

The glass transition point is 150° C. or less, and thermoplastic resins that are not dissolved in the alignment layer solvent and do not dissolve the alignment layer are not particularly limited, and examples thereof include poly(meth)acrylic resins, polyurethane resins, polyester resins, epoxy resins, polyamide resins, polyimide resins, cellulosic resins; polyolefin resins such as polybutadiene and polybutylene; polyvinyl resins such as polyvinyl chloride, polyvinyl acetate, and polystyrene; polyacryl resins, polycarbonate resins, and polyacetal resins. In addition, in copolymers such as styrene-butadiene-styrene resins, thermoplastic resins with a glass transition point of 150° C. or less can also be used by preparing a monomer component.

Resins that are cured by vaporization of the solvent of the spacer dispersion of the present invention are not being cured while mixed in the spacer dispersion, and are cured by vaporization of the solvent after ejection of the spacer dispersion of the present invention on the substrate; whereby spacer particles can be firmly fixed to the substrate.

Examples of such resins include an acrylic adhesive using a blocked isocyanate when the solvent is aqueous. Water-soluble and crosslinkable resins are preferable among these.

The curable resins such as heat-curable resins, photo-curable resins, and photo- and heat-curable resins will be cured by heating and/or light radiation after ejection of the spacer dispersion on the substrate in a state of not being cured while mixed into the spacer dispersion, whereby spacer particles can be firmly fixed to the substrate.

The heat-curable resins are not particularly limited, and examples thereof include phenolic resins, melamine resins, unsaturated polyester resins, an epoxy resin, and maleimide resins. In addition, alkoxymethylacrylamide in which the reaction starts by heating; resins having a reactive functional group in which crosslinking reactions (a urethane reaction, an epoxy crosslinking reaction, and the like) occur by mixing a crosslinking agent therein beforehand and heating; a monomer mixture (for example, a mixture of an oligomer having an epoxy group on a side chain and an initiator) that reacts by heating to form a crosslinking polymer can be used.

The photo-curable resins are not particularly limited, and examples thereof include a mixture of an initiator that starts a reaction by light and various monomers (for example, a mixture of a photoradical initiator and an acrylic monomer binder; a mixture of a photoacid generating initiator and a epoxy oligomer); polymers having a reactive group that crosslinks by light (cinnamic acid based compound and the like); and an azide compound.

In the spacer dispersion of the present invention, the adhesive has a constituent unit expressed by the following general formula (1) and a constituent unit expressed by the following general formula (2), and is preferably a mixture of a copolymer (A) having a content of 5 to 90 mol % of a constituent unit expressed by the following general formula (1) and having a content of 10 to 95 mol % of a constituent unit expressed by the following general formula (2) and a polyhydric compound (B) of at least one kind selected from the group consisting of polycarboxylic acid anhydride, polycarboxylic acid, aromatic polyhydric phenol, and aromatic polyhydric amine. Moreover, hereinafter, the adhesive component, which is a mixture of the copolymer (A) and the polyhydric compound (B), is also referred to as an “adhesive comprising a mixture”.

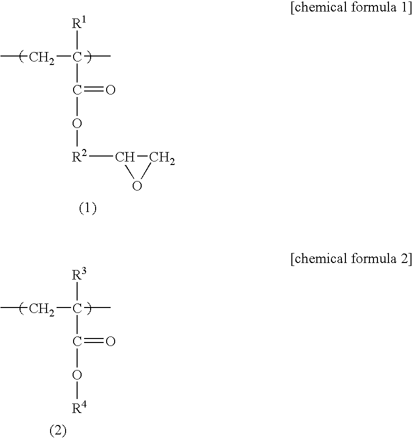

In the formula, R¹ and R³ represent a hydrogen atom or a methyl group, R² represents an alkyl group with the carbon number of 1 to 8, and R⁴ represents an alkyl group with the carbon number of 1 to 12, or a cycloalkyl group with the carbon number of 5 to 12, or an aromatic group. In addition, the cycloalkyl group or the aromatic group may have a substituent group.

When the adhesive is the adhesive comprising a mixture, gelling of the spacer dispersion of the present invention caused by progress of a crosslinking reaction shown in a normal acid-epoxy copolymer does not occur, and it becomes possible to raise a content percentage of an epoxy group of the adhesive comprising a mixture. In addition, since a higher concentration and a lower viscosity of the spacer dispersion of the present invention containing the adhesive comprising a mixture can be realized, it is possible to disperse spacer particles with an ink-jet apparatus; and since the adhesive comprising a mixture dispersed on the substrate together with the spacer particles has a higher capacity of firmly fixing the spacer particles on the substrate and furthermore a higher crosslinking density after cured can be obtained, a gap holding member excellent in various resistance can be formed and heat resistance thereof can also be improved. That is, after droplets of the spacer dispersion of the present invention are ejected and deposited on a predetermined position of the substrate, and then dried, by containing the adhesive comprising a mixture as an adhesive, the spacer particles can be arranged precisely and firmly on a predetermined position of the substrate.

The copolymer (A) contained in the adhesive comprising a mixture has a constituent unit expressed by the following general formula (1) (hereinafter, also referred to as a constituent unit (a1)) and a constituent unit expressed by the following general formula (2) (hereinafter, also referred to as a constituent unit (a2)).

With regard to the monomer to form the constituent unit (a1), examples thereof include an epoxy group-containing radical polymerizable compound. The epoxy group-containing radical polymerizable compound is not particularly limited, and examples thereof include glycidyl acrylate, glycidyl methacrylate, glycidyl α-ethylacrylate, glycidyl α-n-propylacrylate, glycidyl α-n-butylacrylate, 3,4-epoxybutyl acrylate, 3,4-epoxybutyl methacrylate, 6,7-epoxyheptyl acrylate, 6,7-epoxyheptyl methacrylate, and 6,7-epoxyheptyl α-ethylacrylate. Among others, glycidyl acrylate and glycidyl methacrylate are preferably used. These compounds may be used alone or in combination of two or more species.

In the copolymer (A), the lower limit of a content of the constituent unit (a1) is 5 mol %, and the upper limit thereof is 90 mol %. When it is less than 5 mol %, heat resistance and chemical resistance of the adhesive comprising a mixture will fall; whereas when it exceeds 90 mol %, the spacer dispersion of the present invention containing the adhesive comprising a mixture will gel. The preferable lower limit thereof is 10 mol %, and the preferable upper limit is 70 mol %.

With regard to the monomer of the constituent unit (a2), examples thereof include a monoolefin unsaturated compound. The monoolefin unsaturated compound is not particularly limited, and examples thereof include methacrylic alkyl esters such as methyl methacrylate, ethyl methacrylate, n-butyl methacrylate, sec-butyl methacrylate and t-butyl methacrylate; acrylic alkyl esters such as methyl acrylate n-butyl acrylate and isopropyl acrylate; methacrylic cycloalkyl esters such as cyclohexyl methacrylate, 2-methylcyclohexyl methacrylate, dicyclopentenyl oxyethyl methacrylate and isobornyl methacrylate; acrylic cycloalkyl esters such as cyclohexyl acrylate, 2-methylcyclohexyl acrylate, dicyclopentanyl acrylate, dicyclopenta oxyethyl acrylate and isobornyl acrylate; methacrylic aryl esters such as phenyl methacrylate and benzyl methacrylate; acrylic aryl esters such as phenyl acrylate and benzyl acrylate; dicarboxylic diesters such as diethyl maleate, diethyl fumarate and diethyl itaconate; hydroxyalkyl esters such as 2-hydroxyethyl methacrylate and 2-hydroxypropyl methacrylate; styrene, α-methylstyrene, m-methylstyrene, p-methylstyrene, vinyl toluene, p-methoxystyrene, acrylonitrile, methacrylonitrile, vinyl chloride, vinylidene chloride, acrylamide, methacrylamide and vinyl acetate. Among others, methacrylic alkyl esters, acrylic alkyl esters, styrene, dicyclopentanyl acrylate and p-methoxystyrene are suitably used. These may be used alone or in combination of two or more species.

In the copolymer (A), the lower limit of a content of the constituent unit (a2) is 10 mol %, and the upper limit thereof is 95 mol %. When it is less than 10 mol %, the spacer dispersion of the present invention containing the adhesive comprising a mixture will gel; whereas when it exceeds 95 mol %, heat resistance and chemical resistance of the adhesive comprising a mixture will fall. The preferable lower limit thereof is 30 mol %, and the preferable upper limit is 90 mol %.

Here, when a copolymer is produced merely from a monomer to form the constituent unit (a1) and a monomer to form the constituent unit (a2), an epoxy group and a carboxylic acid group may react and crosslink, and a polymerization system may gel.

However, since the spacer dispersion of the present invention containing the adhesive comprising a mixture contains the polyhydric compound (B), gelling of the spacer dispersion of the present invention caused by progress of a crosslinking reaction shown in a normal acid-epoxy copolymer does not occur, and it becomes possible to raise a content percentage of an epoxy group of the adhesive comprising a mixture. In addition, since a higher concentration and a lower viscosity of the spacer dispersion of the present invention containing the adhesive comprising a mixture can be realized, it is possible to disperse spacer particles with an ink-jet apparatus; and since the adhesive comprising a mixture dispersed on the substrate together with the spacer particles has a higher capacity of firmly fixing the spacer particles on the substrate and furthermore a higher crosslinking density after cured can be obtained, a gap holding member excellent in various resistance can be formed and heat resistance thereof can also be improved.

A method for producing the copolymer (A) having the constituent unit (a1) and the constituent unit (a2) is not particularly limited, and examples thereof include a conventional method for copolymerizing the above-described monomer to form the constituent unit (a1) and the above-described monomer to form the constituent unit (a2) in a conventional solvent so that these monomers have the ratio.

The polyhydric compound (B) serves as a curing agent of the copolymer (A), and the polyhydric compound (B) of this kind is at least one kind selected from the group consisting of polycarboxylic acid anhydride, polycarboxylic acid, aromatic polyhydric phenol, and aromatic polyhydric amine.

Examples of the polycarboxylic acid anhydride include aliphatic dicarboxylic anhydride such as itaconic anhydride, succinic anhydride, citraconic anhydride, dodecenylsuccinic anhydride, tricarballylate anhydride, maleic anhydride, hexahydrophthalic anhydride, methyltetrahydrophthalic anhydride, and himic anhydride; aliphatic polycarboxylic dianhydride such as 1,2,3,4-butanetetracarboxylic dianhydride and cyclopentanetetracarboxylic dianhydride; aromatic polycarboxylic anhydride such as phthalic anhydride, pyromellitic anhydride, trimellitic anhydride, and benzophenonetetracarboxylic anhydride; ester group-containing acid anhydride such as ethyleneglycol bis trimellitate anhydride and glycerin tris trimellitate anhydride. Aromatic polycarboxylic acid anhydride is preferable among these from a standpoint of heat resistance.

In addition, a commercially available epoxy resin curing agent comprising a colorless acid anhydride can also be used suitably. With regard to the commercially available epoxy resin curing agent comprising a colorless acid anhydride, examples thereof include Adeka Hardener EH-700 (produced by ADEKA Corporation); Rikacid HH and Rikacid MH-700 (produced by New Japan Chemical Co., Ltd.); Epikure 126, Epikure YH-306 and Epikure DX-126 (produced by Yuka Shell Epoxy K.K.); and Epiclon B (produced by Dainippon Ink and Chemicals, Incorporated)

Examples of the polycarboxylic acid include aliphatic polycarboxylic acids such as succinic acid, glutaric acid, adipic acid, butane tetra carboxylic acid, maleic acid and itaconic acid; alicyclic polycarboxylic acids such as hexahydrophthalic acid, 1,2-cyclohexane carboxylic acid, 1,2,4-cyclohexanetri carboxylic acid and cyclopentane tetra carboxylic acid; and aromatic polycarboxylic acids such as phthalic acid, isophthalic acid, terephthalic acid, trimellitic acid, pyromellitic acid and 1,2,5,8-naphthalene tetra carboxylic acid. Among others, the aromatic polycarboxylic acid is suitable from the viewpoint of reactivity and thermal resistance.

These curing agents may be used alone or in combination of two or more species.

A mixing ratio of the copolymer (A) to the polyhydric compound (B) in the adhesive comprising a mixture is not particularly limited, and the preferable lower limit of the polyhydric compound (B) with respect to 100 parts by weight of the copolymer (A) is 1 part by weight, and the preferable upper limit thereof is 100 parts by weight. When it is less than 1 part by weight, heat resistance and chemical resistance of the cured substance may lower. When it exceeds 100 parts by weight, a large quantity of unreacted curing agents may remain and heat resistance of the cured substance and non-staining properties to liquid crystal may be reduced. The more preferable lower limit thereof is 3 parts by weight, and the more preferable upper limit thereof is 50 parts by weight.

In the spacer dispersion of the present invention containing the adhesive comprising a mixture, the adhesive comprising a mixture may contain components other than the copolymer (A) and the polyhydric compound (B), and compounding agents such as a curing accelerator and an adhesion assisting agent may be mixed therein if necessary.

The curing accelerators will accelerate a reaction between an epoxy group of the copolymer (A) and the polyhydric compound (B) and be used to increase a crosslinking density, and compounds having a heterocyclic ring structure comprising a secondary nitrogen atom or a ternary nitrogen atom are preferable. Examples thereof include pyrrole, imidazole, pyrazole, pyridine, pyrazine, pyrimidine, indole, indazole, benzimidazole, and isocyanuric acid. Specifically, examples of the imidazole compound includes 2-methylimidazole, 2-ethyl-4-methylimidazole, 2-heptadecylimidazole, 4-methyl-2-phenylimidazole, 1-benzyl-2-methylimidazole, 2-ethyl-4-methyl-1-(2′-cyanoethyl)imidazole, 2-ethyl-4-methyl-1-[2′-(3″, 5″-diaminotriazinyl)ethyl]imidazole, and imidazole derivatives such as benzimidazole. And 2-ethyl-4-methylimidazole, 4-methyl-2-phenylimidazole, and 1-benzyl-2-methylimidazole are preferably used among these.

These curing accelerator may be used alone or in combination of two or more species.

In the case where the curing accelerators are contained, a mixing amount is not particularly limited, and the preferable lower limit thereof with respect to 100 parts by weight of the copolymer (A) is 0.01 parts by weight, and the preferable upper limit thereof is 2 parts by weight. When it is less than 0.01 parts by weight, an effect of mixing a curing accelerator almost cannot be obtained. When it exceeds 2 parts by weight, unreacted curing agents may remain and heat resistance of the cured substance and non-staining properties to liquid crystal may be reduced.

Furthermore, in the spacer dispersion of the present invention, the adhesive is a copolymer having a constituent unit expressed by the following general formula (1) and a constituent unit expressed by the following general formula (2), and a constituent unit derived from unsaturated carboxylic acid and/or unsaturated carboxylic acid anhydride. The copolymer preferably has a content of 1 to 70 mol % of a constituent unit expressed by the following general formula (1), has a content of 10 to 98 mol % of a constituent unit expressed by the following general formula (2), and has a content of 1 to 70 mol % of a constituent unit derived from the unsaturated carboxylic acid and/or the unsaturated carboxylic acid anhydride. Moreover, hereinafter, the adhesive, which is a copolymer, having the constituent unit expressed by the below-described general formula (1) and a constituent unit expressed by the following general formula (2) and having the constituent unit derived from unsaturated carboxylic acid and/or unsaturated carboxylic acid anhydride, is also referred to as an “adhesive comprising a copolymer”.

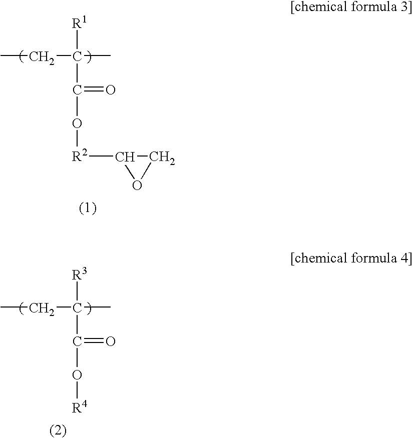

In the formula, R¹ and R³ represent a hydrogen atom or a methyl group, R² represents an alkyl group with the carbon number of 1 to 8, and R⁴ represents an alkyl group with the carbon number of 1 to 12, or a cycloalkyl group with the carbon number of 5 to 12, or an aromatic group. In addition, the cycloalkyl group or the aromatic group may have a substituent group.

When the adhesive is the adhesive comprising a copolymer, since in the spacer dispersion of the present invention, the adhesive comprising a copolymer has a constituent unit derived from unsaturated carboxylic acid and/or unsaturated carboxylic acid anhydride, an epoxy group and a carboxylic acid group contained in the adhesive comprising a copolymer react and a polymerization system is more unlikely to gel, leading to excellent storage stability. Furthermore, since the adhesive comprising a copolymer is easily cured merely by heating, it is not necessary to use a specific curing agent, a gap holding member of the liquid crystal display apparatus having a very little staining material to an alignment layer on the substrate and liquid crystal can be obtained. That is, by containing the adhesive comprising a copolymer as an adhesive, the spacer particles can be arranged precisely and firmly on a predetermined position of the substrate, and lower staining properties to an alignment layer and liquid crystal can be achieved when the adhesive is used for producing the liquid crystal display apparatus.

The adhesive comprising a copolymer is a copolymer having the constituent unit expressed by the general formula (1) (hereinafter, also referred to as a constituent unit (a)) and the constituent unit expressed by the following general formula (2) (hereinafter, also referred to as a constituent unit (b)) and having the constituent unit derived from unsaturated carboxylic acid and/or unsaturated carboxylic acid anhydride (hereinafter, also referred to as a constituent unit (c)).

The monomer to form the constituent unit (a) is not particularly limited, and examples thereof include the epoxy group-containing radical polymerizable compound same as the above-described constituent unit (a1) in the adhesive comprising a mixture.

In the copolymer, the lower limit of a content of the constituent unit (a) is 1 mol %, and the upper limit thereof is 70 mol %. When it is less than 1 mol %, heat resistance and chemical resistance of the adhesive comprising a copolymer will fall; whereas when it exceeds 70 mol %, the spacer dispersion containing the adhesive comprising a copolymer will gel. The preferable lower limit thereof is 5 mol %, and the preferable upper limit is 40 mol %. The further preferable upper limit is 20 mol %.

The monomer to form the constituent unit (b) is not particularly limited, and examples thereof include a monoolefin unsaturated compound same as the above-described constituent unit (a2) in the adhesive comprising a mixture.

In the copolymer, the lower limit of a content of the constituent unit (b) is 10 mol %, and the upper limit thereof is 98 mol %. When it is less than 10 mol %, the spacer dispersion of the present invention containing the adhesive comprising a copolymer will gel; whereas when it exceeds 98 mol %, heat resistance and chemical resistance of the adhesive comprising a copolymer will fall. The preferable lower limit thereof is 20 mol %, and the preferable upper limit is 90 mol %.

With regard to the monomer of the constituent unit (c), examples thereof include monocarboxylic acids such as acrylic acid, methacrylic acid and crotonic acid; and dicarboxylic acids such as maleic acid, fumaric acid, citraconic acid, measaconic acid and itaconic acid and anhydrides of these. Especially, acrylic acid, methacrylic acid and maleic anhydride are suitably used. These may be used alone or in combination of two or more species.

In the copolymer, the lower limit of a content of the constituent unit (c) is 1 mol %, and the upper limit thereof is 70 mol %. When it is less than 1 mol %, heat resistance and chemical resistance of the adhesive comprising a copolymer will fall; whereas when it exceeds 70 mol %, the spacer dispersion of the present invention containing the adhesive comprising a copolymer will gel. The preferable lower limit thereof is 5 mol %, and the preferable upper limit is 40 mol %. The further preferable upper limit thereof is 20 mol %.

Here, when a copolymer is produced merely from the monomer to form the constituent unit (a) and the monomer to form the constituent unit (b), an epoxy group and a carboxylic acid group may react and crosslink, and a polymerization system may gel.

However, since the monomer to form the constituent unit (c) is copolymerized with the monomer to form the constituent unit (a) and the monomer to form the constituent unit (b) within the above-described range in the adhesive comprising a copolymer, an epoxy group and a carboxylic acid group react, and a polymerization system is more unlikely to gel, leading to excellent storage stability.

In addition, since in the spacer dispersion of the present invention containing the adhesive comprising a copolymer, the adhesive comprising a copolymer is easily cured merely by heating, it is not necessary to use a specific curing agent, a gap holding member of the liquid crystal display apparatus having a very little staining material from the spacer dispersion of the present invention to the alignment layer on the substrate and liquid crystal can be obtained.

The added amount of the adhesive to the spacer dispersion is not particularly limited, and, the preferable lower limit thereof is 0.001% by weight, and the preferable upper limit thereof is 10% by weight. When it is less than 0.001% by weight, an effect of adding an adhesive, namely an effect of firmly fixing spacer particles may not be obtained; whereas when it exceeds 10% by weight, spacer particles will be covered with an adhesive after drying and gap accuracy may be deteriorated, or a viscosity of the spacer dispersion will increase and ejection accuracy may be deteriorated. The more preferable lower limit thereof is 0.01% by weight, and the more preferable upper limit thereof is 5% by weight.

Moreover, a hydrophilic solvent is preferably used as a solvent of the spacer dispersion of the present invention since it is preferable in order to narrow the gathering range of spacer particles by gathering spacers and the like. Accordingly, both the “adhesive comprising a mixture” and the “adhesive comprising a copolymer” are preferably an adhesive high in hydrophilic solvent solubility in order to easily melt or disperse in the solvent of the spacer dispersion.

From a standpoint of solubility of the spacer dispersion to a solvent, a weight average molecular weight of the adhesive and the adhesive comprising a copolymer is preferably 400,000 or less and more preferably 200,000 or less. When it exceeds 400,000, not only will solubility of the spacer dispersion to a solvent deteriorate, but also increase in a viscosity of the spacer dispersion and occurrence of thixotropy may arise a problem of having an adverse effect on ejecting properties at the time of ink-jet ejection. In addition, when it exceeds 400,000, the adhesive itself will serve as a surfactant such as a polymer dispersion material, and droplets of the spacer dispersion after deposited on the substrate will be more unlikely to shrink.

In order to obtain a hydrophilic adhesive high in solvent solubility, a copolymer preferably contains at least 20% by weight or more of monomer units having hydrophilic functional groups, and more preferably contains 40% by weight or more thereof, both in an adhesive comprising a mixture and an adhesive comprising a copolymer. Examples of the monomer having a hydrophilic functional group include the monomer to form the constituent unit (c; constituent unit derived from unsaturated carboxylic acid and/or unsaturated carboxylic acid anhydride) and a vinyl-based monomer having a hydrophilic functional group such as a hydroxyl group, a sulfonyl group, a phosphonyl group, an amino group, an amide group, an ether group, a thiol group, and a thioether group. Among others, a hydroxyl group, a carboxyl group (carboxylic acid group) and a vinyl-based monomer having an ether group are preferable because of less interaction with liquid crystal.

The vinyl-based monomer having the hydrophilic functional group is not particularly limited, and examples thereof include vinyl-based monomers having a hydroxyl group such as 2-hydroxyethyl(meth)acrylate, 1,4-hydroxybutyl(meth)acrylate, (poly)caprolactone-modified hydroxyethyl(meth)acrylate, allyl alcohol and glycerin mono allyl ether; vinyl-based monomers having a sulfonyl group such as t-butylacrylamidesulfonic acid, styrenesulfonic acid and 2-acrylamido-2-methyl propane sulfonic acid; vinyl-based monomers having a phosphonyl group such as vinyl phosphate and 2-(meth)acryloyloxyethyl phosphate; vinyl-based monomers having an amino group such as dimethylaminoethyl methacrylate and diethylaminoethyl methacrylate; vinyl-based monomers having ether groups such as terminal alkyl ether of (poly)ethylene glycol (meth)acrylate, terminal alkyl ether of (poly)propylene glycol (meth)acrylate and tetrahydrofurfuryl (meth)acrylate; vinyl-based monomers having hydroxyl group and ether group such as (poly)ethylene glycol (meth)acrylate and (poly)propylene glycol (meth)acrylate; and vinyl-based monomers having an amide group such as (meth)acrylamide, methylol(meth)acrylamide and vinylpyrrolidone. These vinyl-based monomers having the hydrophilic functional group may be used alone or may be used in combination of two or more species.

The spacer dispersion of the present invention can be arranged on a non-pixel area on the surface of the substrate of spacer particles by using the below-described ink-jet apparatus, and a liquid crystal display apparatus shown in FIG. 10 can be produced.

FIG. 10 is a front cross-sectional view of a partially cutout portion schematically illustrating the liquid crystal display apparatus obtained by using the ink-jet apparatus and the spacer dispersion of the present invention.

In a liquid crystal display apparatus 100, two sheets of substrates, a second substrate 102 and a first substrate 103, are arranged so as to face each other.

Black matrixes 104 are formed at equal intervals on the inner surface of a transparent substrate 102A forming the second substrate 102. A color filter 105 made of three colors of red, green, and blue is formed on the black matrixes 104 and on the inner surface of the transparent substrate 102A between the black matrixes 104 so as to have an almost predetermined thickness. An overcoat layer 106 is formed on the color filter 105 so as to have a flat surface. An ITO transparent electrode 107 having a predetermined thickness is formed so as to cover the overcoat layer 106, and an alignment layer 108 having almost a predetermined thickness covers the ITO transparent electrode 107.

On the other hand, wires 109 are formed on portions corresponding to the black matrixes 104 and on the inner surface of a transparent substrate 103A forming the first substrate 103. The ITO transparent electrode 110 having almost a predetermined thickness is formed on the inner surface of the transparent substrate 103A between the wires 109 so as to have a predetermined interval between the wire 109 and the ITO transparent substrate 110. An alignment layer 111 having almost a predetermined thickness is formed so as to cover the wires 109 and the ITO transparent electrode 110. In the first substrate 103, the alignment layer 111 has a raised portion 111a in the portion where the wire 109 is formed.

The second substrate 102 and the first substrate 103 are bonded via a sealing material (not illustrated) in closer vicinity of each of the outer periphery. Liquid crystal 112 is enclosed in the space surrounded by the second substrate 102 and the first substrate 103. A plurality of spacer particles 113 are arranged on a position corresponding to the black matrixes, namely a non-pixel area. The interval between the first substrate 103 and the second substrate 102 is controlled by the spacer particles 113, and a proper thickness of a liquid crystal layer is maintained.

In the spacer dispersion of the present invention, a substrate on which spacer particles are arranged is referred to as the first substrate; whereas in the case where spacer particles are arranged on the above-described second substrate 102, the second substrate will serve as the first substrate.

Examples of such first and second substrates include those made of glass and a resin plate, which are used as a panel substrate of the conventional liquid crystal display apparatus. In addition, the substrate with which a color filter is provided in a pixel area can be used as the first substrate or the second substrate. In this case, the pixel area is separated by black matrixes, and this black matrix forms a non-pixel area. The black matrix comprises resins on which metals such as chromium or carbon black through which actually scarcely light passes are dispersed.

A method for arranging spacer particles 113 on the above-described first substrate 103 using the spacer dispersion of the present invention is described in reference to FIGS. 11(a) to 11(c). FIGS. 11(a) to 11(c) are front cross-sectional views of a partially cutout portion stepwise illustrating the step in which spacer particles are arranged.

As illustrated in FIG. 11(a), a spacer particle 113A comprising one or a plurality of spacer particles 113 is/are ejected so that a non-pixel area corresponding to a black matrix 104, namely a raised portion 111a of an alignment layer 111 on a portion of a wire 109 may be included. The spacer dispersion 113A ejected is deposited on the non-pixel area corresponding to the black matrix 104, as illustrated in FIG. 11 (b). After a certain period of time, the spacer dispersion 113A is dried, as illustrated in FIG. 11(c), the spacer particles 113 are arranged on the non-pixel area corresponding to the black matrix 104, namely a stepped face of the raised portion 111a of the alignment layer 111 on a portion of the wire 109. As illustrated in FIG. 11 (c), when the spacer dispersion 113A is dried, a plurality of spacer particles 113 are included, the spacer particles 113 will gather toward the stepped surface of the raised portion 111a, a plurality of the spacer particles 113 will be arranged so as to make contact with each other.

As described above, as illustrated in a front cross-sectional view of a partially cutout portion in FIG. 12, the first substrate 103 is obtained on which one or a plurality of the spacer particle(s) 113 is/are each arranged on the non-pixel area corresponding to the black matrix 104. This first substrate 103 is superimposed on the second substrate 102 so as to face each other via the spacer particles 113. The liquid crystal display apparatus 100 illustrated in FIG. 10 is configured by injecting liquid crystal between the first substrate 103 and the second substrate 102 superimposed on one another or arranging liquid crystal 112 on the first substrate 103 and the second substrate 102 before superimposing the first substrate 103 on the second substrate 102.

The above-described method for ejecting the spacer dispersion of the present invention on a predetermined position of the substrate is determined appropriately depending on the ink-jet apparatus and the like to be used. When spacer particles (hereinafter, also include the liquid crystal spacers of the present invention) are arranged using an ink-jet apparatus, the ink-jet apparatus is not particularly limited, and examples thereof include an ink jet apparatus of a piezo type for ejecting liquid by vibration of a piezo element, of a thermal type for ejecting liquid from a nozzle by utilizing liquid expansion by sharp heating, and of s bubble jet type (registered trademark) for ejecting liquid from a nozzle by sharp heating of heating elements. Any one of the types may be selected.

The wetted portion of the ink chamber for storing the spacer dispersion of the present invention of the ink-jet apparatus is favorably formed of a hydrophilic material with a surface tension thereof of 31 mN/m or more. As a material of the wetted portion, although a hydrophilic organic material such as hydrophilic polyimide and the like can also be used, an inorganic material, namely ceramics, glass, a metal material such as stainless steel with little corrosiveness is preferably used in terms of durability.

Resins and the like are used for the wetted portion in order to secure insulation and the like to a voltage application part in the head portion of a conventional ink-jet apparatus. The resins used for this wetted portion often comprises a material with a surface tension of less than 31 mN/m. In this case, when introducing the spacer dispersion into the head, the spacer dispersion is not familiar with the head, whereby air bubbles tend to remain. The spacer dispersion may not be able to be ejected in a nozzle where air bubbles remain.

In addition, with respect to the amount of the spacer dispersion to be ejected at a time from one nozzle of the ink-jet apparatus, the preferable lower limit thereof is 5 ng, and the preferable upper limit thereof is 35 ng. When it is less than 0.5 ng, ejection of the spacer dispersion may become difficult; whereas when it exceeds 35 ng, an excessive amount of the spacer dispersion ejected on the substrate will take a certain period of time for drying, and the spacer particles may not be able to be gathered effectively in an area corresponding to a non-pixel area in a short period of time.

Examples of a method for controlling the amount of the spacer dispersion ejected at a time from one nozzle include a method for optimizing an opening of the nozzle and a method for optimizing an electrical signal that controls the head of the ink-jet apparatus. The latter method is particularly effective in using the ink-jet apparatus of a piezo type.

The nozzle diameter of the ink-jet apparatus is preferably at least 7 times as wide as the particle diameter of the spacer particles. If it is less than 7 times as wide, since the nozzle diameter is so small relatively to the particle diameter of the spacer particles that the ejection accuracy could be lowered or in an extreme case, the nozzle could be blocked to make ejection impossible.

The reason for decrease in the ejection accuracy is supposed to be as follows. For example, in the case of an ink-jet apparatus of a piezo type, after ink is sucked to an ink chamber formed in the vicinity of the piezo element by vibration of the piezo element, the ink is delivered from the ink chamber and ejected though the nozzle tip. Examples of a method for ejecting liquid droplets include: a drawing method by which the meniscus of the nozzle tip end, namely the interface of the ink and a gas, is drawn immediately before ejection, and then pushing out the liquid; and a pushing method by which a liquid is directly pushed out from the position where the meniscus is kept still. In typical ink-jet apparatuses, since small droplets are ejected, the former drawing method is in mainstream. In the present method, it is required that the nozzle diameter is large enough to a certain extent and the nozzle is capable of ejecting small droplets and therefore, the drawing method is effective.

However, since the meniscus is drawn immediately before ejection in the drawing method, when the nozzle diameter is small, for example, when the nozzle diameter is less than 7 times as wide as the particle diameter, as illustrated in FIG. 13(a), the drawn meniscus 21 may not be axially symmetric if a spacer particle 22 exists in the vicinity of the drawn meniscus 21. Therefore, after the meniscus 21 is drawn, droplets of the spacer dispersion 23 presumably do not move straight forward but bend when the meniscus 21 is pushed forward. In this case, ejection accuracy will lower. When a nozzle diameter is made too large in order to remove a bend of the droplet at the time of ejection, a size of the droplet to be ejected becomes larger, and a deposition diameter of the droplet also becomes larger, thereby reducing arrangement accuracy of a charged ink and the spacer particle 22.

When the nozzle diameter is large, for example, when the nozzle diameteris 7 times or more as wide as the particle diameter, as illustrated in FIG. 13(b), the meniscus 21 will not be affected by the spacer particle 22 if the spacer particle 22 exists in the vicinity of the drawn meniscus 21. Therefore, the meniscus 21 is drawn in axial symmetry. Therefore, after the meniscus 21 is drawn, droplets of the spacer dispersion 23 presumably move straight forward when the meniscus 21 is pushed forward. In this case, ejection accuracy will be improved.

The nozzle diameter of the ink-jet apparatus is not particularly limited, and the preferable lower limit thereof is 20 μm and the preferable upper limit thereof is 100 μm. When it is less than 20 μm, ejection of the spacer particles with a particle diameter of 2 to 10 μm may lower ejection accuracy due to an excessively small difference between the nozzle diameter and the particle diameter or cause clogging of the nozzle, likely making ejection impossible. When it exceeds 100 μm, since the diameter of the droplets to be ejected becomes larger and then the diameter of the droplets to be ejected on the substrate also becomes larger, and arrangement accuracy of the spacer particles may become coarse.

The diameter of the droplets to be ejected from the nozzle is not particularly limited, and the preferable lower limit thereof is 10 μm and the preferable upper limit thereof is 80 μm.

A method for controlling the diameter of the droplets to be ejected from the nozzle within the preferable range is not particularly limited, and examples thereof include a method for optimizing a nozzle diameter and a method for optimizing an electrical signal that controls the ink-jet apparatus. Any one of the types may be selected. The latter method is particularly effective in using the ink-jet apparatus of a piezo type.

In addition, a diameter of the droplets ejected on the substrate is not particularly limited, but the preferable lower limit thereof is 30 μm and the preferable upper limit thereof is 150 μm. In order to set it to less than 30 μm, since it becomes necessary to dramatically decrease a nozzle diameter, a possibility of clogging of the nozzle caused by the liquid crystal spacer of the present invention may become large, or accuracy of a nozzle processing may have to be enhanced. When it exceeds 150 μm, arrangement accuracy of the liquid crystal spacer of the present invention may become coarse.

In the head of the ink-jet apparatus, a plurality of the nozzles as described above are provided in a predetermined arrangement manner. For example, 64 pieces or 128 pieces of the nozzles are provided at equal intervals in the direction at right angles to the head moving direction. Moreover, the nozzles may be provided in a plurality of rows.

The interval of the nozzles in the ink-jet apparatus is restricted by the structure of the piezo elements and the like, the nozzle diameter, and the like. Therefore, in the case where the nozzles are provided at predetermined intervals and the spacer dispersion is ejected on the substrate at intervals different from the nozzle intervals, as described above, various heads have to be prepared for the ejection intervals. However, it is difficult to prepare various heads. Accordingly, when the ejection intervals are narrower than the head intervals, the head typically arranged at right angles to the scanning direction of the head is inclined or turned, for ejection, in the plane parallel to the substrate while being kept in parallel to the substrate. On the other hand, in the case where the intervals are wider than the head, the nozzles are not all used and only predetermined nozzles are used for the ejection and additionally the head may be inclined for the ejection.

In addition, in order to improve the productivity and the like, a plurality of heads with such a structure can be provided to the ink jet apparatus; however, when the number of the heads to be provided is increased, it becomes complicated in terms of the control.

FIGS. 19 (a) and 19(b) schematically illustrates one example of a head of an ink-jet apparatus used for the present invention. FIG. 19(a) is a perspective view of a partially cutout portion schematically illustrating a structure of an example of a head of an ink-jet apparatus, and FIG. 19(b) is a perspective view of a partially cutout portion schematically illustrating a cross-sectional structure in a nozzle hole portion.

As illustrated in FIGS. 19(a) and 19(b), a head 140 comprises an ink chamber 141 into which ink is charged by suction and the like, and an ink chamber 142 into which ink is delivered from an ink chamber 141. Nozzle holes 144 leading from the ink chamber 142 to an ejection surface 143 are formed in the head 140. The ejection surface 143 is beforehand subjected to a water repellent process in order to prevent contamination due to ink. A temperature control device 145 is provided in the head 140 for adjusting a viscosity of ink. The head 140 has a function to deliver ink from the ink chamber 141 to the ink chamber 142. The head 140 comprises piezo elements 146 that have a function to eject ink, delivered to the ink chamber 142, from the nozzle holes 144.

The temperature control device 145 is provided in the head 140. Therefore, in the case where the viscosity of ink is extremely high, the viscosity of the ink can be reduced by heating it with a heater. Meanwhile, in the case where the viscosity of the ink is extremely low, the viscosity of the ink can be raised by cooling it with Peltier.

The liquid crystal display apparatus having a structure as illustrated in FIG. 10 can be produced using such an ink-jet apparatus and the spacer dispersion of the present invention.

As the method for producing the liquid crystal display apparatus having a structure as illustrated in FIG. 10 using the ink-jet apparatus and the spacer dispersion of the present invention, a preferable method is, for example, a method for producing a liquid crystal display apparatus having a pixel area and a non-pixel area, and a first and a second substrates that face each other, comprising the steps of: arranging spacer particles on an area corresponding to a non-pixel area on the first substrate by ejecting, on the first substrate, a spacer dispersion on which spacer particles are dispersed from a nozzle of an ink-jet apparatus; superimposing on the second substrate the first substrate on which spacer particles are arranged so as to face each other via spacer particles; and injecting liquid crystal; between the first substrate and the second substrate that are superimposed on one another, or arranging liquid crystal; on a first substrate or a second substrate before superimposing the first substrate on the second substrate.

According to the method for producing the liquid crystal display apparatus, spacer particles can be arranged on a predetermined position using the spacer dispersion of the present invention. The spacer dispersion of the present invention used in the method for producing the liquid crystal display apparatus is preferable among others because when it contains the solvent described in the spacer dispersion of the third invention and controls the ejection amount within a predetermined range, spacer particles can be gathered and arranged particularly preferably in a predetermined position. The method for producing the liquid crystal display apparatus using the spacer dispersion, namely the method for producing the liquid crystal display apparatus comprising each of the above-described steps is preferable, the spacer dispersion containing at least a solvent with a boiling point of 200° C. or more and a surface tension of 42 mN/m or more, and an amount of a solvent with a boiling point of 200° C. or more and a surface tension of 42 mN/m or more included in spacer dispersion ejected at a time from one nozzle being 0.5 to 15 ng in the step of arranging spacer particles. The method for producing such a liquid crystal display apparatus is also one of the present inventions.

In the method for producing the liquid crystal display apparatus of the present invention, the spacer dispersion is ejected on the surface of the first substrate using the ink-jet apparatus, and the spacer particles are arranged on an area corresponding to a non-pixel area on the first substrate.

When the spacer dispersion is ejected and then deposited on the substrate, the lower limit of the receding contact angle of this spacer dispersion is preferably 5 degrees. Examples of the method for raising the receding contact angle include a method for letting the surface of the substrate be a low-energy surface.

Examples of the method for letting the surface of the substrate be a low-energy surface include a method for providing resins having a low-energy surface such as a fluoride film and a silicone film on the surface of the substrate, and a method for providing on the surface of the substrate a resin thin film referred to as an alignment layer with a thickness of 0.1 μm or less in general in order to control the alignment of liquid crystal molecules. In general, the method for providing the resin thin film on the surface of the substrate is performed.

Examples of the material forming the resin thin film include a polyimide resin in general. The polyimide resin film is formed by applying a solvent-soluble polyamic acid to the substrate and thereafter thermally polymerizing the polyamic acid or by applying a soluble polyimide resin and thereafter drying the polyimide resin. As the polyimide resins, polyimide resins having long main chains and side chains are particularly preferably used for allowing the surface of the substrate to be a low-energy surface. In addition, the surface of the alignment layer applied is preferably subjected to a rubbing treatment in order to control the alignment of the liquid crystal. As the solvent of the spacer dispersion, it is preferable to select the solvent that does not contaminate the alignment layer by infiltration and dissolution into the alignment layer.

In the first substrate on which the spacer dispersion is ejected, the area corresponding to a non-pixel area preferably comprises an area having a low-energy surface. Namely, droplets of the spacer dispersion are preferably arranged on an area having a low-energy surface. Here, the area corresponding to the non-pixel area means the non-pixel area of the substrate having a non-pixel area; namely, in the case of the color filter substrate, for example, it means the above-mentioned black matrix formation part. Alternatively, when the substrate having a non-pixel area is superimposed on the other substrate, the area facing a non-pixel area of the substrate having a non-pixel area in the other substrate is an area corresponding to a non-pixel area. For example, in the case of a TFT liquid crystal panel, the other substrate is a TFT array substrate. When a TFT array substrate is superimposed on a substrate having a non-pixel area, the other substrate is a wiring part and the like of the TFT array substrate corresponding to a non-pixel area.

The preferable upper limit of the surface energy of the area having a low-energy surface on the surface of the substrate is 50 mN/m. When it exceeds 50 mN/m, as long as the spacer dispersion having a surface tension that enables ejection with an ink-jet apparatus is used, the droplets ejected may be spread wet on the substrate, and spacer particles may overflow from the non-pixel area. The more preferable upper limit is 40 mN/m.

The low-energy surface formed by providing an alignment layer and the like on the surface of the substrate may be only an area where the spacer dispersion is deposited or may be all surface areas of the substrate. Taking complicatedness of the steps such as patterning into consideration, all surface areas of the substrate are typically used as a low-energy surface.

In the substrate, a portion different in level is preferably provided at the deposition center of a droplet of the spacer dispersion. In this case, since spacer particles move to a predetermined position effectively, arrangement accuracy of the spacer particles can be enhanced. In addition, at the deposition center of a droplet of the spacer dispersion, a charged ink that functions electrostatically is ejected and dried.

The portion different in level provided on the surface of the substrate means depressions and projections where the height difference from the surrounding is unintentionally formed by the wiring and the like provided on the substrate or depressions and projections intentionally provided in order to gather spacer particles, regardless of the structure of the projections and depressions. Accordingly, the portion different in level means a portion different in level between a depressed portion or a projected portion in depressed and projected shapes and a flat portion of the substrate, namely a reference surface.

Specifically, examples of the portion different in level include, in an TFT array substrate, a portion different in level of approximately 0.2 μm caused by a gate electrode or a source electrode as illustrated in FIGS. 14(a) to 14(c), and a difference of approximately 1.0 μm owing to an array as illustrated in FIG. 14(g); or in a color filter substrate, a portion different in level of a depressed portion of approximately 1.0 μm between color filters on a black matrix as illustrated in FIGS. 14(d) to 14(f), and 14(h).

Provided that the particle diameter of the spacer particles is defined as D (>m) and the height difference of portions different in level is defined as B (>m), it is preferable to satisfy the relationship of the height difference of portions different in level, 0.01 μm<|B|<0.95 D. When the height difference of portions different in level is smaller than 0.01 μm, spacer particles tend not to gather around the periphery of the portion different in level; whereas when it exceeds 0.95 D, a sufficient gap adjustment effect of the substrate may not be achieved by spacer particles.

In the case where a portion different in level is on the surface of the substrate, since a portion of the droplets is fixed to the portion different in level at the stage where the spacer dispersion is ejected on the substrate, the spacer dispersion can be arranged on a limited area around the periphery of the portion different in level. Therefore, the spacer particles can be gathered in an area corresponding to a non-pixel area by providing a portion different in level in the area corresponding to the non-pixel area.

As illustrated in FIGS. 15(a) to 15(c), after the spacer dispersion is dried, a portion where spacer particles 131 are arranged generally will be an angle in the case of a projected portion 132, and be in the depression in the case of a depressed portion 133. When the size of the depressed portion 133 is larger than the particle diameter of the spacer particles and the deposition diameter of the droplets of the spacer dispersion ejected, the spacer particles are arranged not only inside the depressed portion 133 but also on the peripheral portion of the depressed portion 133.

In the case where a type of the metal exists in a portion different in level formed by a wiring and the like or in the vicinity sandwiching the alignment layers and the like, or in the case where a wiring portion comprises a charge control agent, spacer particles in droplets move to a predetermined position by electrostatic interaction, namely electrostatic electrophoretic effect. Therefore, in order to control gathering of the spacer particles, it is preferable to adjust the type of the metal and kinds of the charge control agent.

In addition, in the case where the wiring is subjected to a surface treatment, the spacer particles in the droplets move to a predetermined position by the electrostatic electrophoretic effect. In this case, it is preferable to vary a functional group and the like of a compound using an ionic functional group with respect to a compound used for the surface treatment of the wiring and the like. Moreover, the positive or negative voltage that does not damage a circuit is applied to wirings such as a source wiring and a gate wiring, and all surface areas of the substrate, and thereby gathering of the spacer particles can be controlled. The arrangement number (dispersion density) of the spacer particles arranged on the substrate is preferably in the range of 50 to 350 particles/mm².

The spacer dispersion used in the method for producing the liquid crystal display apparatus of the present invention is preferably ejected on the substrate at intervals of the value or more expressed by the following formula (1). The ejection interval means the minimum distance between two droplets of the spacer dispersion of the present invention deposited on the substrate.

35×[D/(2−3 cos θ+cos³⁰θ)]^{1/3}(μm) (1)

In the formula (1), D represents a particle diameter of the spacer particles, and θ represents the above-described initial contact angle.

Ejection is performed at intervals narrower than the value expressed by the above-described formula (1) causes agglomeration of the droplets of the spacer dispersion deposited on the substrate, and thereby spacer particles may not gather toward a single point in the drying step. In this case, arrangement accuracy of the spacer particles after drying will be lowered. In addition, in the case where the nozzle diameter is narrowed so as to reduce the ejection amount of the droplets, since the particle diameter of the spacer particles becomes relatively large to the nozzle diameter, for example, stable ejection of the spacer particles cannot be achieved constantly straight forward in one direction, and arrangement accuracy of the spacer particles will be lowered due to a flying curve. Additionally, the nozzles may possibly be clogged with the spacer particles.

As long as the spacer particles are arranged on the area of the black matrix and the like corresponding to the non-pixel area, or on the area of the wiring and the like corresponding to the non-pixel area, the portion to be arranged and arrangement patterns are not particularly limited. However, in order to prevent the spacer particles from overflowing into a pixel area, in the case where an area of the substrate corresponding to the non-pixel area is formed in a lattice form, for example, it is more preferable to eject the spacer dispersion, aiming at a lattice point crossing lengthwise and widthwise in the area corresponding to the non-pixel area in a lattice form.

The arrangement number of the spacer particles in one portion can be appropriately determined by arrangement location, and in general it is preferably approximately 1 to 12 particles. The average arrangement number is preferably approximately 2 to 6 particles. The arrangement number can be appropriately adjusted by a particle diameter of the spacer particles and a concentration of the spacer dispersion.

When ejecting the spacer dispersion on the substrate, the head of the ink-jet apparatus may be scanned at a time or separately a plurality of times. Especially when the interval at which the spacer particles are arranged is narrower than the value expressed by the above-described formula (1), preferably, the spacer dispersion is ejected at an integral multiple interval of the value expressed by the above-described formula (1), the spacer dispersion is dried, thereafter the head is shifted by the interval, and the spacer dispersion is ejected again. At the time of ejection of the spacer dispersion, it may be ejected by varying a shifting direction of the head, for example, alternately at any one time and reciprocating, or it may be ejected by shifting the head only in a predetermined direction.

Examples of the method for arranging the spacer particles on the substrate include a method disclosed in Japanese Kokai Publication 2002-015493, in which when a perpendicular line is drawn on the surface of the substrate, a head is inclined for ejection of the droplets to have a predetermined angle to this perpendicular line, and furthermore a relative moving velocity is controlled between the head and the substrate. This makes it possible to reduce the deposition diameter of the droplets of the spacer dispersion and precisely arrange the spacer particles on the area corresponding to the non-pixel area.

In addition, when the projected portion is formed in the non-pixel area on the surface of the substrate on which the spacer dispersion is ejected with an ink-jet apparatus, it is preferable to eject the spacer dispersion of the present invention on the projected portion. The spacer particles can be arranged on the projected portion; for example, even when spacer particles having a particle diameter of approximately 5 μm or less is used, it is possible to set in an appropriate range a thickness of the liquid crystal layer of the liquid crystal display apparatus to be produced. In this case, with respect to the spacer dispersion, the spacer particle has a particle diameter of 5 μm or less, a surface tension of 33 mN/m or more at 20° C., and a spacer particle concentration of 0.01 to 5% by weight. In the step of arranging the above-described spacer particles, a weight of the spacer dispersion to be ejected from one nozzle at a time is preferably 5 to 20 ng. Since the weight of the spacer dispersion to be ejected from one nozzle at a time is preferably 5 to 20 ng, a deposition diameter of the droplets of the spacer dispersion ejected on the projected portion can be reduced, and therefore the spacer particles can be precisely arranged on the projected portion formed in the area corresponding to the non-pixel area on the surface of the substrate.

The projected portion may have a lattice form or a form having a length direction and a width direction. Moreover, examples of the form having a length direction and a width direction include a rectangle, an ellipse, and the like.

In the case where the spacer dispersion is ejected on the projected portion, this projected portion preferably has a lattice form; and with respect to a width of the projected portion where the spacer dispersion is ejected, preferably, the lower limit thereof is 15 μm, and the upper limit thereof is 40 μm. When the width of the projected portion within the range, the spacer dispersion ejected on the projected portion can be surely prevented from overflowing from the projected portion, and the spacer particles can be more precisely, thereby enhancing the display picture quality of the liquid crystal display to be produced.

Descriptions will be given to a method for ejecting the spacer dispersion to be used in the method for producing the liquid crystal display apparatus of the present invention ion the substrate, depositing the spacer dispersion ejected on the surface of the substrate, and thereafter drying the spacer dispersion.

The method for depositing the spacer dispersion on the surface of the substrate and thereafter drying the spacer dispersion is not particularly limited, and examples thereof include a method for heating a stage on which the substrate is placed, a method for blowing hot air on the substrate, a method for heating the substrate using far infrared rays and so on, a method for drying under reduced pressure the spacer dispersion of the present invention ejected on the substrate. In order to gather spacer particles in closer vicinity of the deposition center of a droplet in the drying step, it is preferable to set to appropriate conditions a drying temperature, a drying period of time, a boiling point of the dispersion, a surface tension of the dispersion, a contact angle of the dispersion to the alignment layer, a concentration of the spacer particles in the dispersion, and the like.

As the method for drying the spacer dispersion ejected on the substrate, a method for drying the substrate under reduced pressure is preferable since it is not necessary to impart heat to the substrate, and the substrate, the alignment layer on the substrate, and spacer particles are not damaged by heating.

In the case where the spacer dispersion ejected on the substrate is dried under reduced pressure, the substrate on which the spacer dispersion is ejected may be placed into a pressure reduction device and subsequently the spacer dispersion may be dried; alternatively, the spacer arrangement device itself may be installed into a pressure reduction dryer and then the spacer dispersion may be dried. This enables adjustment of a drying velocity of the spacer dispersion on the substrate. Examples of the pressure reduction device include a pressure reduction device, in which a pressure reduction chamber in which the substrate is placed is connected to a pressure reduction tank that is larger in volume than the pressure reduction tank and subjected to pressure reduction beforehand; this pressure reduction device is preferable since use thereof allows a quicker and easier pressure reduction.

In order to gather spacer particles in closer vicinity of the deposition center of a droplet in the drying step, it is preferable to dry in a sufficient period of time so as to avoid elimination of liquid while the spacer particles moving on the surface of the substrate. That is, it is preferable to dry at a temperature enough to avoid rapid drying of solvents. Since contamination of the alignment layer may impair the display picture quality as a liquid crystal display apparatus when a solvent with a higher temperature contacts the alignment layer for a long period of time, it is preferable to dry at a lower temperature.

When the solvent that is easily vaporized at room temperature is used or the spacer dispersion is used under conditions where the solvent is rapidly vaporized, the spacer dispersion in the vicinity of nozzles of the ink-jet apparatus is more likely to be dried, likely leading to deteriorated ejecting properties. In addition, in producing the spacer dispersion or keeping the spacer dispersion, the spacer dispersion may be dried and spacer particles may be agglomerated.

A surface temperature of the substrate at the time when the spacer dispersion is deposited on the surface of the substrate is preferably lower by 20° C. or more than a boiling point of a solvent having the lowest boiling point among the solvents contained in the spacer dispersion. When the surface temperature of the substrate is higher by 20° C. than the boiling point of the solvent having the lowest boiling point, the solvent having the lowest boiling point is so sharply evaporated as to make the spacer particles difficult to move, and in an extreme case, the solvent sharply boils and the droplets comprising the spacer particles move around on the surface of the substrate, likely leading to considerable deterioration of the arrangement accuracy of the spacer particles.

After the spacer dispersion is deposited on the surface of the substrate, the surface temperature of the substrate is gradually increased to dry the solvent. In this case, the surface temperature of the substrate is preferably 90° C. or less, more preferably 70° C. or less until completion of the drying. The surface temperature of the substrate of more than 90° C. until completion of the drying may contaminate the alignment layer and subsequently deteriorate the display picture quality. Moreover, the moment when the droplets on the substrate are eliminated shall be deemed to be completion of the drying.

After completion of the drying of the spacer dispersion, in order to enhance the adherence of the spacer particles to the substrate or remove a residual solvent, the substrate may be further heated at a higher temperature of approximately 120 to 230° C.

Moreover, in the case where the above described spacer dispersion of the first invention or the above-described spacer dispersion of the second invention is used as the spacer dispersion of the present invention, the adhesive layer in the spacer dispersion of the first invention and the adhesive particles in the spacer dispersion of the second invention are subjected to the heating treatment, and are melted and softened around the periphery of the spacer particles, firmly adhere and fix the spacer particles and the substrate, and fix a plurality of spacer particles to each other; thereby spacer particles are adhered to the substrate in multiple points, leading to having excellent adhesiveness.

The first substrate on which the spacer particle are arranged is superimposed on the second substrate on which the spacer particle are not arranged so as to face each other via the spacer particles. The first and second substrates are heated and pressure bonded using a peripheral sealing agent, in the vicinity of the outer circumference, for example, subsequently liquid crystal is charged into a gap between the first and second substrates, and the liquid crystal display device is produced (vacuum injection method).

Alternatively, for example, a peripheral sealing agent is applied in the vicinity of the outer circumference of either one of the first substrate or the second substrate, liquid crystal is dropped inside the area surrounded by the peripheral sealing agent. After a certain period of time, the sealing agent is stuck to the other substrate and the sealing agent is cured, and thereby the liquid crystal display device is produced (one drop fill process).

### Effects of the Invention

The present invention can provide a liquid crystal spacer that can precisely control the interval of two substrates in producing a liquid crystal display apparatus, and can be firmly fixed to the surface of the substrate; a spacer dispersion that can precisely control the interval of two substrates in producing a liquid crystal display apparatus, and can make spacer particles firmly fixed to the surface of a substrate and a spacer dispersion that can precisely arrange spacer particles at a predetermined position on a substrate, a method for producing a liquid crystal display apparatus; and a liquid crystal display apparatus.

### BEST MODE FOR CARRYING OUT THE INVENTION

Hereinafter, the invention will be described more in detail along with Examples, and it is not intended that the invention be limited to these Examples.

### EXAMPLE 1

### (1) Production of Liquid Crystal Spacer (1)

As a base particle, a particle composed mostly of divinylbenzene with a particle diameter of 4.1 μm (CV 5%) (trade name: Micropearl SP-2041, produced by Sekisui Chem. Co., Ltd.) was used.

In a separable flask, 80 parts by weight of ion exchange water, 320 parts by weight of ethanol, 0.5 parts by weight of polyvinyl pyrrolidone (K-30), 5 parts by weight of styrene and 10 parts by weight of base particles were weighed, and uniformly stirred and mixed to obtain a base particle dispersion.

Next, a solution in which 10 parts by weight of ion exchange water, 40 parts by weight of ethanol, and 0.8 parts by weight of 2,2′-azobisisobutyronitrile were uniformly mixed was charged into the base particle dispersion, was polymerized at 60° C. for 20 hours, and thereafter, was washed to obtain shell seed particles (1) having shell seed layers on the surface of the base particle.

The shell seed particles were measured by a particle diameter distribution analyzer (produce by Beckman Coulter, Inc.). The average particle diameter of 4.2 mm was observed and the shell seed layer had a thickness of 50 nm.

In a separable flask, 200 parts by weight of ion exchange water, 40 parts by weight of a 5% solution of polyvinyl alcohol (GL-03, produced by Nippon Synthetic Chemical Industry Co., Ltd.), and 2 parts by weight of shell seed particles (1) were weighed, and stirred at 200 rpm to obtain a shell seed particle dispersion (1).

Next, a mixed liquid of 3 parts by weight of hydroxyethyl methacrylate and 0.5 parts by weight of ethylene glycol dimethacrylate, 2 parts by weight of 2-ethylhexyl methacrylate, and 1 part by weight of benzoyl peroxide was dispersed on 100 parts by weight of ion exchange water and 2 parts by weight of sodium dodecyl sulfate using an SPG film with a pore diameter of 0.4 μm to obtain 1.1 μm of a polymerizable monomer emulsion (1).

The obtained polymerizable monomer emulsion (1) was added to the obtained shell seed particle dispersion (1) and was stirred at 100 rpm, and the polymerizable monomer was absorbed by the shell seed layer under nitrogen atmosphere at room temperature for 24 hours to obtain polymerizable droplets.

Next, after the stirring velocity was set at 250 rpm, the polymerizable droplets were heated to 90° C. and thereby polymerized to obtain a liquid crystal spacer having an adhesive layer.

The obtained liquid crystal spacer (1) was classified, and the cross section thereof was observed by a transmission electron microscope (TEM). The results showed that the structure of the liquid crystal spacer was such that (a) was 4.2 μm, (b) was 1.5 μm, (b)/(a) was 0.4, and (c) was 5.5 μm, and the liquid crystal spacer had a portion protruding from the surface of a base particle to form a bump shape.

### (2) Preparation of Spacer Dispersion

A mixed solvent was prepared by uniformly stirring and mixing 60 parts by weight of ethylene glycol, 20 parts by weight of isopropyl alcohol, and 20 parts by weight of ion exchange water. A surface tension of the solvent at 20° C. was 35 mN/m. The spacer dispersion (1) was prepared by slowly adding 0.5 parts by weight of the produced liquid crystal spacer (1) to 100 parts by weight of the solvent and uniformly stirring and mixing them with a sonicator.

### EXAMPLE 2

A liquid crystal spacer (2) having an adhesive layer was obtained in the same treatment as in Example 1, except that when preparing a polymerizable monomer emulsion using the shell seed particles (1) obtained in Example 1, a polymerizable monomer emulsion was used in which 160 parts by weight of ion exchange water, 0.2 parts by weight of ethylene glycol dimethacrylate, 0.8 parts by weight of 2-ethylhexyl methacrylate, 0.2 parts by weight of hydroxyethyl methacrylate, 0.05 parts by weight of benzoyl peroxide and 1.2 parts by weight of sodium dodecyl sulfonate were uniformly emulsified with a homogenizer.

The cross section of the obtained liquid crystal spacer (2) was observed by a transmission electron microscope (TEM). As illustrated in FIG. 4, the results showed the structure in which (a) was 4.2 μm, (b) was 6.1 μm, (b)/(a) was 1.5, and (c) was 7.2 μm, and the adhesive layer was provided on a portion of the surface of a base particle.

Afterward, a spacer dispersion (2) was prepared in the same treatment as in Example 1.

### EXAMPLE 3

A liquid crystal spacer (3) having an adhesive layer was obtained in the same treatment as in Example 1, except that when preparing a polymerizable monomer emulsion using the shell seed particles (1) obtained in Example 1, a polymerizable monomer emulsion was used in which 160 parts by weight of ion exchange water, 0.6 parts by weight of ethylene glycol dimethacrylate, 2.4 parts by weight of 2-ethylhexyl methacrylate, 0.6 parts by weight of hydroxyethyl methacrylate, 0.15 parts by weight of benzoyl peroxide and 1.2 parts by weight of sodium dodecyl sulfonate were uniformly emulsified with a homogenizer.

The cross section of the obtained liquid crystal spacer (3) was observed by a transmission electron microscope (TEM). As illustrated in FIG. 5, the results showed the structure in which (a) was 4.2 μm, (b) was 4.5 μm, (b)/(a) was 1.1, (c) was 5.1 μm, and the adhesive layer was provided on a portion of the surface of a base particle.

Afterward, a spacer dispersion (3) was prepared in the same treatment as in Example 1.

### EXAMPLE 4

### Synthesis of Liquid Crystal Spacer (4)

In a separable flask, 50 parts by weight of dimethyl sulfoxide and 50 parts by weight of base particles (trade name: Micropearl SP-2041, produced by Sekisui Chem. Co., Ltd.), 50 parts by weight of 2-hydroxy methacrylate and 50 parts by weight of isobutyl methacrylate were weighed, and stirred at 200 rpm to obtain a base particle dispersion (1).

Next, shell seed particles (2) were obtained by adding a solution, in which 1.5 parts by weight of diammonium nitrate cerium was dissolved in 18 parts by weight of 1 M of nitric acid aqueous solution, to a base particle dispersion, and heating it to 50° C. under nitrogen atmosphere.

When the obtained shell seed particles were measured with regard to the particle diameter thereof using a particle diameter distribution analyzer (produced by Beckman Coulter, Inc.), formation of the shell seed layers with an average particle diameter of 4.2 μm and a thickness of 50 nm was observed.

In a separable flask, 200 parts by weight of ion exchange water, 40 parts by weight of a 5% solution of polyvinyl alcohol (GL-03, produced by Nippon Synthetic Chemical Industry Co., Ltd.), and 2 parts by weight of shell seed particles (2) were weighed, and stirred at 200 rpm to obtain a shell seed particle dispersion (3).

In addition, 160 parts by weight of ion exchange water, 1.5 parts by weight of ethylene glycol dimethacrylate, 1.5 parts by weight of 2-ethylhexyl methacrylate, 0.30 parts by weight of benzoyl peroxide and 1.2 parts by weight of sodium dodecyl sulfonate were uniformly emulsified with a homogenizer to obtain a polymerizable monomer emulsion.

The obtained polymerizable monomer emulsion was added to the obtained shell seed particle dispersion (3) and was stirred at 100 rpm, and the polymerizable monomer was absorbed in a graft layer under nitrogen atmosphere at room temperature for 24 hours to obtain polymerizable droplets.

Next, after a stirring velocity was set at 200 rpm, the polymerizable droplets were heated to 90° C. and thereby polymerized to obtain a liquid crystal spacer (4) having an adhesive layer.

The cross section of the obtained liquid crystal spacer (4) was observed by a transmission electron microscope (TEM). As illustrated in FIG. 6, the results showed the structure in which (a) was 4.2 μm, (b) was 5.7 μm, (b)/(a) was 1.4, and (c) was 5.7 μm, and the adhesive layer was provided on all surface areas of a base particle.

Afterward, a spacer dispersion (4) was prepared in the same treatment as in Example 1.

### COMPARATIVE EXAMPLE 1

### Synthesis of Liquid Crystal Spacer (5)

As base particles, particles composed mostly of divinylbenzene with a particle diameter of 5.0 μm (CV value of 5%) (trade name: Micropearl SP-205, produced by Sekisui Chem. Co., Ltd.) were used.

In a separable flask, 200 parts by weight of methylethyl ketone, 30 parts by weight of methacryloyl isocyanate and 10 parts by weight of base particles were weighed, and uniformly stirred and mixed, and reacted for 30 minutes at room temperature to obtain particles having a polymerizable vinyl group on the surface thereof.

After having been washed with methylethyl ketone, 200 parts by weight of methylethyl ketone, 20 parts by weight of methyl methacrylate, 80 parts by weight of 2-ethylhexyl methacrylate, 20 parts by weight of hydroxyethyl methacrylate and 0.5 parts by weight of benzoyl peroxide were added, graft polymerization reaction was performed at 70° C. under nitrogen atmosphere for 4 hours to obtain a liquid crystal spacer (5) having an adhesive layer.

The cross section of the obtained liquid crystal spacer (5) was observed by a transmission electron microscope (TEM). The results showed an almost uniform adhesive layer had a thickness of 100 nm.

Afterward, a spacer dispersion (5) was prepared in the same treatment as in Example 1.

A liquid crystal spacer was arranged by ejecting on the substrate the spacer dispersion prepared in Examples 1 to 4 and Comparative Example 1 using an ink-jet apparatus.

A predetermined TFT array substrate was placed on a stage heated to 45° C. by a heater attached to the stage.

After the spacer dispersion prepared in Examples 1 to 4 and Comparative Example 1 were filtered with a stainless mesh (10 μm opening) for removal of agglomerates, droplets of a spacer dispersion were ejected, by an ink-jet apparatus comprising a piezo type head having a 50 μm diameter at the head tip end, at 110 μm intervals on every other vertical line, aiming to locations corresponding to a black matrix of a color filter substrate in the TFT array substrate to arrange a liquid crystal spacer at vertically 110 μm transversely 150 μm pitches. Moreover, the gap between the nozzle (the head face) and the substrate at the time of ejection was set to 0.5 mm and a double pulse method was used. The dispersion density of the liquid crystal spacer arranged in such a manner was 180 particles/mm².

Next, after it was confirmed that the spacer dispersion ejected on the substrate on the stage was completely dried by eye observation, the remaining dispersion media were further removed and in order to firmly fix the liquid crystal spacer in the substrate, the substrate was shifted to a hot plate at 150° C. and heated and kept standing for 15 minutes.

The TFT array substrate in which the liquid crystal spacer was arranged and a color filter glass substrate were stuck to each other via a sealing agent in the peripheries of the substrates, and the sealing agent was heated at 150° C. for 1 hour to be cured and to form an empty cell having a cell gap equal to the particle diameter of the base particles of the liquid crystal spacer; afterward, liquid crystal (trade name: ZLI-4720-000, produced by Merck & Co., Inc.) was charged into this empty cell by a vacuum method and an injection inlet was sealed with an end-sealing agent to produce a liquid crystal display apparatus.

### (Evaluation)

### (Adherence)

The number of liquid crystal spacers in the range of 1.0 mm² was measured before and after air was applied by an air gun to the TFT array substrate on which, before stuck to the color filter glass substrate, a liquid crystal spacer had been dispersed, and which had been subjected to a heat treatment, and a proportion of the number of the remaining particles was calculated as a percentage. Moreover, the conditions of the air blow in this case are as follows: an air blow pressure is 2.0 kg/cm² and 4.0 kg/cm², a nozzle diameter is 2 mm, a perpendicular distance is 5 mm, a period of time is 15 seconds. The results are shown in Table 1.

### (Display Picture Quality)

Existence of display failure such as light blank attributed to spacer particles was observed by an electronic microscope by applying predetermined voltage to the liquid crystal display apparatus and the display image quality thereof was evaluated according to the following criteria.

O: Spacers were scarcely observed in the display regions and the quality of images was good without light blank attributed to the spacers.
Δ: Some spacers were observed in the display regions and light blank attributed to the spacers took place.
X: Many spacers were observed in the display regions and light blank attributed to the spacers took place.

TABLE 1

| | |
|---|---|
| Display | Residual Ratio of Liquid Crystal |
| Picture | Spacers After Air Blow |

| | Quality | 2 kg/cm² | 4 kg/cm² |
|---|---|---|---|
| Example 1 | Δ | 80% | 76% |
| Example 2 | Δ | 98% | 95% |
| Example 3 | ◯ | 100% | 100% |
| Example 4 | ◯ | 100% | 100% |
| Comparative | X | 62% | 25% |
| Example 1 | | | |

As shown in Table 1, it is clear that the liquid crystal spacer of the present invention has superior adherence and display picture quality as compared to those in Comparative Example.

### EXAMPLE 5

### (1) Production of Adhesive Particle

After 150 mmol of methyl methacrylate, 50 mol of isobutyl methacrylate, 6 mmol of ethylene glycol dimethacrylate, 4 mmol of methacrylic acid phenyldimethylsulfoniummethyl sulfate, 2 mmol of 2,2-azobis [N-(2-carboxyethyl)-2-methyl-propionamidine]tetrahydrate, and 500 mL of distilled water were measured in a 1000 mL separable flask equipped with a four-necked separable cover, a stirring blade, a three-way cock, a condenser, and a temperature probe, they were stirred at 200 rpm and polymerization was carried out at 70° C. for 12 hours in nitrogen atmosphere.

After 2 mmol of 2-ethanolamine was added to the obtained resin particulate dispersion, and the dispersion was further stirred at 70° C. for 1 hour, removal and washing of unreacted monomers and a polymerization initiator and the like were carried out twice in a centrifugal separation to obtain an adhesive particle having a hydroxyl group on the surface thereof.

When the obtained adhesive particles were measured with regard to the particle diameter thereof using a particle diameter distribution analyzer based on a dynamic light scattering method (DLS8000, produced by Otsuka Electronics Co., Ltd.), an average particle diameter was 0.25 μm, and a CV value was 8.8%.

In addition, after removal of water by freeze drying, 1 g of adhesive particles and 10 mL of ultra pure water were enclosed in a quartz glass pipe, and heated at 120° C. for 24 hours.

The results of measuring an ion concentration of Na⁺ by a frameless atomic absorption spectrophotometry and that of Cl⁻ and SO₄²⁻ by ion chromatography, in water after heating, were respectively less than 2.4 ppm, 3 ppm, and 1 ppm, and an ion content thereof was each low.

### (2) Preparation of Solvent

A solvent was prepared by uniformly mixing 60 parts by weight of ethylene glycol, 20 parts by weight of isopropyl alcohol, and 20 parts by weight of ion exchange water.

A surface tension of the obtained solvent at 20° C. was 35 mN/m.

### (3) Preparation of Spacer Dispersion

As spacer particles, particles composed mostly of divinylbenzene with an average particle diameter of 5.0 μm (CV value of 5%) (trade name: Micropearl SP-205, produced by Sekisui Chem. Co., Ltd.) were used.

A spacer dispersion was prepared by slowly adding 2 parts by weight of the spacer particles to 100 parts by weight of the solvent and uniformly stirring and mixing them with a sonicator.

### EXAMPLE 6

### (1) Production of Adhesive Particles (6)

In a 2000 mL separable flask, 50 parts by weight of methyl methacrylate, 20 parts by weight of isobutyl methacrylate, 10 parts by weight of 2-ethylhexyl methacrylate, 1000 parts by weight of water, and 3 parts by weight of potassium persulfate were measured, and stirred at 250 rpm to obtain a mixed solution 1.

After The solution was heated to 70° C. in nitrogen atmosphere, a monomer solution in which 15 parts by weight of 2-hydroxyethyl methacrylate and 100 parts by weight of water were mixed was added dropwise for 3 hours, and afterward, polymerization was performed for 12 hours.

Removal and washing of unreacted monomers and a polymerization initiator and the like in the obtained resin particulate dispersion were carried out twice to obtain an adhesive particle (6).

When the obtained adhesive particles were measured with regard to the particle diameter thereof using a particle diameter distribution analyzer based on a dynamic light scattering method (DLS8000, produced by Otsuka Electronics Co., Ltd.), an average particle diameter was 0.50 μm and a CV value was 10.0%.

### (2) Preparation of Solvent

A solvent was prepared by uniformly mixing 10 parts by weight of ethylene glycol, 10 parts by weight of isopropyl alcohol, and 80 parts by weight of ion exchange water. A surface tension of the obtained solvent at 20° C. was 36 mN/m.

### (3) Preparation of Spacer Dispersion

As spacer particles, particles composed mostly of divinylbenzene with an average particle diameter of 5.0 μm (CV value of 5%) (trade name: Micropearl SP-205, produced by Sekisui Chem. Co., Ltd.) were used.

The spacer dispersion was prepared by slowly adding 2 parts by weight of the spacer particles to 100 parts by weight of the solvent and uniformly stirring and mixing them with a sonicator.

### COMPARATIVE EXAMPLE 2

A spacer dispersion was prepared in the same treatment as in Example 5, except that adhesive particles are not mixed in the spacer dispersion.

### COMPARATIVE EXAMPLE 3

### (1) Synthesis of Spacer Particles Having Adhesive Layer

As base particles, particles composed mostly of divinylbenzene with an average particle diameter of 5.0 μm (CV value of 5%) (trade name: Micropearl SP-205, produced by Sekisui Chem. Co., Ltd.) were used.

In a separable flask, 200 parts by weight of methylethyl ketone, 30 parts by weight of methacryloyl isocyanate and 10 parts by weight of base particles were weighed, and uniformly stirred and mixed, and reacted for 30 minutes at room temperature to obtain particles having a polymerizable vinyl group on the surface of the particles.

After the obtained particles having been washed with methylethyl ketone, 200 parts by weight of methylethyl ketone, 84 parts by weight of methyl methacrylate, 36 parts by weight of isobutyl methacrylate, 0.5 parts by weight of benzoyl peroxide were added to the particles, graft polymerization reaction was performed at 70° C. in nitrogen atmosphere for 4 hours to obtain spacer particles having an adhesive layer.

The cross section of the obtained adhesive liquid crystal spacer was observed by a transmission electron microscope (TEM). The results showed an almost uniform adhesive layer having a thickness of 100 nm was formed.

### (2) Preparation of Spacer Dispersion

A spacer dispersion was prepared by slowly adding 2 parts by weight of the spacer particles having the obtained adhesive layer to 100 parts by weight of the solvent prepared in Example 1 and uniformly stirring and mixing them with a sonicator.

### (Evaluation)

After the spacer dispersion prepared in Examples 5, 6 and Comparative Example 2, 3 was filtered with a stainless mesh (10 μm opening) for removal of agglomerates, droplets of a spacer dispersion were ejected, by an ink-jet apparatus comprising a piezo type head having a 50 μm diameter at the head tip end, at 110 μm intervals on every other vertical line, aiming to the locations corresponding to a black matrix of a color filter substrate in the TFT array substrate to arrange a liquid crystal spacer at vertically 110 μm transversely 150 μm pitches. Moreover, the gap between the nozzle (the head face) and the substrate at the time of ejection was set to 0.5 mm and a double pulse method was used. The dispersion density of the spacer particles arranged in such a treatment was 180 particles/mm².

Next, after it was confirmed that the spacer dispersion ejected on the substrate on a stage was completely dried by eye observation, the remaining dispersion solvent was further removed and to firmly fix the spacer particles to the substrate, the substrate was shifted to a hot plate at 150° C. and heated and kept standing for 15 minutes to be cooled naturally to room temperature.

The number of spacer particles in the range of 1.0 mm² was measured before and after air was applied by an air gun to the TFT array substrate on which spacer particles had been arranged, and a proportion of the number of the remaining spacer particles was calculated.

Moreover, the conditions of the air blow in this case are as follows: an air blow pressure is 5 kg/cm² and 10 kg/cm², a nozzle diameter is 2 mm, a perpendicular distance is 5 mm, a period of time is 15 seconds.

The results are shown in Table 2.

TABLE 2

Residual Ratio of Liquid Crystal
Spacers After Air Blow

| | 5 (kg/cm²) | 10 (kg/cm²) |
|---|---|---|
| Example 5 | 100% | 100% |
| Example 6 | 100% | 98% |
| Comparative | 0% | 0% |
| Example 2 | | |
| Comparative | 60% | 20% |
| Example 3 | | |

### (Preparation of Spacer Particles)

In a separable flask, 15 parts by weight of divinylbenzene, 5 parts by weight of isooctyl acrylate, and 1.3 parts by weight of benzoyl peroxide as a polymerization initiator were uniformly mixed.

Next, 20 parts by weight of a 3% solution of polyvinyl alcohol (trade name: KURARAY Poval GL-03, produced by KURARAY CO., LTD.) and 0.5 parts by weight of sodium dodecyl sulfate were charged in the separable flask and stirred sufficiently. After a certain period of time, 140 parts by weight of ion exchange water was further added. This solution was reacted under nitrogen atmosphere at 80° C. for 15 hours while being stirred. After washing the obtained particles using hot water and acetone, classification operation was performed to obtain three types of spacer particles having an average particle diameter of 3, 4, or 5 μm, and a CV value of 3.0%.

### (Surface Modification of Spacer Particle)

### (Spacer Particle SA)

Five parts by weight of the obtained spacer particles having an average particle diameter of 3, 4, or 5 μm, and a CV value of 3.0% were charged in a mixture of 20 parts by weight of dimethyl sulfoxide (DMSO), 2 parts by weight of hydroxymethyl methacrylate, 18 parts by weight of N-ethylacrylamide, and uniformly dispersed with a sonicator. After a certain period of time, nitrogen gas was introduced into the reaction system, and stirring was continuously carried out at 30° C. for 2 hours. Next, 10 parts by weight of a 0.1 mol/L diammonium cerium nitrate ([Ce(NH₄)₂] (NO₃)₆) regulated by a 1N aqueous solution of nitric acid and a reaction was continued for 5 hours. After completion of reaction, spacer particles and a reaction solution were separated through filtration using a 2 μm membrane filter. These particles were adequately washed with ethanol and acetone and then dried under reduced pressure with a vacuum drier to obtain three kinds of spacer particles SA having an average particle diameter of 3, 4, or 5 μm.

### (Spacer Particle SB)

Five parts by weight of spacer particles having an average particle diameter of 4 μm and a CV value of 3.0% obtained by preparation of spacer particles were charged in a mixture of 20 parts by weight of dimethyl sulfoxide (DMSO), 2 parts by weight of hydroxymethyl methacrylate, 16 parts by weight of methacrylic acid, and 2 parts by weight of lauryl acrylate, and uniform dispersion was carried out using an ultrasonic generator. After a certain period of time, spacer particles SB having an average particle diameter of 4 μm were obtained in the same treatment as in the case of the spacer particles SA.

### (Spacer Particle SC)

Five parts by weight of spacer particles having an average particle diameter of 4 μm and a CV value of 3.0% obtained by preparation of spacer particles were charged in a mixture of 20 parts by weight of dimethyl sulfoxide (DMSO), 2 parts by weight of hydroxymethyl methacrylate, and 18 parts by weight of polyethylene glycol methacrylate (molecular weight: 800), and uniform dispersion was carried out using an ultrasonic generator. After a certain period of time, spacer particles SC having an average particle diameter of 4 μm were obtained in the same treatment as in the case of the spacer particles SA.

### (Preparation of Spacer Dispersion)

A needed amount of the obtained spacer particles was ensured so as to have a predetermined particle concentration and was weighed and slowly added to the media with the compositions shown in the following Tables 3 to 6 and sufficiently stirred by a sonicator to disperse them in the media, and then filtered with a stainless mesh with a mesh size of 10 μm to remove agglomerates and obtain a spacer dispersion.

A surface tension of the obtained spacer particles at 20° C. was measured with a Wilhelmy method using a platinum plate. In addition, after the spacer dispersion was introduced to a height of 10 cm of a test tube having an inner diameter φ of 5 mm, a period of time until deposition of spacer particles in still standing was visually confirmed was measured and a precipitating speed of the spacer dispersion was evaluated. The measurement results were shown in the following Tables 3 to 6.

### (Production of Substrate)

As substrates for a liquid crystal test panel were prepared a color filter substrate 51, and TFT array model substrates 61A and 61B, which are counter substrates of the color filter substrate 51, having portions different in level provided.

### (Color Filter Substrate)

FIG. 16 (a) is a plan view of a partially cutout portion enlarging and illustrating a glass substrate where a black matrix used for the color filter substrate 51 is provided. FIG. 16 (b) is a front cross-sectional view of a partially cutout portion enlarging and illustrating the color filter substrate 51.

The color filter substrate 51 having a smooth surface used in Examples and Comparative Examples was produced as described below.

As illustrated in FIGS. 16(a) and 16(b), a black matrix 53 (width: 25 μm; vertical intervals: 150 μm; transverse intervals: 75 μm; and thickness: 0.2 μm) comprising metal chromium was provided on a glass substrate 52 with 300 mm×360 mm by a conventional method. Color filter 54 pixels made of RGB three colors (thickness: 1.5 μm) was formed on the black matrix 53 and therebetween so that the surface thereof becomes flat. An overcoat layer 55 and an ITO transparent electrode 56 each having an almost predetermined thickness was formed thereon.

On the ITO transparent electrode 56, a solution containing polyimide was further applied uniformly by a spin coating method. After the application, the solution was dried at 80° C., subsequently fired for 1 hour and cured, and then an alignment layer 57 with an almost predetermined thickness was formed.

The above-described alignment layer 57 is made of any one of the below-described three kinds of alignment layers PI1, PI2, or PI3. The below-described polyimide resin solution was used to form the alignment layer PI1, PI1, or PI3. Surface tensions (γ) of the alignment layers formed were as follows.

PI1: trade name: Sunever SE130, produced by Nissan Chemical Industries, Ltd., surface tension (γ): 46 mN/m
PI2: trade name: Sunever SE150, produced by Nissan Chemical Industries, Ltd., surface tension (γ): 39 mN/m
PI3: trade name: Sunever SE1211, produced by Nissan Chemical Industries, Ltd., surface tension (γ): 26 mN/m

### (TFT Array Model Substrate)

FIG. 17 (a) is a plan view of a partially cutout portion enlarging and illustrating a glass substrate used for a TFT array model substrate and having portions different in level provided. FIG. 17 (b) is a front view of a partially cutout portion enlarging and illustrating a TFT array model substrate.

The TFT array model substrate 61A used in Examples and Comparative Examples and having portions different in level provided was produced as described below.

As illustrated in FIGS. 17(a) and 17(b), a portion different in level 63 (width: 8 μm, thickness: 5 nm) comprising copper was provided, according to a conventionally well-known method, on a glass substrate with 300 mm×360 mm at a position where a color filter substrate 51 faces a black matrix 53. An ITO transparent electrode 64 having an almost predetermined thickness was provided thereon, and an alignment layer 65 having an almost predetermined thickness was further formed according to the above-described method. In the TFT array model substrate 61A, a projected portion was formed in such a manner that the alignment layer 65 protrudes at a position where the portion different in level 63 was formed. The height of the projected portion, namely a portion different in level of the surface of the substrate, was 5 nm.

In forming the alignment layer 65, a polyimide resin solution used also in forming an alignment layer 57 in the color filter substrate 51 serving as a counter substrate was used.

A TFT array model substrate 61B having portions different in level provided was separately produced. The TFT array model substrate 61B is different from the above-described TFT array model substrate 61A only in a height of portions different in level thereof. That is, a portion different in level 63 has a height of 200 nm in the TFT array model substrate 61B, and 200 nm of a portion different in level was provided on the surface of the substrate. An alignment layer 65 comprising PI3 was formed in the TFT array model substrate 61B.

### (Ink-Jet Apparatus)

An ink-jet apparatus of a piezo type, on which a head having a nozzle diameter of 40 μm is mounted, was prepared. A wetted portion of an ink chamber of this head was made of a glass ceramic material. A nozzle the face of which was subjected to a fluorine-based water repellent treatment was used as a nozzle.

### (Arrangement of Spacer Particle)

The step of arranging spacer particles on either one of the substrates, namely the color filter substrate 51 or the TFT array model substrate 61A or 61B, as shown in Table 3 to 6, was then carried out.

Moreover, after 0.5 mL of an initial spacer dispersion ejected from the nozzle of the ink-jet apparatus was thrown away, the spacer particles began to be arranged.

The color filter substrate 51 or the TFT array model substrates 61A and 61B was/were placed on a stage heated to 45° C. by a heater attached to the stage. After a certain period of time, using the above-described ink-jet apparatus, a spacer dispersion was ejected aiming to a portion of the black matrix 53 on the color filter substrate 51 or a portion different in level corresponding to the black matrix 53 in the TFT array model substrates 61A and 61B.

After introduction of the spacer dispersion into the ink chamber of the ink-jet apparatus, a period of time until ejection was changed. That is, evaluations were made both in the case where the spacer dispersion was ejected right after the introduction thereof (initial) and in the case where ejection was carried out after one-hour still standing after the introduction thereof.

Moreover, the gap between the head face of the nozzle and the surface of the substrate at the time of ejection was set to 0.5 mm. An ink-jet apparatus using a double pulse method was used. With regard to a spacer dispersion exceeding a viscosity of 15 mPa·s, ejection was carried out so that the viscosity was set in the range of 3 to 15 mPa·s. After the ejection, an initial contact angle (θ) of liquid droplets of the spacer dispersion to the substrate was measured by a contact angle measurement apparatus. The results were shown in Tables 3 to 6. After ejection of the spacer dispersion, the spacer dispersion deposited on the color filter substrate 51 or the TFT array model substrates 61A and 61B was dried.

In Examples 7 to 30 and Comparative Examples 4 to 8, the spacer dispersion ejected on the substrate was dried on a stage that was heated to 45° C. by a heater, and it was visually confirmed that the spacer dispersion was completely dried. After a certain period of time, a residual solvent was removed, the substrate was placed on a hot plate heated to 150° C. and heated for 15 minutes to firmly fix spacer particles to the spacer dispersion.

In Examples 31 and 32, the substrate on which a spacer dispersion was ejected was put into a pressure reduction device, and the spacer dispersion was dried. The temperature in drying under reduced pressure was 45° C. and the degree of reduced pressure was 10 mmHg.

### (Production of Liquid Crystal Display Apparatus for Evaluation)

The color filter substrate 51 where spacer particles are arranged one either one of the substrates, and the TFT array model substrate 61A or the TFT array model substrate 61B were stuck to each other using a peripheral sealing agent. After the substrates stuck to each other, the sealing agent was heated at 150° C. for one hour to be cured and to form an empty cell having a cell gap equal to the particle diameter of the spacer particles. After a certain period of time, liquid crystal was charged into two substrates stuck to each other by a vacuum injection method and an injection inlet was sealed with an end-sealing agent to produce a liquid crystal display apparatus.

### (Evaluation of Examples and Comparative Examples)

Evaluation was made about the following items.

### (Dispersion Density of Spacer Particles)

After spacer particles were firmly fixed to the substrate, the number of the spacer particles dispersed per 1 mm² was observed in a portion where the spacer particles are arranged, and a dispersion density thereof was measured.

### (Average Number of Spacer Particles)

The average value of the number of spacer particles agglomerated per one arrangement in 1 mm² area was defined as the average number of the spacer particles. The mark “-” in Tables 3 to 6 shows that no agglomeration of the spacer particles was observed.

### (Ejection State in One Hour)

After introduction of the spacer dispersion into the ink chamber of the ink-jet apparatus, an ejection state in the case of an ejection after one-hour still standing was judged according to the following criteria.

◯: Ejection was carried out in all the nozzles.
Δ: A proportion of non-ejection nozzles is less than 3%.
X: A proportion of non-ejection nozzles is 3% or more.

### (Arrangement Accuracy of Spacer Particle)

The arrangement state of spacer particles after the droplets were dried were judged according to the following criteria.

◯: Almost all of the spacer particles were in the areas corresponding to non-pixel areas.
Δ: Part of the spacer particles were outside the areas corresponding to non-pixel areas.
X: Many of the spacer particles were outside the areas corresponding to non-pixel areas.

### (Existence Range of Spacer Particles)

As illustrated in FIG. 18, parallel lines at equal intervals on both sides from the center of the black matrix or a portion corresponding to the black matrix were drawn, and the distance of neighboring two parallel lines where 95% or more of the spacer particles in number existed was defined as the spacer particle existence range.

### (Display Picture Quality)

The positions of the spacer particles were observed and the judgment was done according to the following criteria.

◯: The spacer particles were scarcely observed in the display regions and no light blank attributed to the spacer particles was caused.
Δ: A small number of spacer particles were observed in the display regions and light blank attributed to the spacer particles was caused.
X: Spacer particles were observed in the display regions and light blank attributed to the spacer particles was caused.

The results are shown in the following Tables 3 to 6.

TABLE 3

| | | Example | | | | | | | | |
|---|---|---|---|---|---|---|---|---|---|---|
| | | 7 | 8 | 9 | 10 | 11 | 12 | 13 | 14 | 15 |
| Mixing | Ethanol | | | | | | | | | |
| Amount of | 2-propanol | 15 | 15 | 15 | 15 | 15 | 15 | 15 | 15 | 15 |
| Solvent g | Water | 5 | 5 | 5 | 5 | 45 | 5 | 5 | 5 | 5 |
| | Ethylene Glycol | | | | | | | | | |
| | Monoethyl Ether | | | | | | | | | |
| | Propylene Glycol | | | | | | | | | |
| | Ethylene Glycol | 70 | 70 | 60 | 40 | | 70 | 70 | 70 | 70 |
| | 1,3-propanediol | | | | | | | | | |
| | 1,4-butanediol | | | | | | | | | |
| | Diethylene Glycol | | | | | | | | | |
| | Glycerin | 10 | 10 | 20 | 40 | 40 | 10 | 10 | 10 | 10 |
| Spacer | Type | SA | SA | SA | SA | SA | SA | SA | SA | SA |
| Particles | Particle Diameter (μm) | 4 | 4 | 4 | 4 | 4 | 4 | 4 | 3 | 5 |
| | Added Amount (g) | 0.37 | 0.75 | 1.00 | 2.00 | 2.00 | 0.75 | 0.75 | 0.30 | 2.00 |
| Spacer | Surface Tension γ₂₀ | 37.0 | 37.0 | 37.2 | 37.4 | 34.0 | 37.0 | 37.0 | 37.2 | 36.8 |
| Particle | (mN/m) | | | | | | | | | |
| Dispersion | Viscosity η₂₀ (mPa · s) | 14.3 | 14.3 | 14.4 | 14.5 | 8.0 | 14.3 | 14.3 | 14.0 | 15.0 |
| | Density d₂₀ (g/cm³) | 1.046 | 1.046 | 1.046 | 1.047 | 1.062 | 1.046 | 1.046 | 1.047 | 1.048 |
| | Precipitating Speed | 300 | 300 | 300 | 300 | 60 | 300 | 300 | 300 | 300 |
| | (min) | | | | | | | | | |
| Amount of Droplets of Spacer | | 40 | 20 | 15 | 7.5 | 7.5 | 20 | 20 | 20 | 20 |
| Particle Dispersion per One | | | | | | | | | | |
| Nozzle and One Time | | | | | | | | | | |
| Amount of Solvent (ng) with a | | 4 | 2 | 3 | 3 | 3 | 2 | 2 | 2 | 2 |
| Boiling Point of 200° C. or more | | | | | | | | | | |
| and with a Surface Tension of | | | | | | | | | | |
| 42 mN/m or more in One Droplet | | | | | | | | | | |
| Substrate | Type | 61A | 61A | 61A | 61A | 61A | 61A | 61A | 61A | 61A |
| to Receive | Height of Portion | 5 | 5 | 5 | 5 | 5 | 5 | 5 | 5 | 5 |
| the | Different in Level | | | | | | | | | |
| droplets | (nm) | | | | | | | | | |
| | Type of Alignment | PI2 | PI2 | PI2 | PI2 | PI2 | PI1 | PI3 | PI2 | PI2 |
| | Layer | | | | | | | | | |
| | Initial Contact | 33.0 | 33.0 | 33.5 | 34.0 | 38.0 | 24.8 | 45.0 | 31.0 | 32.5 |
| | Angle θ (degrees) | | | | | | | | | |
| | Receding Contact | 24.0 | 27.0 | 29.0 | 29.0 | 28.5 | 12.0 | 44.0 | 25.0 | 24.0 |
| | Angle θr (degrees) | | | | | | | | | |
| Counter | Type | 51 | 51 | 51 | 51 | 51 | 51 | 51 | 51 | 51 |
| Substrate | Height of Portion | 0 | 0 | 0 | 0 | 0 | 0 | 0 | 0 | 0 |
| | Different in Level | | | | | | | | | |
| | (nm) | | | | | | | | | |
| | Type of Alignment | PI2 | PI2 | PI2 | PI2 | PI2 | PI1 | PI3 | PI2 | PI2 |
| | Layer | | | | | | | | | |
| Drying Period of Time (min) | | 15 | 6 | 10 | 10 | 10 | 6 | 6 | 6 | 6 |
| Initial | Density of Spacer | 200 | 210 | 190 | 220 | 200 | 210 | 210 | 200 | 105 |
| | Particles | | | | | | | | | |
| | (particles/mm²) | | | | | | | | | |
| | Average Number of | 3.3 | 3.5 | 3.1 | 3.6 | 3.3 | 3.5 | 3.5 | 3.3 | 1.7 |
| | Spacer Particles | | | | | | | | | |
| | (particles/dot) | | | | | | | | | |
| One Hour | Ejection State | ∘ | ∘ | ∘ | ∘ | x | ∘ | ∘ | ∘ | ∘ |
| Later | Density of Spacer | 205 | 220 | 200 | 200 | 90 | 205 | 220 | 200 | 210 |
| | Particles | | | | | | | | | |
| | (particles/mm²) | | | | | | | | | |
| | Average Number of | 3.4 | 3.6 | 3.3 | 3.3 | — | 3.4 | 3.6 | 3.3 | 3.5 |
| | Spacer Particles | | | | | | | | | |
| | (particles/dot) | | | | | | | | | |

| | | | | | | | | | |
|---|---|---|---|---|---|---|---|---|---|
| Arrangement Accuracy of Spacer | ∘ | ∘ | ∘ | ∘ | ∘ | ∘ | ∘ | ∘ | ∘ |
| Spacer Particle Existence Range | 24 | 23 | 23 | 22 | 21 | 24 | 23 | 21 | 24 |
| (μm) | | | | | | | | | |
| Display Picture Quality | ∘ | ∘ | ∘ | ∘ | ∘ | ∘ | ∘ | ∘ | ∘ |

TABLE 4

| | | Example | | | | | | | | |
|---|---|---|---|---|---|---|---|---|---|---|
| | | 16 | 17 | 18 | 19 | 20 | 21 | 22 | 23 | 24 |
| Mixing | Ethanol | | | | | 15 | 15 | | | |
| Amount of | 2-propanol | 15 | 15 | 15 | 15 | | | 10 | 15 | 15 |
| Solvent g | Water | 5 | 5 | 5 | 5 | 5 | 5 | | 5 | 5 |
| | Ethylene Glycol | | | | | | | | | |
| | Monoethyl Ether | | | | | | | | | |
| | Propylene Glycol | | | | | | | | | |
| | Ethylene Glycol | 70 | 70 | 70 | 70 | 70 | 70 | 70 | | |
| | 1,3-propanediol | | | | | | | | 80 | 80 |
| | 1,4-butanediol | | | | | | | | | |
| | Diethylene Glycol | | | | | | | | | |
| | Glycerin | 10 | 10 | 10 | 10 | 10 | 10 | 20 | | |
| Spacer | Type | SB | SC | SA | SA | SA | SA | SA | SA | SA |
| Particles | Particle Diameter (μm) | 4 | 4 | 4 | 4 | 4 | 4 | 4 | 4 | 4 |
| | Added Amount (g) | 0.75 | 0.75 | 0.75 | 0.75 | 0.75 | 0.75 | 1.00 | 0.75 | 0.75 |
| Spacer | Surface Tension γ₂₀ (mN/m) | 36.9 | 37.2 | 37.0 | 37.0 | 35.2 | 35.2 | 37.7 | 36.5 | 36.5 |
| Particle | Viscosity η₂₀ (mPa · s) | 14.3 | 14.3 | 14.3 | 14.3 | 13.8 | 13.8 | 15.0 | 15.0 | 15.0 |
| Dispersion | Density d₂₀ (g/cm³) | 1.046 | 1.047 | 1.046 | 1.046 | 1.042 | 1.042 | 1.048 | 1.040 | 1.040 |
| | Precipitating Speed | 300 | 300 | 300 | 300 | 240 | 240 | 360 | 300 | 300 |
| | (min) | | | | | | | | | |
| Amount of Droplets of Spacer | | 20 | 20 | 20 | 20 | 20 | 20 | 15 | 20 | 20 |
| Particle Dispersion per One | | | | | | | | | | |
| Nozzle and One Time | | | | | | | | | | |
| Amount of Solvent with a | | 2 | 2 | 2 | 2 | 2 | 2 | 3 | 16 | 16 |
| Boiling Point of 200° C. or more | | | | | | | | | | |
| and with a Surface Tension of | | | | | | | | | | |
| 42 mN/m or more in One Droplet | | | | | | | | | | |
| Substrate | Type | 61A | 61A | 51 | 61B | 61A | 61A | 61A | 61A | 61A |
| to Receive | Height of Portion | 5 | 5 | 0 | 200 | 5 | 5 | 5 | 5 | 5 |
| the | Different in Level | | | | | | | | | |
| droplets | (nm) | | | | | | | | | |
| | Type of Alignment | PI2 | PI2 | PI3 | PI3 | PI2 | PI3 | PI2 | PI2 | PI3 |
| | Layer | | | | | | | | | |
| | Initial Contact | 33.0 | 34.0 | 44.7 | 43.5 | 33.0 | 45.0 | 32.0 | 29.8 | 41.0 |
| | Angle θ (degrees) | | | | | | | | | |
| | Receding Contact | 27.0 | 26.5 | 42.0 | 41.0 | 27.0 | 45.0 | 27.0 | 14.0 | 42.0 |
| | Angle θr (degrees) | | | | | | | | | |
| Counter | Type | 51 | 51 | 61A | 51 | 51 | 51 | 51 | 51 | 51 |
| Substrate | Height of Portion | 0 | 0 | 5 | 0 | 0 | 0 | 0 | 0 | 0 |
| | Different in Level | | | | | | | | | |
| | (nm) | | | | | | | | | |
| | Type of Alignment | PI2 | PI2 | PI3 | PI3 | PI2 | PI3 | PI2 | PI2 | PI3 |
| | Layer | | | | | | | | | |
| Drying Period of Time (min) | | 6 | 6 | 6 | 6 | 6 | 6 | 10 | 6 | 6 |
| Initial | Density of Spacer | 210 | 210 | 200 | 195 | 210 | 200 | 200 | 200 | 205 |
| | Particles | | | | | | | | | |
| | (particles/mm²) | | | | | | | | | |
| | Average Number of | 3.5 | 3.5 | 3.3 | 3.2 | 3.5 | 3.3 | 3.3 | 3.3 | 3.4 |
| | Spacer Particles | | | | | | | | | |
| | (particles/dot) | | | | | | | | | |
| One Hour | Ejection State | ∘ | ∘ | ∘ | ∘ | ∘ | ∘ | ∘ | ∘ | ∘ |
| Later | Density of Spacer | 220 | 220 | 205 | 210 | 210 | 205 | 200 | 195 | 210 |
| | Particles | | | | | | | | | |
| | (particles/mm²) | | | | | | | | | |
| | Average Number of | 3.6 | 3.6 | 3.4 | 3.5 | 3.5 | 3.4 | 3.3 | 3.2 | 3.5 |
| | Spacer Particles | | | | | | | | | |
| | (particles/dot) | | | | | | | | | |

| | | | | | | | | | |
|---|---|---|---|---|---|---|---|---|---|
| Arrangement Accuracy of Spacer | ∘ | ∘ | ∘ | ∘ | ∘ | ∘ | ∘ | ∘ | ∘ |
| Spacer Particle Existence Range (μm) | 24 | 22 | 25 | 21 | 23 | 23 | 22 | 24 | 23 |
| Display Picture Quality | ∘ | ∘ | ∘ | ∘ | ∘ | ∘ | ∘ | ∘ | ∘ |

TABLE 5

| | | Example | | | | | | | |
|---|---|---|---|---|---|---|---|---|---|
| | | 25 | 26 | 27 | 28 | 29 | 30 | 31 | 32 |
| Mixing | Ethanol | | | | | | | | |
| Amount of | 2-propanol | 15 | 15 | 10 | 10 | 10 | 10 | 15 | 15 |
| Solvent g | Water | 5 | 5 | | | | | 5 | 5 |
| | Ethylene Glycol | | | | | | | | |
| | Monoethyl Ether | | | | | | | | |
| | Propylene Glycol | | | | | | | | |
| | Ethylene Glycol | | | | | | | 40 | |
| | 1,3-propanediol | | | | | | | | |
| | 1,4-butanediol | 80 | 80 | 90 | 90 | | | | |
| | Diethylene Glycol | | | | | 90 | 90 | | |
| | Glycerin | | | | | | | 40 | 80 |
| Spacer | Type | SA | SA | SA | SA | SA | SA | SA | SA |
| Particles | Particle Diameter (μm) | 4 | 4 | 4 | 4 | 4 | 4 | 4 | 4 |
| | Added Amount (g) | 0.75 | 0.75 | 0.25 | 0.25 | 0.25 | 0.25 | 0.37 | 0.75 |
| Spacer | Surface Tension γ₂₀ (mN/m) | 37.0 | 37.0 | 37.8 | 37.8 | 38.9 | 38.9 | 37.4 | 37.6 |
| Particle | Viscosity η₂₀ (mPa · s) | 14.5 | 14.5 | 25.0 | 25.0 | 19.0 | 19.0 | 14.5 | 15.0 |
| Dispersion | Density d₂₀ (g/cm³) | 1.040 | 1.040 | 1.045 | 1.045 | 1.080 | 1.080 | 1.047 | 1.049 |
| | Precipitating Speed | 300 | 300 | 720 | 720 | 900 | 900 | 300 | 360 |
| | (min) | | | | | | | | |
| Amount of Droplets of Spacer | | 20 | 20 | 20 | 20 | 20 | 20 | 40 | 20 |
| Particle Dispersion per One | | | | | | | | | |
| Nozzle and One Time | | | | | | | | | |
| Amount of Solvent with a | | 16 | 16 | 18 | 18 | 18 | 18 | 16 | 16 |
| Boiling Point of 200° C. or more | | | | | | | | | |
| and with a Surface Tension of | | | | | | | | | |
| 42 mN/m or more in One Droplet | | | | | | | | | |
| Substrate | Type | 61A | 61A | 61A | 61A | 61A | 61A | 61A | 61A |
| to Receive | Height of Portion | 5 | 5 | 5 | 5 | 5 | 5 | 5 | 5 |
| the | Different in Level | | | | | | | | |
| droplets | (nm) | | | | | | | | |
| | Type of Alignment | PI2 | PI3 | PI2 | PI3 | PI2 | PI3 | PI2 | PI2 |
| | Layer | | | | | | | | |
| | Initial Contact | 30.0 | 42.4 | 21.4 | 26.0 | 22.0 | 24.1 | 34.0 | 34.7 |
| | Angle θ (degrees) | | | | | | | | |
| | Receding Contact | 14.5 | 45.0 | 10.2 | 18.1 | 9.8 | 19.0 | 29.0 | 29.5 |
| | Angle θr (degrees) | | | | | | | | |
| Counter | Type | 51 | 51 | 51 | 51 | 51 | 51 | 51 | 51 |
| Substrate | Height of Portion | 0 | 0 | 0 | 0 | 0 | 0 | 0 | 0 |
| | Different in Level | | | | | | | | |
| | (nm) | | | | | | | | |
| | Type of Alignment | PI2 | PI3 | PI2 | PI3 | PI2 | PI3 | PI2 | PI2 |
| | Layer | | | | | | | | |
| Drying Period of Time (min) | | 6 | 6 | 8 | 8 | 8 | 8 | 10 | 10 |
| Initial | Density of Spacer | 205 | 219 | 180 | 205 | 190 | 195 | 205 | 215 |
| | Particles | | | | | | | | |
| | (particles/mm²) | | | | | | | | |
| | Average Number of | 3.4 | 3.6 | 3.0 | 3.4 | 3.1 | 3.2 | 3.4 | 3.5 |
| | Spacer Particles | | | | | | | | |
| | (particles/dot) | | | | | | | | |
| One Hour | Ejection State | ∘ | ∘ | ∘ | ∘ | ∘ | ∘ | ∘ | ∘ |
| Later | Density of Spacer | 200 | 205 | 190 | 195 | 190 | 190 | 210 | 215 |
| | Particles | | | | | | | | |
| | (particles/mm²) | | | | | | | | |
| | Average Number of | 3.3 | 3.4 | 3.1 | 3.2 | 3.1 | 3.1 | 3.5 | 3.5 |
| | Spacer Particles | | | | | | | | |
| | (particles/dot) | | | | | | | | |

| | | | | | | | | |
|---|---|---|---|---|---|---|---|---|
| Arrangement Accuracy of Spacer | ∘ | ∘ | ∘ | ∘ | ∘ | ∘ | ∘ | ∘ |
| Spacer Particle Existence Range (μm) | 25 | 24 | 24 | 23 | 22 | 23 | 24 | 24 |
| Display Picture Quality | ∘ | ∘ | ∘ | ∘ | ∘ | ∘ | ∘ | ∘ |

TABLE 6

| | | Comparative Example | | | | |
|---|---|---|---|---|---|---|
| | | 4 | 5 | 6 | 7 | 8 |
| Mixing | Ethanol | | | | | |
| Amount of | 2-propanol | 15 | 15 | 10 | 15 | 15 |
| Solvent g | Water | 5 | 75 | 40 | 85 | 85 |
| | Ethylene Glycol | | 10 | | | |
| | Monoethyl Ether | | | | | |
| | Propylene Glycol | 80 | | | | |
| | Ethylene Glycol | | | 50 | | |
| | 1,3-propanediol | | | | | |
| | 1,4-butanediol | | | | | |
| | Diethylene Glycol | | | | | |
| | Glycerin | | | | | |
| Spacer | Type | SA | SA | SA | SA | SA |
| Particles | Particle Diameter (μm) | 4 | 4 | 4 | 4 | 4 |
| | Added Amount (g) | 0.75 | 0.37 | 0.37 | 0.37 | 0.37 |
| Spacer | Surface Tension γ₂₀ (mN/m) | 34.2 | 34.2 | 37.2 | 35.0 | 35.0 |
| Particle | Viscosity η₂₀ (mPa · s) | 16.0 | 2.3 | 5.4 | 2.3 | 2.3 |
| Dispersion | Density d₂₀ (g/cm³) | 1.044 | 0.962 | 1.018 | 0.967 | 0.967 |
| | Precipitating Speed (min) | 300 | 20 | 60 | 20 | 20 |
| Amount of Droplets of Spacer | | 20 | 40 | 40 | 40 | 40 |
| Particle Dispersion per One | | | | | | |
| Nozzle and One Time | | | | | | |
| Amount of Solvent with a | | 0 | 0 | 0 | 0 | 0 |
| Boiling Point of 200° C. or more | | | | | | |
| and with a Surface Tension of | | | | | | |
| 42 mN/m or more in One Droplet | | | | | | |
| Substrate | Type | 61A | 61A | 61A | 61A | 61A |
| to Receive | Height of Portion | 5 | 5 | 5 | 5 | 5 |
| the | Different in Level | | | | | |
| droplets | (nm) | | | | | |
| | Type of Alignment Layer | PI1 | PI3 | PI1 | PI1 | PI3 |
| | Initial Contact | 24.0 | 35.3 | 33.4 | 32.4 | 54.7 |
| | Angle θ (degrees) | | | | | |
| | Receding Contact | <5 | <5 | <5 | 10.0 | 42.5 |
| | Angle θr (degrees) | | | | | |
| Counter | Type | 51 | 51 | 51 | 51 | 51 |
| Substrate | Height of Portion | 0 | 0 | 0 | 0 | 0 |
| | Different in Level | | | | | |
| | (nm) | | | | | |
| | Type of Alignment Layer | PI1 | PI3 | PI1 | PI1 | PI 3 |
| Drying Period of Time (min) | | 2 | 1.5 | 1.5 | <0.5 | <0.5 |
| Initial | Density of Spacer | 205 | 195 | 185 | 180 | 175 |
| | Particles | | | | | |
| | (particles/mm²) | | | | | |
| | Average Number of | 3.4 | — | 3.1 | 3.0 | 2.9 |
| | Spacer Particles | | | | | |
| | (particles/dot) | | | | | |
| One Hour | Ejection State | ∘ | x | x | x | x |
| Later | Density of Spacer | 205 | 100 | 80 | 40 | 55 |
| | Particles | | | | | |
| | (particles/mm²) | | | | | |
| | Average Number of | 3.4 | — | — | 0.7 | 0.9 |
| | Spacer Particles | | | | | |
| | (particles/dot) | | | | | |

| | | | | | |
|---|---|---|---|---|---|
| Arrangement Accuracy of Spacer | x | x | x | ∘ | ∘ |
| Spacer Particle Existence Range (μm) | 70 | 74 | 44 | 25 | 20 |
| Display Picture Quality | x | x | x | ∘ | ∘ |

Boiling points, surface tensions, viscosities, and densities of the solvents used in Examples and Comparative Examples, and receding contact angles of the respective solvents to alignment layers are shown in the following Tables 7 and 8.

TABLE 7

| | Solvent Properties | | | |
|---|---|---|---|---|
| | Boiling | Surface | | |
| | Point bp | Tension | Viscosity | Density |
| | ° C. | γ₂₀ mN/m | η₂₀ mPa · s | d₂₀ g/cm³ |
| Ethanol | 78 | 22.3 | 1.2 | 0.789 |
| 2-propanol | 82 | 21.7 | 2.4 | 0.786 |
| Water | 100 | 72.6 | 1.0 | 0.998 |
| Ethylene Glycol | 125 | 31.8 | 2.1 | 0.929 |
| Monoethyl Ether | | | | |
| Propylene Glycol | 187 | 38.0 | 56.0 | 1.040 |
| Ethylene Glycol | 198 | 46.5 | 23.0 | 1.113 |
| 1,3-propanediol | 214 | 47.4 | 42.0 | 1.055 |
| 1,4-butanediol | 229 | 45.3 | 88.8 | 1.015 |
| Diethylene Glycol | 245 | 48.5 | 35.7 | 1.118 |
| Glycerin | 290 | 63.3 | 1412 | 1.263 |

TABLE 8

| | Receding Contact Angle θr (degrees) | | |
|---|---|---|---|
| | PI1 | PI2 | PI3 |
| | (Alignment | (Alignment | (Alignment |
| | Layer) | Layer) | Layer) |
| Ethanol | 0 | 0 | 0 |
| 2-propanol | 0 | 0 | 0 |
| Water | 15 | 30 | 57 |
| Ethylene Glycol | 0 | 0 | 0 |
| Monoethyl Ether | | | |
| Propylene Glycol | 0 | <5 | 13 |
| Ethylene Glycol | 0 | 15 | 51 |
| 1,3-propanediol | 0 | 13 | 37 |
| 1,4-butanediol | 0 | 11 | 35 |
| Diethylene Glycol | 0 | 14 | 33 |
| Glycerin | 12 | 28 | 45 |

As shown in Tables 3 to 6, in the liquid crystal display apparatus according to Examples, spacer particles were arranged precisely in non-pixel areas and display picture quality was excellent. Meanwhile, as shown in Table 6, in the liquid crystal display apparatus according to Comparative Examples, the spacer dispersion was not stably ejected in some cases. In addition, the spacer particles were arranged also in non-pixel areas and inferior in display picture quality.

### EXAMPLE 33

After 100 parts by weight of mixed monomers made of 10 parts by weight of methyl methacrylate, 60 parts by weight of hydroxyethyl methacrylate, 10 parts by weight of polyethylene glycol methacrylate (molecular weight: 400), 10 parts by weight of glycidyl methacrylate, and 10 parts by weight of methacrylate are dissolved in 300 parts by weight of ethanol, loaded into a separable flask, and replaced with nitrogen, 10 parts by weight of 10% by weight of an ethanol solution of an oil-soluble azo type polymerization initiator (trade name: V-65, produced by Wako Pure Chemical Industries, Ltd.) was dropwise titrated for one hour and, simultaneously, polymerization reaction was carried out at 65° C. Afterward, 200 parts by weight of ethylene glycol was added thereto, ethanol was removed under reduced pressure at 40° C., and the solvent was replaced with the ethylene glycol, to obtain an adhesive component solution A.

A spacer particle dispersion was obtained in the same treatment as in Example 8, except that an adhesive composition A was added to a solvent so as to be 0.1% by weight.

### (Evaluation)

After the spacer dispersion prepared in Example 33 and prepared for comparison in Comparative Example 8 was filtered with a stainless mesh (10 μm opening) for removal of agglomerates, droplets of a spacer dispersion were ejected, by an ink-jet apparatus comprising a piezo type head having a 50 μm diameter at the head tip end, at 110 μm intervals on every other vertical line, aiming to the locations corresponding to a black matrix of a color filter substrate in the TFT array substrate to arrange a liquid crystal spacer at vertically 110 μm transversely 150 μm pitches. Moreover, the gap between the nozzle (the head face) and the substrate at the time of ejection was set to be 0.5 mm and a double pulse method was used. The dispersion density of the spacer particles arranged in such a manner was 180 particles/mm².

Next, after it was confirmed that the spacer dispersion ejected on the substrate on a stage was completely dried by eye observation, the remaining dispersion medium was further removed and to firmly fix the spacer particles to the substrate, the substrate was shifted to a hot plate at 150° C. and heated and kept standing for 15 minutes to be cooled naturally to room temperature.

The number of spacer particles in the range of 1.0 mm² was measured before and after air was applied by an air gun to the TFT array substrate on which the spacer particles had been arranged, and a proportion of the number of the remaining spacer particles was calculated as a percentage.

Moreover, the conditions of the air blow in this case are as follows: an air blow pressure is 5 kg/cm² and 10 kg/cm², a nozzle diameter is 2 mm, a perpendicular distance is 5 mm, a period of time is 15 seconds.

The results are shown in Table 9.

TABLE 9

Residual Ratio of Spacers After Air Blow

| | 5 (kg/cm²) | 10 (kg/cm²) |
|---|---|---|
| Example 33 | 100% | 100% |
| Example 7 | 70% | 25% |

As shown in Table 9, the fixation force of the spacer particles after arrangement can be raised markedly by adding the adhesive composition A containing a hydrophilic adhesive in the spacer dispersion prepared in Example 8.

### INDUSTRIAL APPLICABILITY

In accordance with the invention, it is possible to provide: a liquid crystal spacer that can precisely control the interval of two substrates in producing a liquid crystal display apparatus, and can be firmly fixed to the surface of the substrate; a spacer dispersion that can precisely control the interval of two substrates in producing a liquid crystal display apparatus, and can make spacer particles firmly fixed to the surface of a substrate; a spacer dispersion that can precisely arrange spacer particles at a predetermined position on a substrate, a method for producing a liquid crystal display apparatus; and a liquid crystal display apparatus.

### BRIEF DESCRIPTION OF THE DRAWINGS

FIG. 1 is a cross-sectional view schematically illustrating an example of a liquid crystal spacer of the present invention.

FIG. 2 is a cross-sectional view schematically illustrating an example of a liquid crystal spacer of the present invention.

FIG. 3 is a cross-sectional view schematically illustrating an example of a liquid crystal spacer of the present invention.

FIG. 4 is an electron micrograph of a liquid crystal spacer produced in Example 1.

FIG. 5 is an electron micrograph of a liquid crystal spacer produced in Example 2.

FIG. 6 is an electron micrograph of a liquid crystal spacer produced in Example 3.

FIG. 7 is a cross-sectional view schematically illustrating a state where spacer particles are firmly fixed to predetermined positions of the surface of a substrate using a spacer dispersion.

FIG. 8 is a cross-sectional view schematically illustrating one embodiment in which adhesive particles are completely fixed on and combined with the surface of the spacer particle.

FIG. 9 is a cross-sectional view schematically describing a mechanism where a spacer particle arranged on a substrate is firmly fixed via adhesive particles.

FIG. 10 is a front cross-sectional view of a partially cutout portion schematically illustrating a liquid crystal display apparatus obtained by the method for producing a liquid crystal display apparatus of the present invention.

FIGS. 11(a) to 11(c) are front cross-sectional views of partially cutout portions stepwise illustrating a step in which spacer particles are arranged with a spacer dispersion according to the third aspect of the present invention.

FIG. 12 is a front cross-sectional view of a partially cutout portion illustrating a first substrate on which spacer particles are arranged.

FIG. 13 is a view schematically illustrating a state in ejecting droplets from a nozzle of an ink-jet apparatus, FIG. 13(a) illustrates the case where a meniscus is not axially symmetric, and FIG. 13(b) illustrates the case where a meniscus is axially symmetric.

FIG. 14(a) to FIG. 14(h) are end views of cleavage sites that are along the cross-sectional direction of portions different in level arranged on the surface of a substrate.

FIGS. 15(a) to 15(c) are views schematically illustrating positions where spacer particles remain.

FIG. 16 (a) is a plan view of a partially cutout portion enlarging and illustrating a state where a black matrix is provided on the inner surface of a glass substrate in forming a color filter substrate used in Examples 5 to 31 and Comparative Examples 4 to 8. FIG. 16 (b) is a front cross-sectional view of a partially cutout portion enlarging and illustrating a color filter substrate used in Examples 5 to 31 and Comparative Examples 4 to 8.

FIG. 17 (a) is a plan view of a partially cutout portion enlarging and illustrating a state where portions different in level are provided on the inner surface of a glass substrate in forming a TFT array model substrate used in Examples 5 to 31 and Comparative Examples 4 to 8. FIG. 17 (b) is a front view of a partially cutout portion enlarging and illustrating a TFT array model substrate used in Examples 5 to 31 and Comparative Examples 4 to 8.

FIG. 18 is a schematic view illustrating the evaluation method of a spacer particle existence range.

FIG. 19(a) is a perspective view of a partially cutout portion schematically illustrating a structure of an example of a head of an ink-jet apparatus, and FIG. 19(b) is a perspective view of a partially cutout portion schematically illustrating a cross-sectional structure in a nozzle hole portion.

FIG. 20 is a front cross-sectional view schematically illustrating an example of a liquid crystal display apparatus.

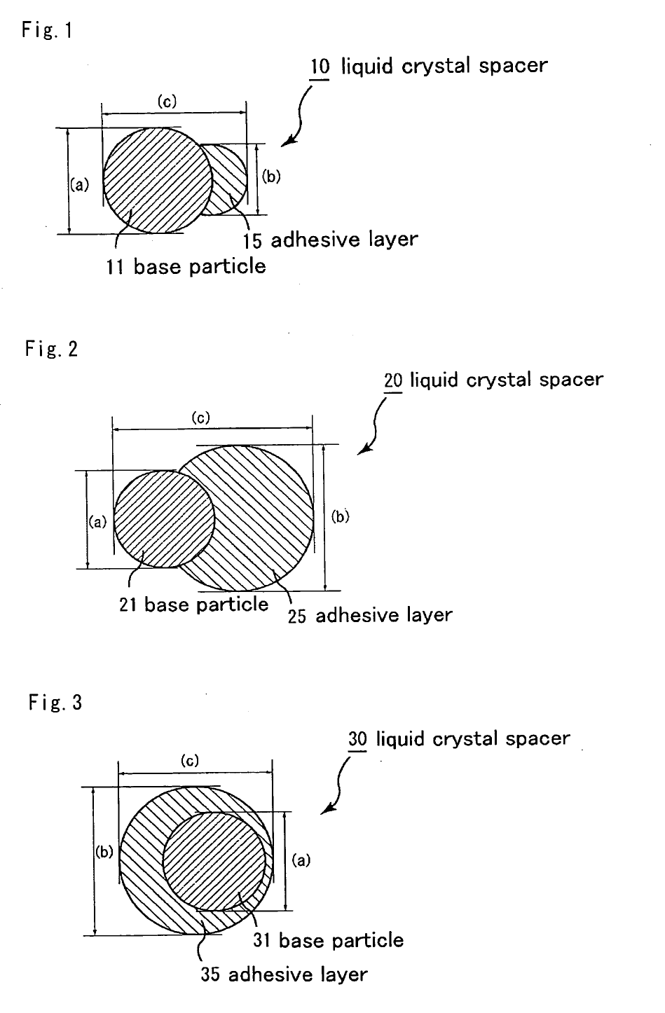

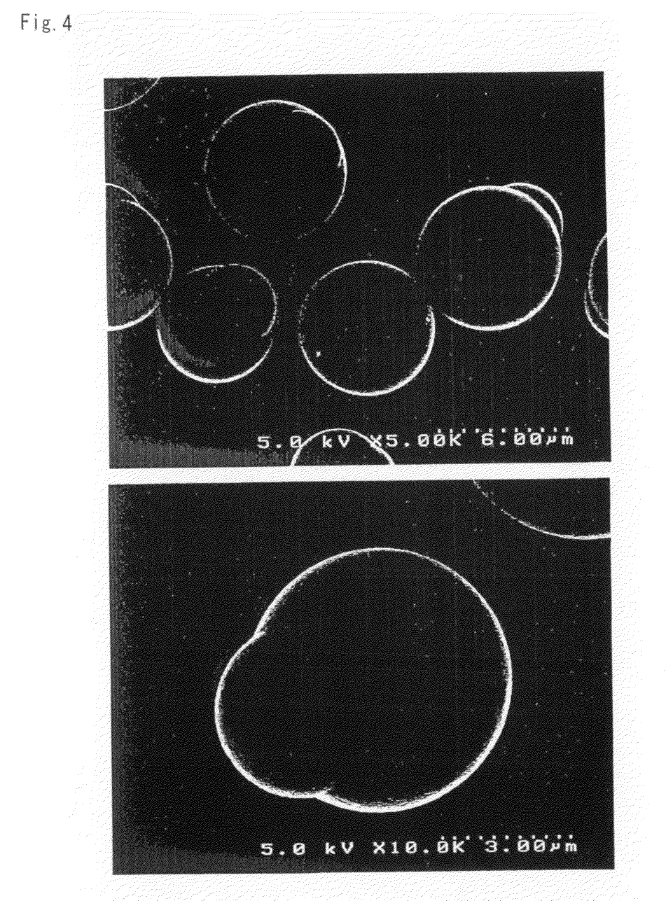

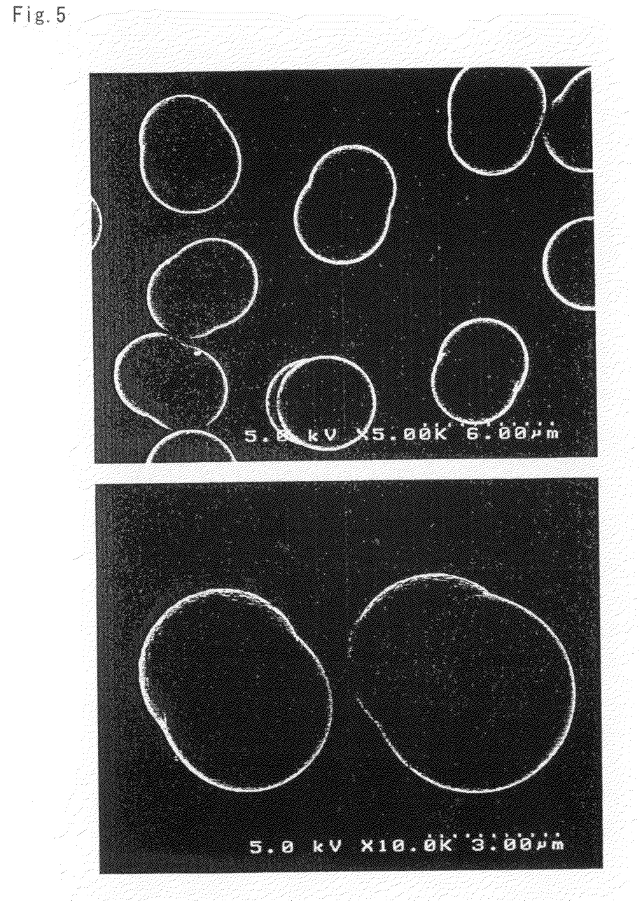

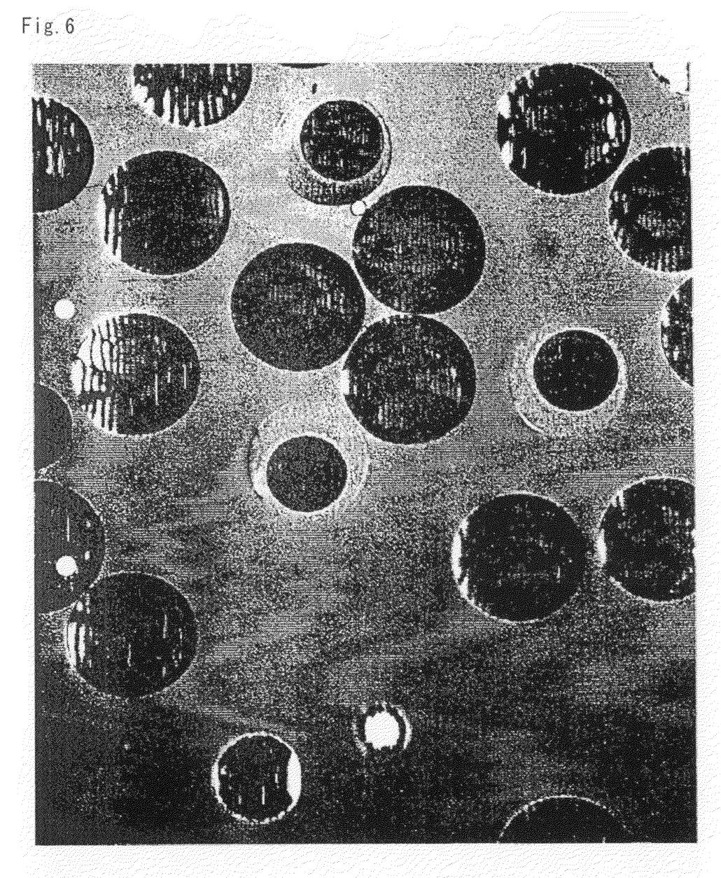

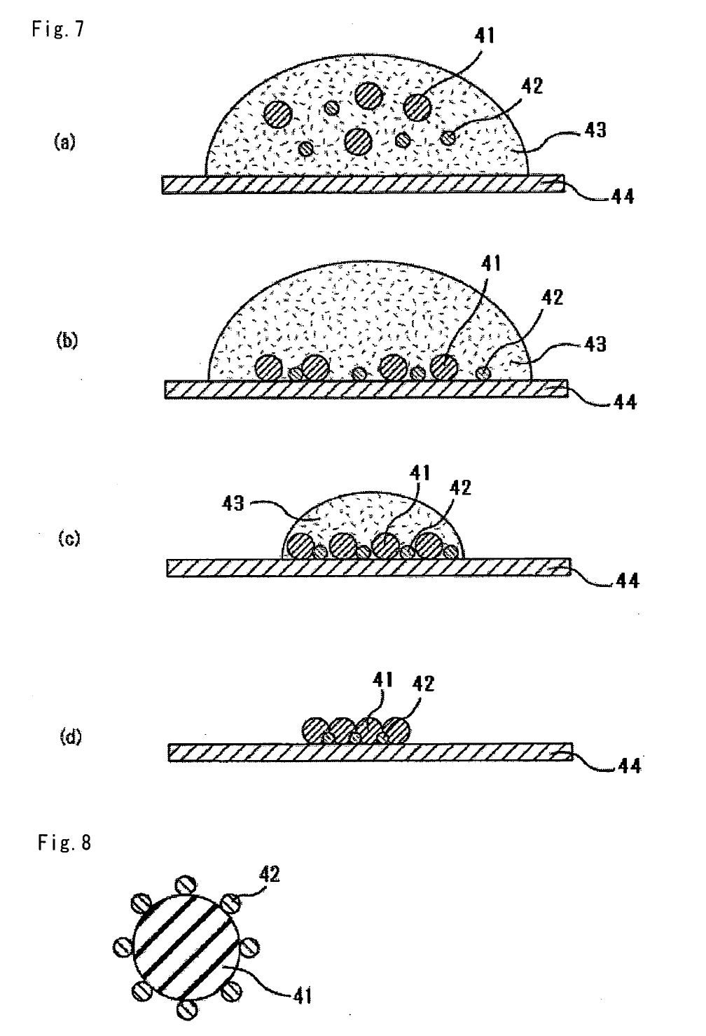

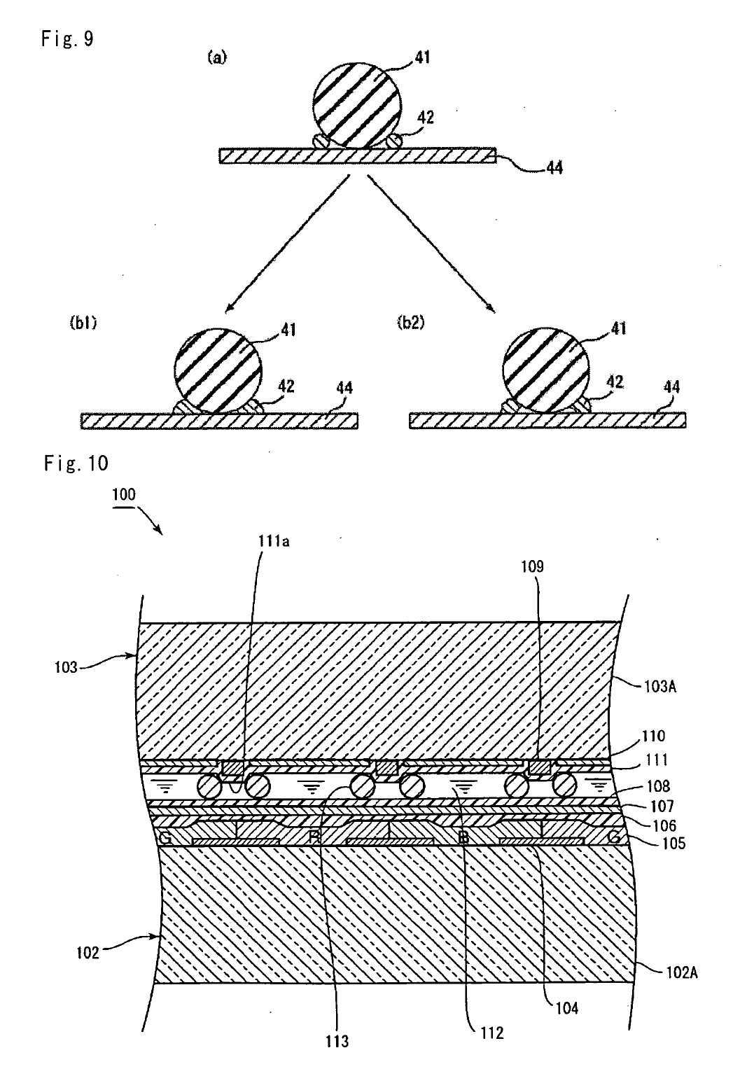

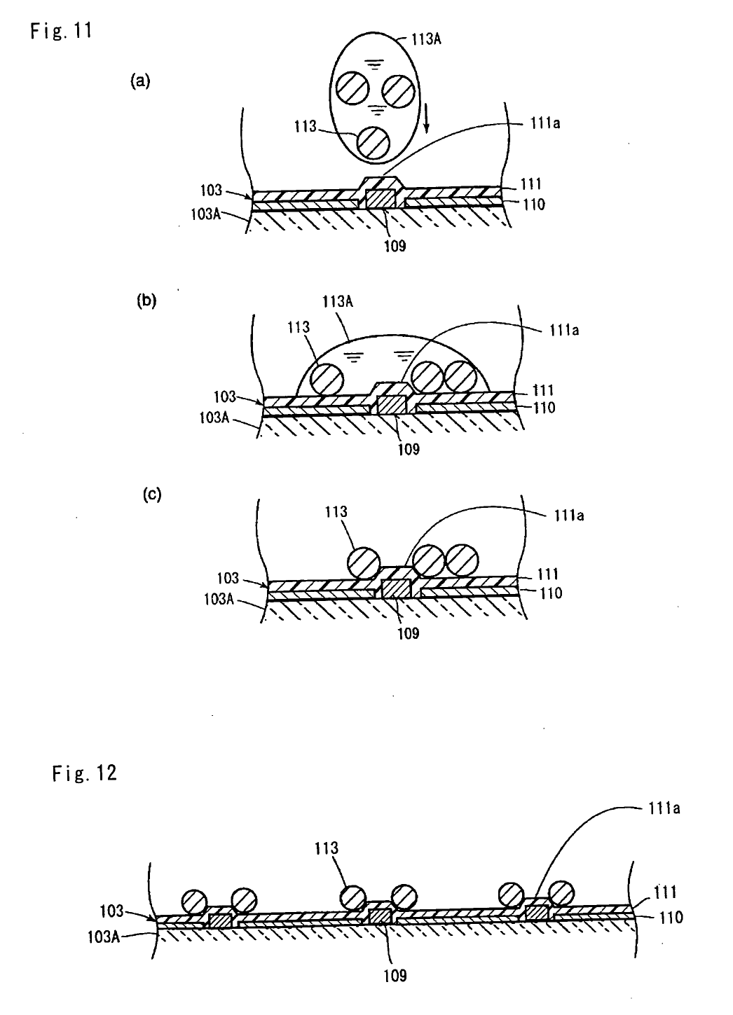

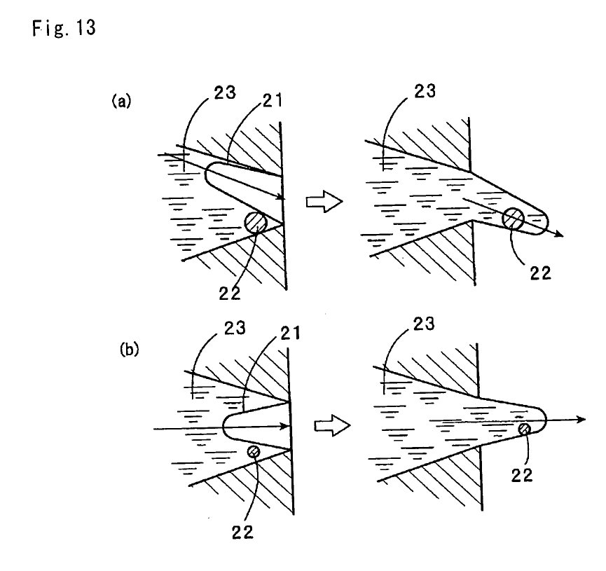

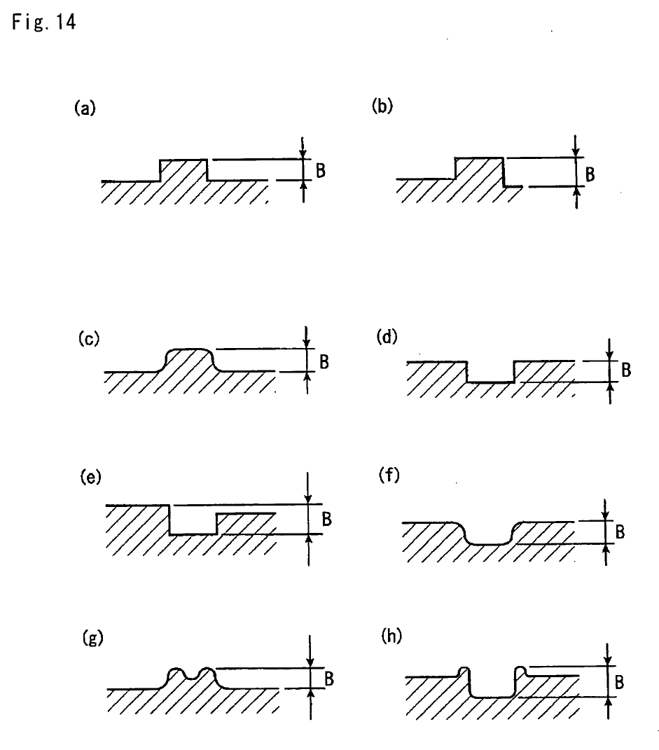

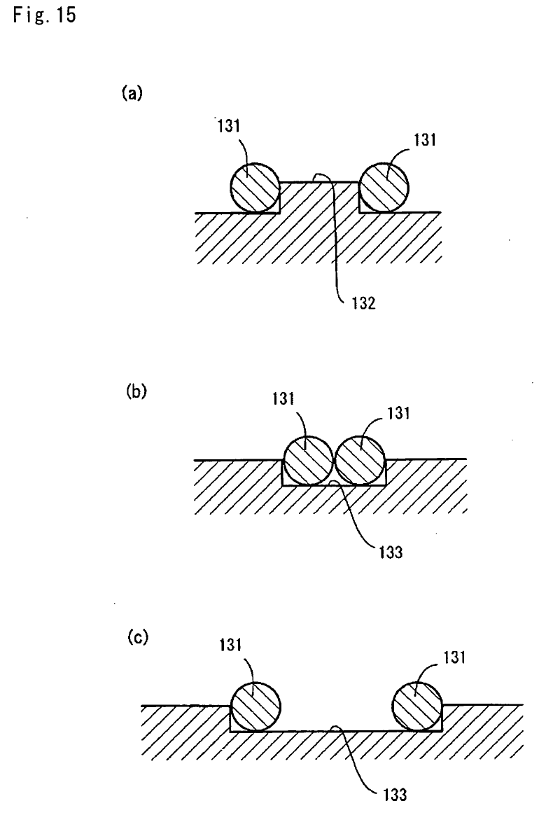

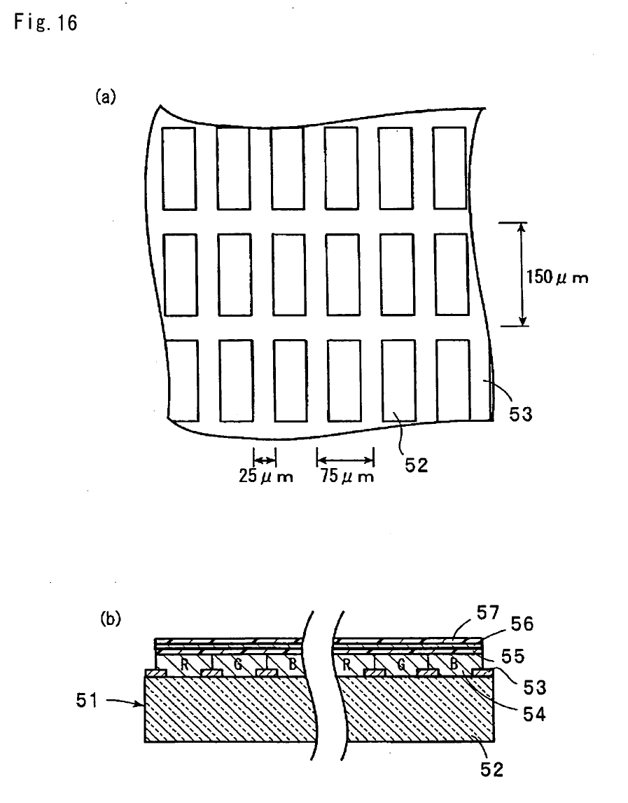

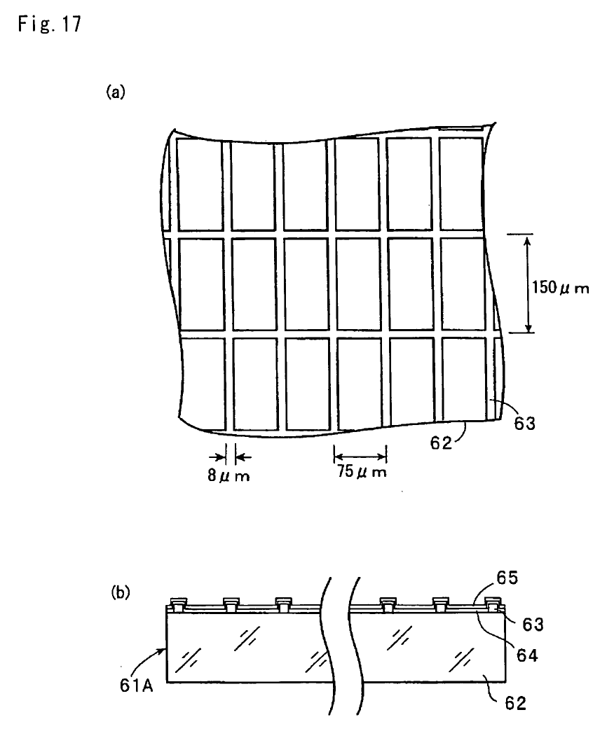

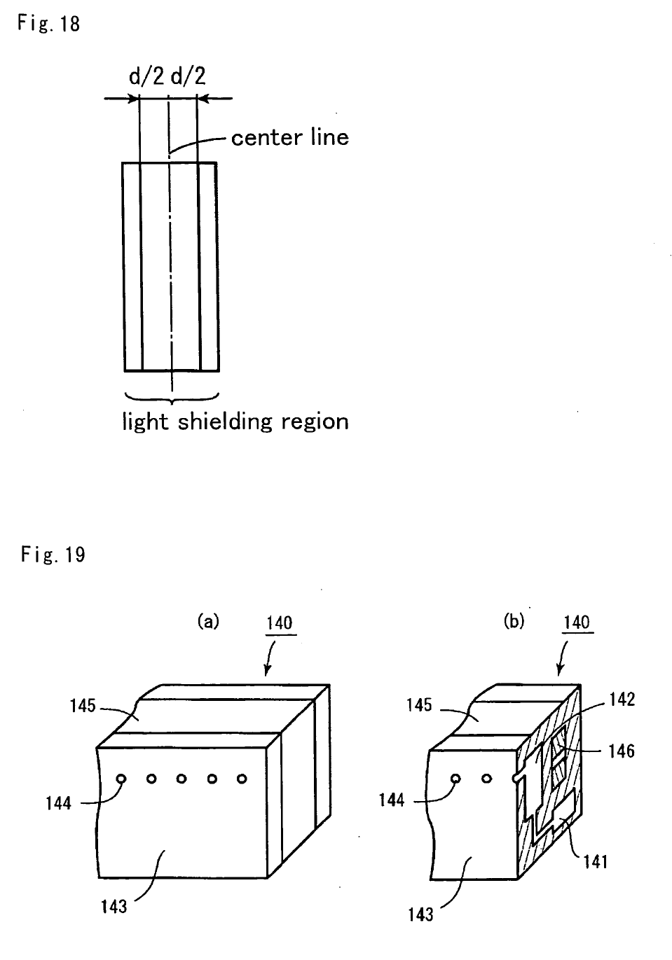

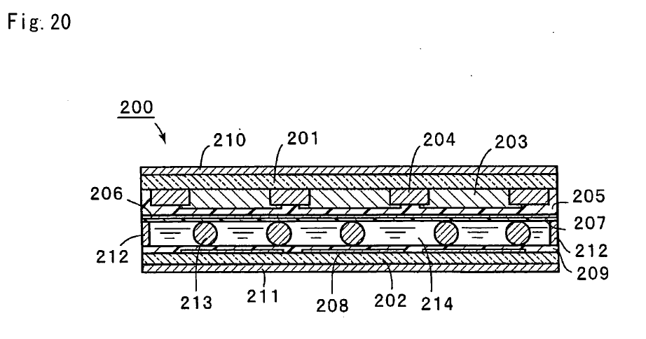

### EXPLANATION OF SYMBOLS

10, 20, 30 Liquid crystal spacer
11, 21, 31 Base particle
15, 25, 35 Adhesion particle
41, 113, 131 Spacer particle
42 Adhesive Particle
43 Solvent
44 Substrate
51 Color filter substrate
52, 62 Glass substrate
53, 104 Black matrix
54, 105 Color filter
55, 106 Overcoat layer
56, 64, 110 ITO transparent electrode
57, 65, 108, 111 Alignment layer
61A, 61B TFT array model substrate
63 Portion different in level
100 Liquid crystal display apparatus
102 Second substrate
102A, 103A Transparent substrate
103 First substrate
107 Transparent electrode
109 Wire
111a Raised portion
112 Liquid crystal
132 Projected portion
133 Depressed portion
140 Head
141, 142 Ink chamber
143 Ejection surface
144 Nozzle hole
145 Temperature Control Device
146 Piezo element

1. A liquid crystal spacer,
which comprises a base particle and an adhesive layer provided on the surface of said base particle, the apparent center of said adhesive layer being not identical to the apparent center of said base particle.

2. The liquid crystal spacer according to claim 1,
wherein a ratio (b/a) of the apparent diameter (a) of the base particle to the apparent diameter (b) of the adhesive layer is 0.3 to 1.5, and a length (c) in a long axis direction is shorter than the sum of the apparent diameter (a) of said base particle and the apparent diameter (b) of said adhesive layer.

3. The liquid crystal spacer according to claim 1,
wherein the adhesive layer has a portion protruding from the surface of the base particle to form a bump shape.

4. The liquid crystal spacer according to claim 1,
wherein the adhesive layer is provided on a portion of the surface of the base particle.

5. The liquid crystal spacer according to claim 1,
wherein the adhesive layer is provided on all surface areas of the base particle.

6. The liquid crystal spacer according to claim 2,
wherein a ratio (b/a) of the apparent diameter (a) of a base particle to the apparent diameter (b) of an adhesive layer is 0.3 or more and less than 1.0.

7. The liquid crystal spacer according to claim 2,
wherein a ratio (b/a) of the apparent diameter (a) of the base particle to the apparent diameter (b) of the adhesive layer is 1.0 to 1.5.

8. A spacer dispersion,
which comprises the liquid crystal spacer according to claim 1, and a solvent dispersing said liquid crystal spacer.

9. A spacer dispersion,
which comprises a spacer particle, an adhesive particle and a solvent containing water and/or a hydrophilic organic solvent.

10. The spacer dispersion according to claim 9,
which comprises 1 to 200 part(s) by weight of adhesive particles with respect to 100 parts by weight of spacer particles.

11. The spacer dispersion according to claim 9,
wherein the solvent has a surface tension at 20° C. of 25 to 50 mN/m.

12. The spacer dispersion according to claim 9,
wherein an average particle diameter of the adhesive particles is ½ or less of an average particle diameter of the spacer particles.

13. The spacer dispersion according to claim 9,
wherein a softening point of the adhesive particle is within the range of 40 to 120° C.

14. A spacer dispersion,
which comprises a spacer particle and a solvent component,
the spacer dispersion being ejected on a substrate of a liquid crystal display element using an ink-jet apparatus and being used when said spacer particle is arranged on said substrate, and
said solvent component containing 1% by weight or more of an solvent with a boiling point of 200° C. or more and a surface tension of 42 mN/m or more.

15. The spacer dispersion according to claim 14,
wherein the solvent component contains 10 to 100% by weight of a solvent with a boiling point of 200° C. or more and a surface tension of 42 mN/m or more.

16. The spacer dispersion according to claim 14,
wherein the solvent with a boiling point of 200° C. or more and a surface tension of 42 mN/m or more is at least one kind selected from the group consisting of 1,3-propanediol, 1,4-butanediol, and glycerin.

17. The spacer dispersion according to claim 14,
which further comprises water and/or a hydrophilic organic solvent.

18. A method for producing a liquid crystal display apparatus having a pixel area and a non-pixel area, and a first and a second substrates facing each other,
which comprises the steps of:
arranging spacer particles on an area corresponding to a non-pixel area on said first substrate, by ejecting a spacer dispersion, where spacer particles are dispersed, on said first substrate from a nozzle of an ink-jet apparatus,
superimposing said first substrate on which spacer particles are arranged on said second substrate so as to face each other via spacer particles and
injecting a liquid crystal between said first and said second substrates superimposed on one another, or arranging a liquid crystal on said first substrate or said second substrate before superimposing said first substrate on said second substrate,
said spacer dispersion containing at least a solvent with a boiling point of 200° C. or more and a surface tension of 42 mN/m or more, and
an amount of the solvent with a boiling point of 200° C. or more and a surface tension of 42 mN/m or more contained in a spacer dispersion ejected at a time from one nozzle being 0.5 to 15 ng in said step of arranging spacer particles.

19. The method for producing the liquid crystal display apparatus according to claim 18,
which further comprises a step of drying the spacer dispersion ejected on the substrate under reduced pressure after the step of arranging the spacer particles on the area corresponding to the non-pixel area on the first substrate and before the step of superimposing said first substrate where said spacer particles are arranged on the second substrate so as to face each other via the spacer particles.

20. The method for producing the liquid crystal display apparatus according to claim 18,
wherein an amount of the spacer dispersion ejected at a time from one nozzle is 5 to 35 ng in the step of arranging spacer particles.

21. A liquid crystal display apparatus,
which is obtained by using the spacer dispersion according to claim 1.

22. A liquid crystal display apparatus,
which is obtained by using a liquid crystal spacer according to claim 8.
